(19) United States
(12) Patent Application Publication
(10) Pub. No.: US 2003/0105809 A1
(43) Pub. Date: Jun. 5, 2003

(54) Method and system for distributing digital content, and server and terminal stations therefor

(75) Inventors: Yoshihiro Yoshii, Tokyo (JP); Yasuhiko Hongo, Tokyo (JP); Takahiro Endo, Tokyo (JP); Masami Sato, Tokyo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/105,360

(22) Filed: Mar. 26, 2002

(30) Foreign Application Priority Data
Nov. 30, 2001 (JP) 2001-367026
Feb. 4, 2002 (JP) 2002-026691

(51) Int. Cl. G06F 15/16; H04N 7/173

(52) U.S. Cl. 709/203; 725/87

(57) ABSTRACT

A content delivery method which distributes content from a server to a plurality of customers according to their desired delivery schedules. The server receives delivery schedule information from each user terminal which specifies a desired delivery time. The server then stores the received delivery schedule information into its local storage device. Comparing the present time with each desired delivery time stored in the storage device, the server determines whether any scheduled delivery time is reached. The server delivers specified content to every requesting user terminal when their desired delivery time is reached.

### BACKGROUND OF THE INVENTION

1. Field of the Invention

The present invention relates to a content distribution method, a content viewing method, and a server and terminal stations used therefor. More particularly, the present invention relates to a method of delivering digital content to customers according to a predef ined schedule, as well as to a method of receiving such content. The present invention also relates to a server that offers scheduled content delivery service, and to a user terminal for receiving such content.

2. Description of the Related Art

The recent advancement of information technologies have enabled distribution of digital content over the Internet, in live broadcasting mode or on-demand delivery mode. In live broadcasting systems, a schedule of broadcast programs are previously compiled on the side of source stations, and video streams are distributed according to that schedule. Unlike the on-demand systems, each video program is transmitted only once. For this reason, live broadcasting systems do not require complicated data management, which is beneficial to content service providers because they need not to keep many video data files in a content server for a long time.

Live broadcasting systems, however, impose some limitations on the audience's end; that is, customers are only allowed to receive a program in a fixed period. Besides being inconvenient to the audience in this aspect, live distribution sessions could produce heavy network traffic because the viewership tends to concentrate in particular time periods. To meet service quality requirements, service providers have to deploy high-speed backbone networks and high-performance servers.

As one solution to compensate for the above-described inflexibility of live broadcasting systems, customers may take advantage of unattended video recording functions of personal computers. In other words, personal computers take the place of conventional VCRs. Many recent personal computers have an integral TV tuner and video codec, besides being equipped with a mass-storage device with sufficient capacity for storing movie files. Such TV program recording functions of personal computers can be utilized in recording digital content delivered by the Internet broadcast services.

In contrast to live systems, on-demand delivery systems concentrate program data resources in a broadcast station. When a customer specifies a particular program, the specified program is delivered instantly to the requesting customer. The advantage of such an on-demand system is that people can enjoy a program at any convenient time. Another advantage over live broadcasting systems is that the service traffic is likely to distribute in time. This nature enables the use of lower-speed channels and lower-performance servers.

Meanwhile, customers have their own needs in terms of when to receive broadcast programs. Many people make access to broadcast media to have, for example, weather forecast information and traffic information every morning before they go to work or school. Generally speaking, people wish to use their busy morning hours as efficiently as possible, and they would like to have the above-mentioned information at convenient times. The problem here is what their convenient times are. Actually, people's activity patterns are different, depending on their individual working hours, school hours, and other private reasons. If they could automatically receive weather forecast and traffic information at a desired time, that would be a great benefit to them.

Aside from the above, people have their own spare time to watch TV programs. But, again, their activity patterns are not the same. To be more specific, most housewives are busy in the evening, preparing dinner, and it would be impossible for them to concentrate on watching TV during those hours. Rather, they would prefer to spend daytime hours watching TV shows. On the other hand, most office workers and students have no leisure time during the daytime, and for those people, the evening would be the only time available for watching TV. After all, it could be said about TV time that no single time is convenient to everyone.

In spite of their diversified needs, service customers are not allowed to receive desired programs at desired times. More specifically, conventional live broadcasting systems require the viewers to receive a program during a particular period that is previously determined by the program provider, which does not necessarily agree with the individual viewers' needs. While more than two programs may be delivered in a single time slot, as in case of current TV broadcasting services, the viewers have to choose one program because they cannot receive two programs at a time.

Another annoyance for viewers is that they have to make access to the website of an Internet broadcast provider by entering its address, or the uniform resource locator (URL), to their personal computers, before they start receiving a desired program. This step is required because each viewer should select a program through his/her personal computer, just like people selects TV channels with a remote controller. It is said that anyone can operate an Internet broadcast company if there are ready-to-use technical infrastructures. For this reason, the number of Internet broadcast providers is expected to be far larger than the number of current TV stations. Considering such a situation where a large number of program channels are available from different providers, most people would think it a cumbersome task to make access to the provider's URL each time they use a program delivery service.

As we mentioned earlier, recent personal computers are equipped with an unattended video recording function. While the capacity of storage devices are growing, it does not mean that we can record an unlimited length of video programs. For this reason, to ensure that a desired program can be recorded correctly, people have to keep their hard disk drives clean and tidy, not to run out of storage space. Without such efforts, they could fail to record a desired program. This means that people have to check the remaining disk space before setting up the computer to record a program. If the space turned out to be insufficient, they must delete some recorded programs before it is too late.

Because video programs consumes a large amount of disk space, they could affect the data writing operation of other application programs that coexist in the computer. It is therefore desirable for people to view a program realtime, without spending disk space, unless it is really necessary to keep its copy in their hard drive for a long time.

Using conventional video tapes for unattended recording may still be an option. In this case, however, the recorded programs can only be played back in the order that they were recorded, basically. For this reason, people have to search for the beginning position of each video program before starting playback, when they wish to view the programs in a different order. They would find such tasks intolerable when they playback, for example, a multiple-episode drama. This could be a problem also in the hard disk-based video recording system discussed earlier.

In view of the above, it would be beneficial to the viewers if they can define the order of program delivery or the delivery time of each individual program. With this feature, people would be able to record a series of video programs in the order that they would be played back.

The on-demand delivery systems allow the customers to receive a specified program at any time. Conversely, the system requires them to choose a program each time they use the service. Selecting one program from a long list of available programs could be intolerably troublesome. Suppose, for example, that one customer receives routinely a particular program. He/she selects that program everyday since it is updated on a daily basis. In a sense, the on-demand system forces him/her to repeat the same selection.

### SUMMARY OF THE INVENTION

In view of the foregoing, it is an object of the present invention to provide a content delivery method and a server which distribute content to a plurality of customers according to their desired schedules.

It is another object of the present invention to provide a content viewing method and a user terminal which receive content being delivered according to individual customers' schedules.

To accomplish the first object, the present invention provides a method of delivering content from a server to a user terminal. This method comprises the following steps: (a) upon receipt of delivery schedule information from the user terminal which specifies a desired delivery time, storing the received delivery schedule information into a storage device; (b) determining whether the desired delivery time is reached, by comparing the present time with the desired delivery time specified in the delivery schedule information that is stored in the storage device; and (c) delivering the content to the user terminal when the desired delivery time is reached.

To accomplish the first object, the present invention provides a server connected to a user terminal via a network. This server comprises the following elements: a storage device; a delivery schedule receiving unit which receives delivery schedule information from the user terminal which specifies a desired delivery time, and saves the received delivery schedule information in the storage device; a delivery time determination unit which determines whether the desired delivery time is reached, by comparing the present time with the desired delivery time specified in the delivery schedule information that is stored in the storage device; and a delivering unit which delivers the content to the user terminal when notified by the delivery time determination unit that the desired delivery time has been reached.

To accomplish the second object, the present invention provides a method of receiving content at a user terminal which is delivered from a server over a network. This method comprises the following steps: (a) transmitting delivery schedule information to the server in response to an external input, wherein the delivery schedule information specifies a desired delivery time; (b) storing the transmitted delivery schedule information into a storage device; (c) determining whether the desired delivery time is reached, by comparing the present time with the desired delivery time specified in the delivery schedule information that is stored in the storage device; (e) issuing a message that requests permission for receiving the content, when the desired delivery time is reached; (f) upon receipt of the permission, notifying the server that the user terminal is ready for receiving the content; and (g) displaying the content being delivered from the server.

Further, to accomplish the second object, the present invention provides a user terminal connected to a server that distributes content over a network. This user terminal comprises the following elements: a storage device; a delivery schedule transmission unit which transmits delivery schedule information to the server in response to an external input, wherein the delivery schedule information specifies a desired delivery time; a delivery schedule recording unit which records the transmitted delivery schedule information into a storage device; a delivery time determination unit which determines whether the desired delivery time is reached, by comparing the present time with the desired delivery time specified in the delivery schedule information that is stored in the storage device; a message issuing unit which issues a message that requests permission for receiving the content, when the desired delivery time is reached; a notifying unit which notifies, upon receipt of the permission, the server that the user terminal is ready for receiving the content; and a content displaying unit which displays the content being delivered from the server.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention;

FIG. 2 shows a content distribution system where the present invention is embodied;

FIG. 3 shows an example of hardware structure of an automatic distribution server in the present embodiment of the invention;

FIG. 4 shows how the proposed content distribution system is used;

FIG. 5 is a block diagram showing what functions are implemented in each device in the present embodiment;

FIG. 6 shows a typical data structure of a membership table;

FIG. 7 shows a typical data structure of a program provider table;

FIG. 8 shows a typical data structure of a program table;

FIG. 9 shows a typical data structure of a copyright management table;

FIG. 10 shows a typical data structure of a schedule table;

FIG. 11 shows a typical data structure of a sponsorship table;

FIG. 12 shows a typical data structure of a commercial table;

FIG. 13 is a flowchart of a member registration routine;

FIG. 14 is a flowchart of a schedule registration process;

FIG. 15 shows an example of transition of pages displayed on a screen of a user terminal during the processes of membership registration and schedule registration;

FIG. 16 shows an example of a main page displayed at each user terminal;

FIG. 17 shows an example of a member profile entry page displayed on a user terminal;

FIG. 18 shows an example of an ID reentry request page displayed on a user terminal;

FIG. 19 shows an example of a preference data entry page displayed on a user terminal;

FIG. 20 shows an example of a profile data confirmation page displayed on a user terminal;

FIG. 21 shows an example of a registration acknowledgment page displayed on a user terminal;

FIG. 22 shows an example of a login page displayed on a user terminal;

FIG. 23 shows an example of a login failure notification page (for wrong password) displayed on a user terminal;

FIG. 24 shows another example of login failure notification page (for invalid ID) displayed on a user terminal;

FIG. 25 shows an example of a program listing method selection page displayed in each user terminal;

FIG. 26 shows an example of a program selection page displayed on a user terminal, which includes a program list sorted by date;

FIG. 27 shows an example of a genre selection page displayed on a user terminal;

FIG. 28 shows an example of a program selection page displayed on a user terminal, which includes a program list sorted by genre;

FIG. 29 shows an example of a station selection page displayed on a user terminal;

FIG. 30 shows an example of a program selection page displayed on a user terminal, which includes a program list sorted by station;

FIG. 31 shows an example of a schedule planning page displayed on a user terminal;

FIG. 32 shows an example of a detailed schedule planning page displayed on a user terminal;

FIG. 33 shows an example of a schedule confirmation page displayed on a user terminal;

FIG. 34 shows an example of a registration acknowledgment page displayed on a user terminal;

FIG. 35 is a flowchart of a program distribution process;

FIG. 36 is a flowchart of an advertisement selection process;

FIG. 37 shows an example of a transition of pages displayed on a user terminal during the process of delivering scheduled programs;

FIG. 38 shows an example of a pre-delivery notification page displayed on a user terminal;

FIG. 39 shows an example of a program viewing page displayed on a user terminal;

FIG. 40 shows an example of a delivery end confirmation page displayed on a user terminal;

FIG. 41 is a flowchart of a program registration process;

FIG. 42 is a flowchart of a commercial registration process;

FIG. 43 is a flowchart of a content discarding process;

FIG. 44 is a flowchart of a process to compile the statistics about reservations and actual viewers;

FIG. 45 is a flowchart of a system access survey process;

FIG. 46 is a flowchart of a content fee payment process;

FIG. 47 is a flowchart of a process of statistical analysis about content distribution services;

FIG. 48 shows an example of a log table for each content;

FIG. 49 gives an example of a cumulative program statistics table, which shows the number of reservations and viewers in different time slots;

FIG. 50 gives an example of another cumulative program statistics table, which shows the number of reservations and viewers in each day of the week;

FIG. 51 shows an example of a system log table complied for each day;

FIG. 52 shows an example of a system statistics table;

FIG. 53 shows typical transitions of pages displayed on a program editing station and commercial editing station;

FIG. 54 shows an example of a main page which appears on a program editing station or commercial editing station;

FIG. 55 shows an example of a category selection page displayed on a program editing station;

FIG. 56 shows an example of a program information entry page displayed on a program editing station;

FIG. 57 shows an example of a contract information entry page displayed on a program editing station;

FIG. 58 shows an example of a registration acknowledgment page displayed on a program editing station;

FIG. 59 shows an example of an operation selection page displayed on a commercial editing station;

FIG. 60 shows an example of a commercial data entry page displayed on a commercial editing station, which allows the operator to register a new commercial title;

FIG. 61 shows an example of a registration data confirmation page displayed on a commercial editing station;

FIG. 62 shows an example of a registration acknowledgment page displayed on a commercial editing station;

FIG. 63 shows an example of a title/operation selection page displayed on a commercial editing station;

FIG. 64 shows an example of a commercial data entry page displayed on a commercial editing station, which allows the operator to change the setup of a commercial;

FIG. 65 shows an example of a deletion confirmation page displayed on a commercial editing station;

FIG. 66 shows an example of a deletion acknowledgment page displayed on a commercial editing station;

FIG. 67 shows an example of a program selection page displayed on a program editing station;

FIG. 68 shows an example of a statistics selection page displayed in a program editing station;

FIG. 69 shows an example of a reservation/delivery track record page displayed on a program editing station; and

FIG. 70 shows an example of a viewer statistics page displayed on a program editing station.

### DESCRIPTION OF THE PREFERRED EMBODIMENTS

Preferred embodiments of the present invention will be described below with reference to the accompanying drawings. The description begins with a brief explanation of the invention, which will then be followed by a more specific embodiment of the same.

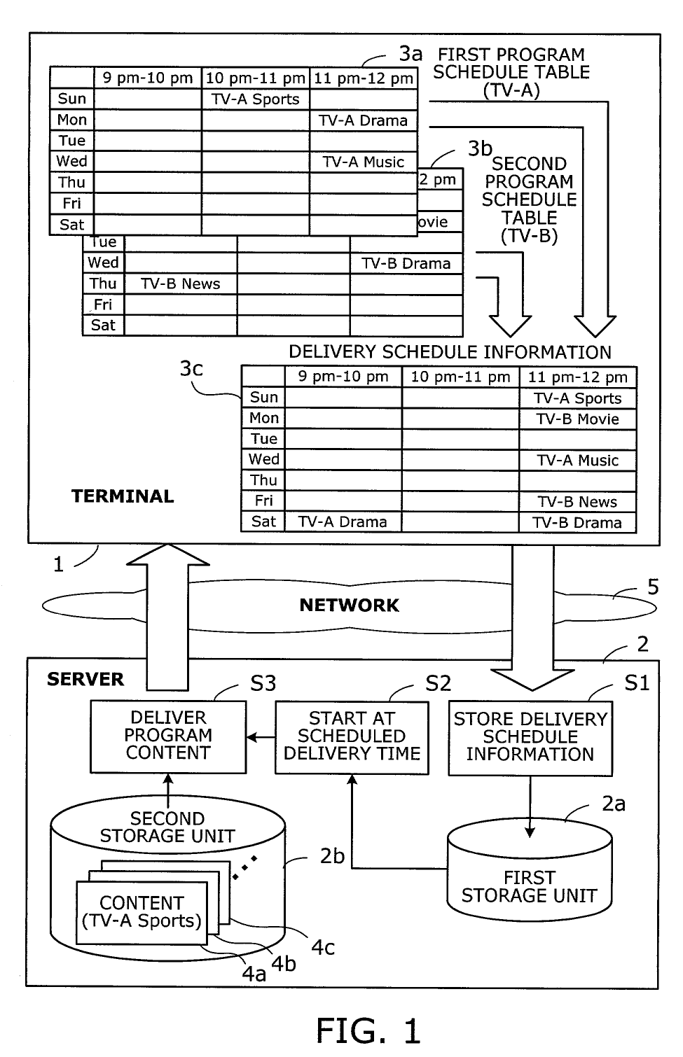

FIG. 1 is a conceptual view of the present invention. The illustrated system includes a terminal 1, a server 2, and a network 5 interconnecting them. The server 2 comprises a first storage unit 2a to store delivery schedule information 3c received from the terminal 1 and a second storage unit 2b to store pieces of content 4a, 4b, 4c, and so on. The terminal 1 compiles delivery schedule information 3c to specify a desired delivery time for each piece of content 4a, 4b, and 4c as necessary and sends it to the server 2.

As shown in the upper half of FIG. 1, the terminal 1 has two program schedule tables 3a and 3b sent from the server 2, which describe programs available from different broadcast stations TV-A and TV-B, respectively. More specifically, the first and second program schedule tables 3a and 3b show what kind of program content (e.g., video data) will be offered and in which period it will be available to the audience. The availability period of a program is defined to be a time period between its program release date and distribution end date. A program becomes accessible to interested service customers when its release date is reached.

The customer sitting at the terminal 1 chooses one or more programs from among those listed in the program schedule tables 3a and 3b and specifies when he/she would like them delivered. The terminal 1 then compiles delivery schedule information 3c including data about the selected programs and their desired delivery times. The terminal 1 transmits this delivery schedule information 3c to the server 2 in response to a certain user action. The server 2 stores the received delivery schedule information 3c in its first storage unit 2a (step S1). The server 2 watches the current time in comparison with the delivery schedule information 3c in the first storage unit 2a to determine whether any of the scheduled delivery times is reached (step S2). When the time comes, the server 2 begins delivering relevant pieces of content 4a, 4b, 4c, and so on to the terminal 1 (step S3), retrieving them from the second storage unit 2b.

In the way described above, the server 2 delivers requested content according to the delivery schedule information 3c created at the customer's terminal 1. The proposed system permits the customer to receive desired content at desired times from the server 2, so that the customer can enjoy the programs at convenient times. Delivery of content is automatically initiated at previously scheduled times, unlike conventional on-demand delivery systems, in which customers have to select a program each time they wish to receive services. With the proposed system, the customer can make access to available online content more easily.

Another advantage of the proposed system over conventional live broadcasting systems is that it prevents content delivery requests from concentrating in a particular time period. The proposed system thus relaxes performance requirements for equipment, such as transmission rate of telecommunications facilities and throughput of server computers. The present invention enables content providers to offer services to their customers at lower costs. The following sections will describe a more specific embodiment of the present invention.

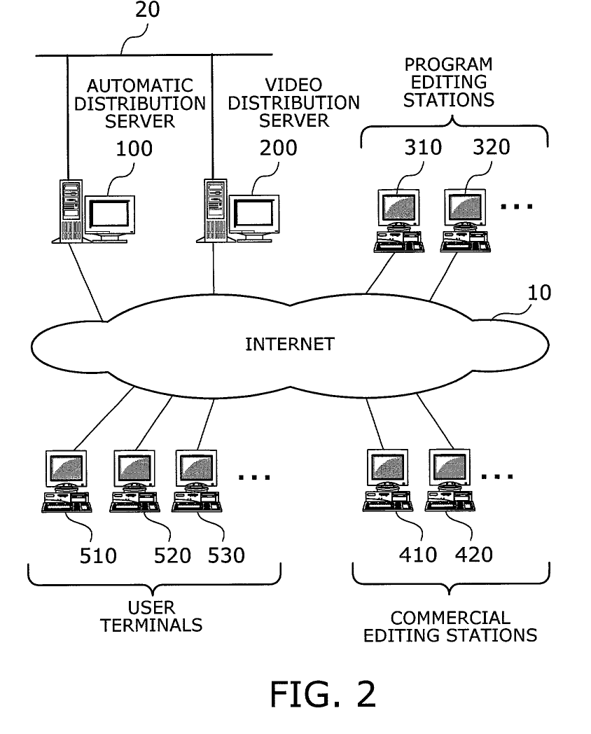

FIG. 2 shows a content distribution system in which the present invention is embodied. The illustrated system is constructed on the Internet 10, which interconnects an automatic distribution server 100, a video distribution server 200, a plurality of program editing stations 310 and 320, a plurality of commercial editing stations 410 and 420, and a plurality of user terminals 510, 520, and 530. Aside from the Internet connections, the automatic distribution server 100 and video distribution server 200 are on a local area network (LAN) 20 or similar private communications system. While FIG. 2 shows only a limited number of devices, it should be appreciated that a real-world system may include more user terminals and editing stations.

The automatic distribution server 100 manages programs to be delivered over the Internet 10, along with commercial clips to be inserted in the middle of a program. The automatic distribution server 100 also manages content delivery times according to each customer's schedule data, which is received from the user terminals 510, 520, and 530. When it reaches the time for delivery of a program, the automatic distribution server 100 so notifies the video distribution server 200, by sending the identifier of the scheduled content and that of the destination user terminal.

The video distribution server 200 stores substantive video files and commercial video clips for distribution of programs over the Internet 10. It delivers such content to the user terminals 510, 520, and 530, as instructed by the automatic distribution server 100.

The program editing stations 310 and 320 create and edit program video streams. They send the finished program content to the video distribution server 200, as well as providing information about such content to the automatic distribution server 100. The commercial editing stations 410 and 420 create and edit commercial video clips. They send the finished video clips to the video distribution server 200, as well as providing information about those clips to the automatic distribution server 100.

The user terminals 510, 520, and 530 send schedule data to the automatic distribution server 100 in response to a user action, to specify what each customer wishes to receive and when. When a program video stream and associated commercial video clips are delivered from the video distribution server 200, the user terminals 510, 520, and 530 decode and display them on a monitor screen.

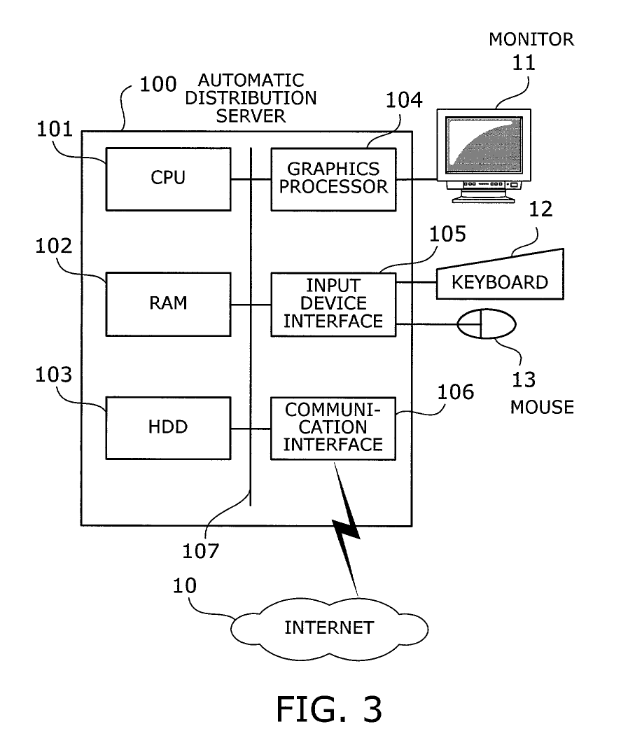

FIG. 3 shows an example of hardware structure of the automatic distribution server 100 in the present embodiment. This automatic distribution server 100 comprises the following functional elements: a central processing unit (CPU) 101, a random access memory (RAM) 102, a hard disk unit (HDD) 103, a graphics processor 104, an input device interface 105, and a communication interface 106. The CPU 101 controls the entire computer system, interacting with other elements via a bus 107. The RAM 102 temporarily stores at least a part of operating system (OS) programs and application programs that the CPU 101 executes, in addition to other various data objects manipulated at runtime. The HDD unit 103 stores program and data files of the operating system and various applications.

The graphics processor 104 produces video images in accordance with drawing commands from the CPU 101 and displays them on the screen of an external monitor unit 11 coupled thereto. The input device interface 105 is used to receive signals from external input devices such as a keyboard 12 and a mouse 13. Those input signals are supplied to the CPU 101 via the bus 107. The communication interface 106 is connected to the Internet 10, allowing the CPU 101 to exchange data with remote computers.

The processing functions of the present embodiment are implemented on a hardware platform with the above-described structure. The same hardware structure may also apply to the video distribution server 200, program editing stations 310 and 320, commercial editing stations 410 and 420, and user terminals 510, 520, and 530, in addition to the automatic distribution server 100.

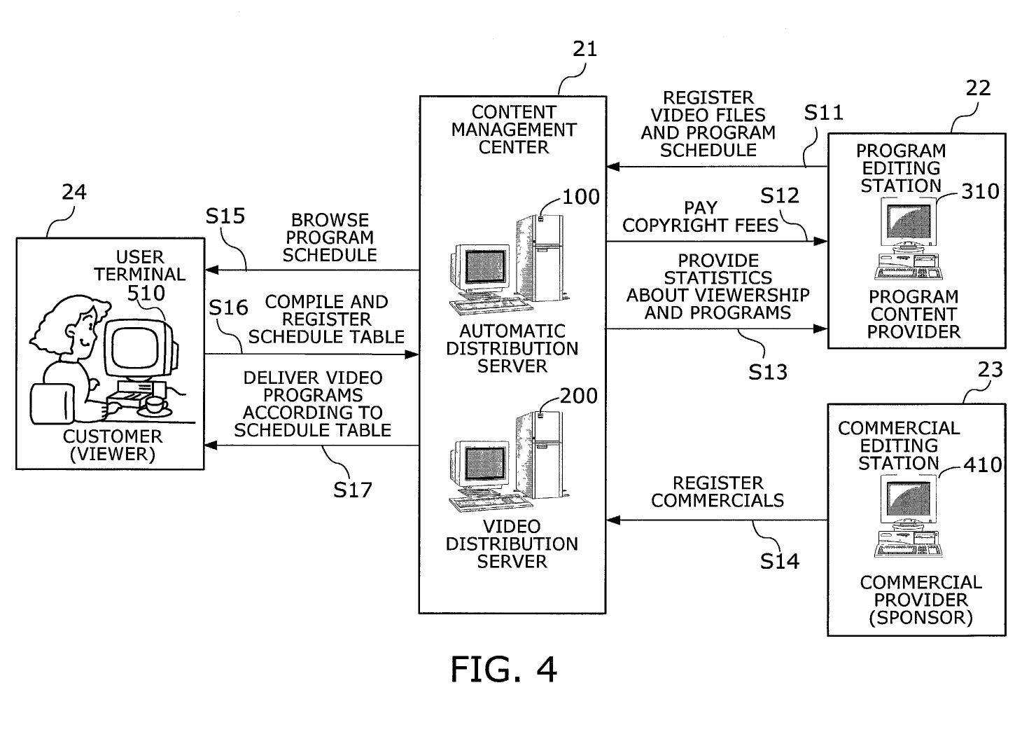

Referring next to FIG. 4 and subsequent drawings, the functions and operation of each device shown in FIGS. 2 and 3 will explained. FIG. 4 is a conceptual diagram which shows how the proposed content distribution system is used. According to the present embodiment, the automatic distribution server 100 and video distribution server 200 are located in a content management center 21. The situation of FIG. 4 assumes that a person working for a broadcast station is sitting at a program editing station 310, while another person working for an advertising company is sitting at a commercial editing station 410. The former person is referred to herein as the “program content provider” 22, and the latter person is referred to as the “commercial provider” 23. It is also supposed here that a customer 24 of program delivery service is sitting at a user terminal 510, who may also be referred to as the “viewer.”

Using the program editing station 310, the program content provider 22 makes access to the automatic distribution server 100 and video distribution server 200 in the content management center 21 to register program video files, an established program schedule, and other related information (step S11). The content management center 21 pays copyright fees to the program content provider 22 (step S12), as well as providing statistical analysis about viewership and programs (step S13).

Using the commercial editing station 410, the commercial provider 23 makes access to the automatic distribution server 100 in the content management center 21 to register commercial video clips and other information (step S14).

Making access to the content management center 21 through his/her user terminal 510, the customer 24 browses the program schedule that has been uploaded by the program content provider 22 (step S15). The customer 24 also interacts with the automatic distribution server 100 to compile and register his/her own personal program schedule table (step S16). This table will be referred to simply as the “schedule table.” According to the registered schedule table, the content management center 21 delivers video programs to the user terminal 510 of the customer 24 through its video distribution server 200 (step S17). Such content delivery services are realized as a collection of various processing functions which will be described in the next section.

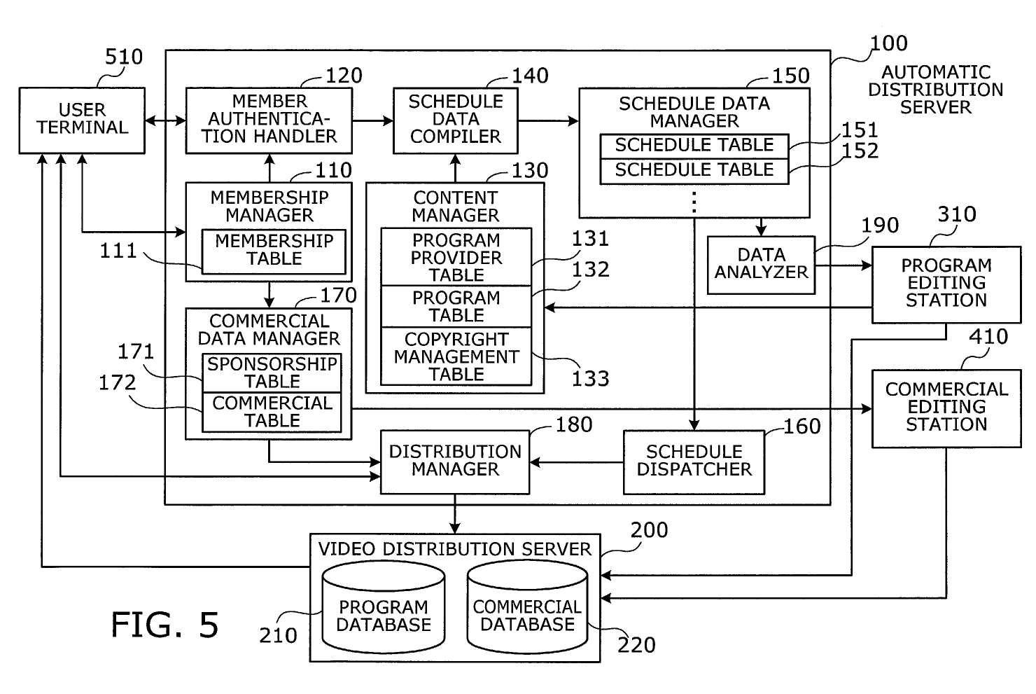

FIG. 5 is a block diagram showing what functions are implemented in each device of the present embodiment. The automatic distribution server 100 comprises a membership manager 110, a member authentication handler 120, a content manager 130, a schedule data compiler 140, a schedule data manager 150, a schedule dispatcher 160, a commercial data manager 170, a distribution manager 180, and a data analyzer 190.

The membership manager 110 maintains a membership table 111 to manage “member profile,” the information about each individual user who signed up for the content delivery service. The membership table 111 stores such profile information of the membership, together with their identifiers (IDs) and passwords. Based on the data stored in the membership table 111, the member authentication handler 120 authenticates the membership of the customer 24 sitting at the user terminal 510. It will permit the requesting customer 24 (and his/her user terminal 510) to organize and register a schedule table only when the membership authentication is successfully completed.

The content manager 130 has a program provider table 131, a program table 132, and a copyright management table 133 to manage the registered program content. The program provider table 131 stores information about the program content provider 22 and other similar parties. The program table 132 stores information about programs provided by each program content provider 22. The copyright management table 133 stores information for controlling the copyright of each program.

The schedule data compiler 140 interacts with the user terminal 510 to allow the authenticated members to compile their schedule data (including identifiers, start times, and other parameters of desired programs). To this end, the schedule data compiler 140 retrieves records of the program table 132 from the content manager 130 and sends them to the user terminal 510. When a registration request for a personal viewing schedule is received from the user terminal 510, the schedule data compiler 140 compiles schedule data for the requesting customer 24 accordingly. The schedule data includes the identifier of the user terminal 510, program ID, delivery start time, and other parameters. The created schedule data is passed to the schedule data manager 150. The schedule data manager 150 enters it to one of the schedule tables 151, 152, and so on that is relevant to the requesting customer.

The schedule dispatcher 160 compares the present time with each entry of the schedule tables 151, 152, and so on, which are stored in the schedule data manager 150. By doing so, it determines whether any of the scheduled viewing start times is reached. If any schedule data entry is ripe for execution, the schedule dispatcher 160 extracts that entry and passes it to the distribution manager 180 as an active schedule data entry.

The commercial data manager 170 has a sponsorship table 171 and a commercial table 172. Based on the data in these tables, it selects relevant commercial video clips for delivery to the user terminal 510. The commercial data manager 170 takes each member's preference into consideration when doing this, by referring to the membership table 111 stored in the membership manager 110. Selection of a commercial is made in this way, and the result is sent to the distribution manager 180.

When an active schedule data entry is received from the schedule dispatcher 160, the distribution manager 180 requests the video distribution server 200 to start delivering the video data specified in the received entry. More specifically, the distribution manager 180 first identifies the requesting customer 24 from the received schedule data entry and then obtains his/her member profile information from the membership manager 110. This information permits the distribution manager 180 to attempt to reach the user terminal 510 that the customer 24 is using, so as to determine whether it is in an active state. After confirming that the user terminal 510 is online, the distribution manager 180 sends a data delivery request to the video distribution server 200, which includes the identifiers of the destination user terminal 510 and requested video data.

In addition to the above, the distribution manager 180 determines when to insert a commercial video clip during the delivery of the program. When the time comes, the distribution manager 180 consults the commercial data manager 170 to obtain information about which video clip to insert. The distribution manager 180 then requests the video distribution server 200 to deliver the specified commercial video clip to the user terminal 510.

The data analyzer 190 collects statistical records concerning the performance of the system as a whole or each individual program, scanning through the schedule tables 151, 152, and so on. From the collected data, the data analyzer 190 performs statistical analysis in the areas of: the reservations and actual viewers of programs (reservation/viewer statistics) and the system usage (system usage statistics). The result of this analysis will be distributed to the program editing station 310.

The video distribution server 200 contains a program database 210 and a commercial database 220. The program database 210 stores video stream files for program delivery service, while the commercial database 220 stores commercial video clips to be inserted in a program for advertisement purposes. The video distribution server 200 sends such program video streams and commercial video clips to the user terminal 510 in response to a data delivery request from the automatic distribution server 100. The video distribution server 200 also interacts with the program editing station 310, saving new program video files into the program database 210 when so requested. The video distribution server 200 is further responsive to the commercial editing station 410, saving new commercial video clips to the commercial database 220 when so requested.

The program editing station 310 uploads program video files to the video distribution server 200 when requested by the program content provider 22. At that time, the program editing station 310 makes access to the automatic distribution server 100 to supply the content manager 130 with the information about the uploaded files.

The commercial editing station 410, on the other hand, uploads program commercial video clips to the video distribution server 200 when requested by the commercial provider 23. At that time, the commercial editing station 410 also makes access to the automatic distribution server 100 to supply the commercial data manager 170 with the information about the uploaded commercial files.

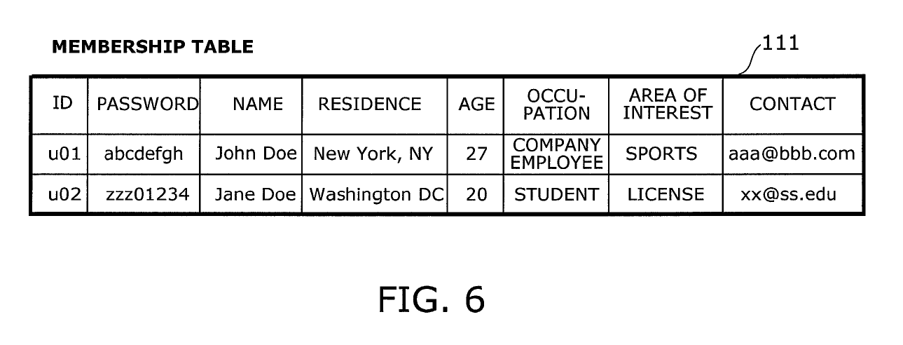

FIG. 6 shows a typical data structure of the membership table 111. The illustrated membership table 111 has the following data fields (or columns): “ID,” “Password,” “Name,” “Residence,” “Age,” “Occupation,” “Area of Interest,” and “Contact.” Each row of the membership table 111 forms an associated set of parameters describing the profile of a member.

The “ID” field stores an identification code for distinguishing individual members from each other. The “Password” field stores a password used to authenticate the identity of each member. The “Name” field stores the name of each member. The “Residence” field shows the place of residence of each member. The “Age” field shows the age of each member. The “Occupation” field shows each member's job. The “Area of Interest” field shows what each member is interested in. The “Contact” field stores an e-mail address that allows the system to reach its member.

In the example of FIG. 6, the first table entry of the membership table 111 is of a member named “John Doe” with the identification code (ID) “u01” and password “abcdefgh.” This record also shows that the member “John Doe” has a residence in New York, N.Y., is 27 years old, makes a living as a company employee, likes sports, and can be reached by e-mail at “aaa@bbb.com.” Likewise, the second entry shows the information of another member named “Jane Doe” with the identification code “u02” and password “zzz01234.” Her record shows that she is a 20-year-old student living in Washington, D.C., interested in getting a license for something, and can be reached by e-mail at “xx@ss.edu.”

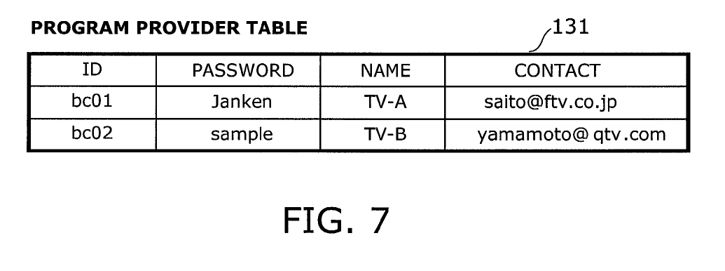

FIG. 7 shows a typical data structure of the program provider table 131. This table 131 has the following data fields: “ID,” “Password,” “Name,” and “Contact.” Each row of the program provider table 131 forms an associated set of parameters.

The “ID” field stores an identification code for distinguishing program providers from each other. The “Password” field stores a password used to authenticate the identity of each program provider. The “Name” field stores the name (e.g., company name) of each provider. The “Contact” field stores an e-mail address that allows the system to reach the contact person of each program provider.

In the example of FIG. 7, the first entry of the program provider table 131 is of a program provider named “TV-A” with the identification code “bc01” and password “Janken,” the contact person of which can be reached by e-mail at “saito@ftv.co.jp.” Likewise, the second entry shows that there is another program provider named “TV-B” with the identification code “bc02” and password “sample.” Their contact person can be reached by e-mail at “yamamoto@qtv.com”

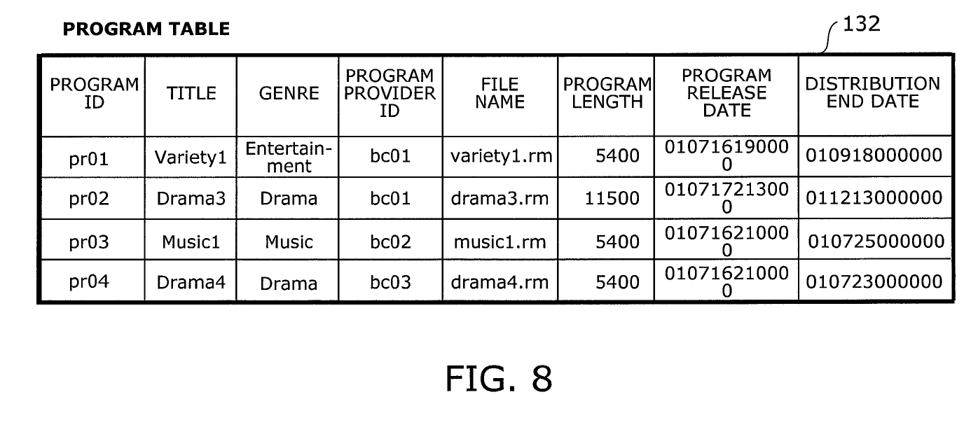

FIG. 8 shows a typical data structure of the program table 132. The program table 132 has the following data fields: “Program ID,” “Title,” “Genre,” “Program Provider ID,” “File Name,” “Program Length,” “Program Release Date,” and “Distribution End Date.” Each row of the program table 132 forms an associated set of parameters that describe a particular program.

The “Program ID” field contains the identification code of a program that was registered in the video distribution server 200 by a program provider, and the “Title” field stores the title of that program. The “Genre” field indicates to which genre the program belongs. The “Program Provider ID” field stores the identification code of the program provider. The “File Name” field stores the video file name of the program. The “Program Length” field indicates how long the program is. The “Program Release Date” field shows when the program will be released for delivery, and the “Distribution End Date” field stores the distribution end date. The last two fields give the availability period of a program, during which users can receive that program from the video distribution server 200.

In the example of FIG. 8, the first table entry describes a program titled “Variety1” with the program ID “pr01.” This program falls into the category of “Entertainment” and is offered by the program provider with the identification code “bc01” in the form of a video data file named “varietyl.rm” with a length of “5400” (meaning 54 minutes and zero seconds). The availability period of this program starts at “010716190000” (7:00 pm, Jul. 16, 2001) and expires at “010918000000” (0:00 am, Sep. 18, 2001).

The second table entry describes another program titled “Drama3” with the program ID “pr02.” This program falls into the category of “Drama” and is offered by the program provider “bc01” in the form of a video data file named “drama3.rm” with a length “11500” (115 minutes and zero seconds). The availability period of this program starts at “010717213000” (9:30 pm, Jul. 17, 2001) and expires at “011213000000” (0:00 am, Dec. 13, 2001).

The third table entry describes another program titled “Music1” with the program ID “pr03.” This program falls into the category of “Music” and is offered by the program provider “bc02” in the form of a video data file named “music1.rm” with a length “5400” (54 minutes and zero seconds). The availability period of this program starts at “010716210000” (9:00 pm, Jul. 16, 2001) and expires at “010725000000” (0:00 am, Jul. 25, 2001).

The fourth table entry describes another program titled “Drama4” with the program ID “pr04.” This program falls into the category of “Drama” and is offered by the program provider “bc03” in the form of a video data file named “drama4.rm” with a length “5400” (54 minutes and zero seconds). The availability period of this program starts at “010716210000” (9:00 pm, Jul. 16, 2001) and expires at “010723000000” (0:00 am, Jul. 23, 2001).

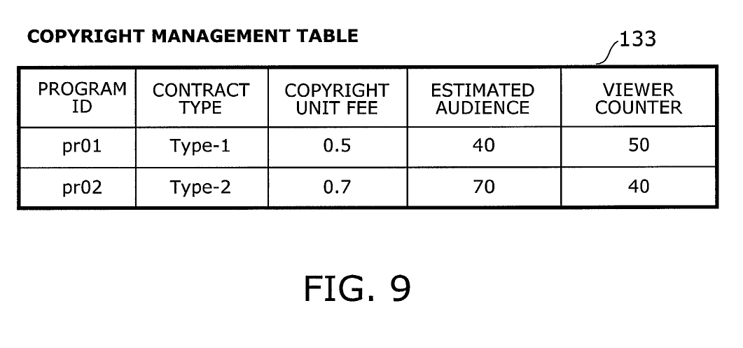

FIG. 9 shows a typical data structure of the copyright management table 133. This table 133 has the following data fields: “Program ID,” “Contract Type,” “Copyright Unit Fee,” “Estimated Audience,” and “Viewer Counter.” Each row of the copyright management table 133 forms an associated set of parameters.

The “Program ID” field contains the identification code of a program that was registered in the video distribution server 200 by a program provider. The “Contract Type” field indicates which type of contract is applied to the program. The present embodiment assumes two types of contracts, type-1 and type-2, in terms of how to calculate copyright fees for payment to the copyright holders.

Under the type-1 contract, the copyright fee is calculated on the basis of the number of viewers that is estimated beforehand, even if the actual number of viewers falls short of the expectation. Under the type-2 contract, on the other hand, the copyright fee is calculated according to the number of actual viewers, no matter whether it is below the estimated number. The “Copyright Unit Fee” field indicates how much the copyright holder will be paid for each program delivery. The “Estimated Audience” field stores the estimated number of viewers, while the “Viewer Counter” field shows the cumulative number of customers who actually received the program.

In the example of FIG. 9, the first table entry shows that the program “pr01” is provided under the type-1 contract with a unit fee of 0.5 dollars per view. While its initial estimate of audience was 40, the program “pr01” has been delivered to 50 users as of today. The second table entry, on the other hand, shows that the program “pr02” is provided under the type-2 contract with a unit fee of 0.7 dollars per view. The actual number of viewers is 40, falling short of the initial estimate of audience, which was 70.

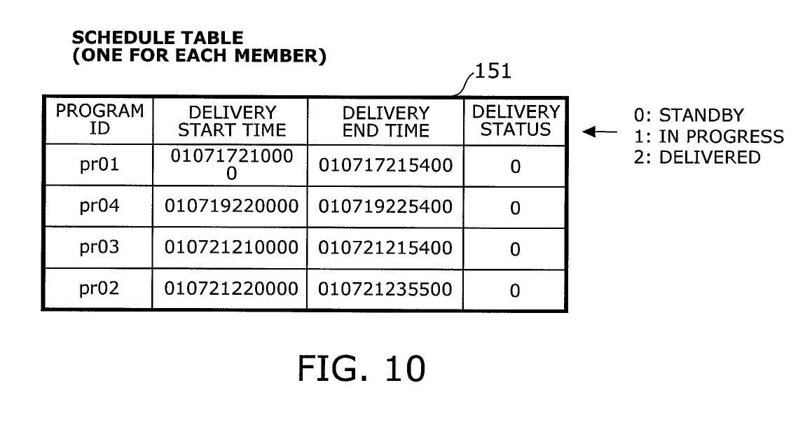

FIG. 10 shows a typical data structure of the schedule table 151, which has the following fields: “Program ID,” “Delivery Start Time,” “Delivery End Time,” and “Delivery Status.” The schedule data manager 150 creates such schedule tables 151, one for every member, and each row of the tables forms an associated set of parameters, which is referred to as the “schedule data.”

More specifically, the “Program ID” field stores the identification code of a program that the member wishes to view. The “Delivery Start Time” field shows when to start delivering the requested program, and the “Delivery End Time” field shows when that delivery is to end. The “Delivery Status” field indicates in what state the registered schedule entry is. This field initially holds a value of “0” (standby) when the requested program is not yet delivered to the member. It will be changed to “1” (in progress) when the delivery starts, and then set to “2” (delivered) when the delivery is completed.

In the example of FIG. 10, the first table entry shows that the member specifies that the program “pr01” be delivered in the period from “010717210000” (9:00 pm, Jul. 17, 2001) to “010717215400” (9:54 pm, Jul. 17, 2001), and that this request is in a standby state. The second table entry shows that the member also specifies that the program “pr04” be delivered in the period from “010719220000” (10:00 pm, Jul. 19, 2001) to “010719225400” (10:54 pm, Jul. 19, 2001), and that this request is in a standby state. The third table entry shows that the member has still another request that the program “pr03” be delivered in the period from “010721210000” (9:00 pm, Jul. 21, 2001) to “010721215400” (9:54 pm, Jul. 21, 2001), and that this request is in a standby state. The fourth table entry shows that the member further specifies that the program “pr02” be delivered in the period from “010721220000” (10:00 pm, Jul. 21, 2001) to “010721235500” (11:55 pm, Jul. 21, 2001), and that this request is in a standby state.

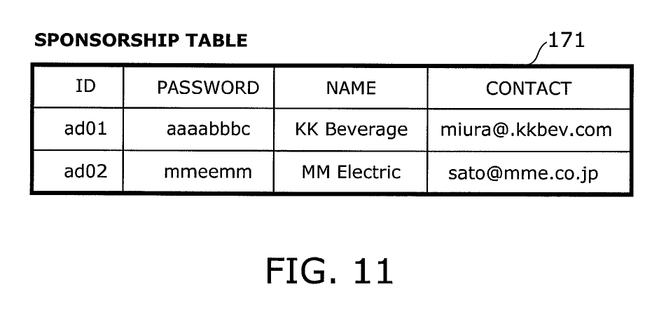

FIG. 11 shows a typical data structure of the sponsorship table 171. The sponsorship table 171 has the following data fields: “ID,” “Password,” “Name,” and “Contact.” Each row of the table 171 forms an associated set of parameters related to a particular sponsor.

The “ID” field stores an identification code for distinguishing individual sponsors from each other. The “Password” field stores a password used to authenticate the identity of each sponsor. The “Name” field stores the name (e.g., company name) of each sponsor. The “Contact” field stores an e-mail address that allows the system to reach the contact person of each sponsor.

In the example of FIG. 11, the first table entry is of a sponsor named “KK Beverage” with the identification code “ad01” and password “aaaabbbc,” the contact person of which can be reached by e-mail at “miura@kkbev.com.” Likewise, the second table entry is of a sponsor named “MM Electric” with the identification code “ad02” and password “mmeemm,” the contact person of which can be reached by e-mail at “sato@mme.co.jp.”

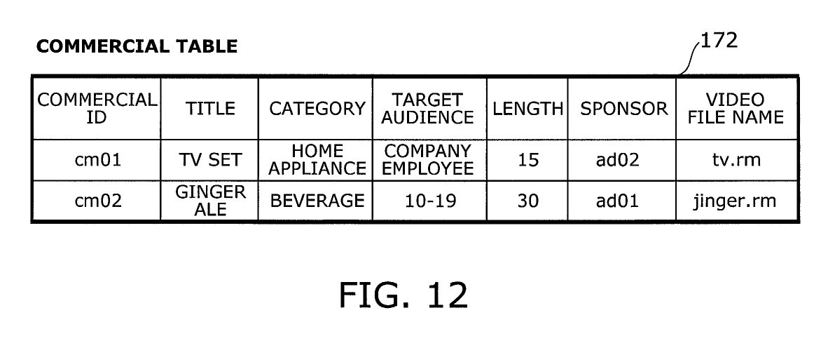

FIG. 12 shows a typical data structure of the commercial table 172. The commercial table 172 has the following data fields: “Commercial ID,” “Title,” “Category,” “Target Audience,” “Length,” “Sponsor,” and “Video File Name.” Each row of the table 172 forms an associated set of parameters related to a particular commercial video clip.

The “Commercial ID” field stores an identification code for distinguishing individual commercials from each other. The “Title” field shows the title of a commercial. The “Category” field shows a particular category of products or services for which the advertisement is intended. The “Target Audience” field shows who are the intended audience of the commercial. More specifically, this data field is filled out with a piece of attribute information (e.g., occupation, age bracket) characterizing prospective purchasers of a particular product or service. The “Length” field indicates the length of the commercial in seconds. The “Sponsor” field shows who (or which company) is the advertiser. The “Video File Name” field stores the file name of the commercial video clip.

In the example of FIG. 12, the first table entry describes a commercial titled “TV Set” with the identification code “cm01.” The advertiser “ad02” provides this advertisement of a home appliance, targeting it mainly to company employees. The commercial is stored as a 15-second video clip file named “tv.rm.” The second table entry describes another commercial with the identification code “cm02” which is titled “Ginger Ale.” The advertiser “ad01” provides this 30-second long advertisement of a beverage, targeting it mainly to customers in the age bracket of 10 to 19. The commercial is stored as a video clip file named “jinger.rm.”

The proposed system executes content delivery service with the above-described tables defined in the automatic distribution server 100. The explanation of this process starts with membership signup by a customer and then proceeds to program schedule entry by a registered member.

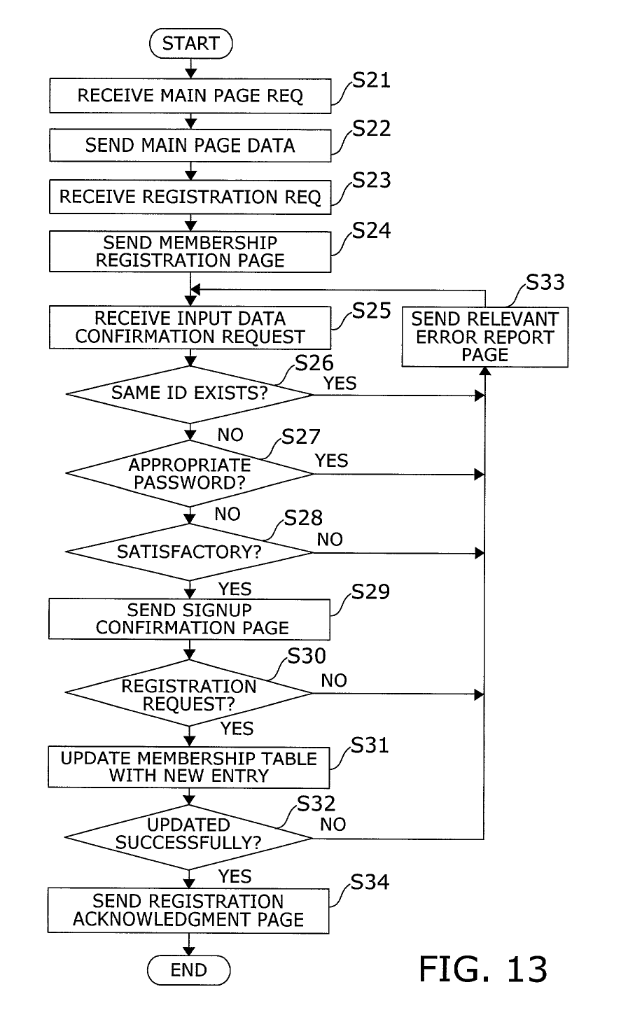

Referring back to FIG. 4, a customer 24 who wishes to subscribe to the content delivery service first makes access to the automatic distribution server 100 in the content management center 21, in an attempt to invoke a process of membership signup. In response to this, the automatic distribution server 100 begins interacting with the user terminal 510 to process the customer's request. FIG. 13 is a flowchart of a membership registration routine. This routine is called up and executed within the automatic distribution server 100 when it receives a main page request from the user terminal 510. The flowchart of FIG. 13 shows the following steps:

(S21) The membership manager 110 receives a main page request signal from the user terminal 510.

(S22) The membership manager 110 transmits main page data to the requesting user terminal 510. This causes the main page to appear on the screen of the user terminal 510, allowing the customer 24 to select a menu item “Sign up for membership.” The selection then makes the user terminal 510 to send a registration request to the automatic distribution server 100.

(S23) The membership manager 110 receives the registration request signal sent from the user terminal 510.

(S24) The membership manager 110 sends membership registration page data to the user terminal 510.

This causes the membership registration page to appear on the screen of the user terminal 510, allowing the customer 24 to provide necessary information by filling out text boxes on the page.

When the customer 24 presses a button to submit the data, the user terminal 510 transmits an input data confirmation request signal to the automatic distribution server 100.

(S25) The membership manager 110 receives the input data confirmation request from the user terminal 510, which includes at least the identification code (ID) and password that the requesting customer 24 has selected and specified.

(S26) Consulting the membership table 111, the membership manager 110 examines whether the specified ID is already used by any other member. If the same ID is found in the membership table 111, the process branches to step S33 for error indication. If there is no fear of duplication, the process advances to step S27.

(S27) Consulting again the membership table 111, the membership manager 110 examines whether the specified password is in a predefined list of unacceptable passwords. The unacceptable password list may include unduly simple character strings such as “aaaa.” Another type of inappropriate passwords is such words as “password,” which are often seen in our everyday computing environment. If the specified password falls within the above categories, the process branches to step S33 for error indication. If the specified password is deemed appropriate, the process advances to step S28. (S28) The membership manager 110 determines whether the submitted information satisfies prescribed requirements. More specifically, the membership manager 110 checks whether the customer 24 has provided all required data items. If the result is satisfactory, the process advances to step S29. If it is not satisfactory, the process branches to step S33 for error indication.

(S29) The membership manager 110 sends signup confirmation page data to the user terminal 510. This causes the signup confirmation page to appear on the screen of the user terminal 510, allowing the customer 24 to review every item that he/she entered.

When the customer 24 presses a button to instruct the system to proceed to the next step, the user terminal 510 sends a registration request signal to the automatic distribution server 100. The customer 24 may want to cancel the registration. The signup confirmation page accepts cancellation when he/she presses CANCEL button, thus sending a cancellation request signal from the user terminal 510 to the automatic distribution server 100.

(S30) Upon receipt of a signal from the user terminal 510, the membership manager 110 determines whether it is a registration request or cancellation request. If it is a registration request, the process advances to step S31. If it is a cancellation request, the process branches to step S33.

(S31) The membership manager 110 updates its local membership table 111 with the data included in the input data confirmation request.

(S32) The membership manager 110 determines whether the membership table 111 has been successfully updated. If so, the process advances to step S34. If not, the process branches to step S33 for error indication.

(S33) Depending on the reason why this step is reached, the membership manager 110 compiles an appropriate error report page and sends it to the membership manager 110 to notify the customer 24 of the error. The process then resumes from step S25.

(S34) The membership manager 110 sends registration acknowledgment page data to the user terminal 510, which allows the customer 24 to see a registration acknowledgment page. The membership registration processing is then terminated.

Through the above processing steps, the automatic distribution server 100 handles membership applications from customers. Once registered, the customer 24 can login to the automatic distribution server 100 with his/her user terminal 510 to build his/her own program viewing schedule. The automatic distribution server 100 accepts such a request from the user terminal 510 and executes a schedule registration process as requested.

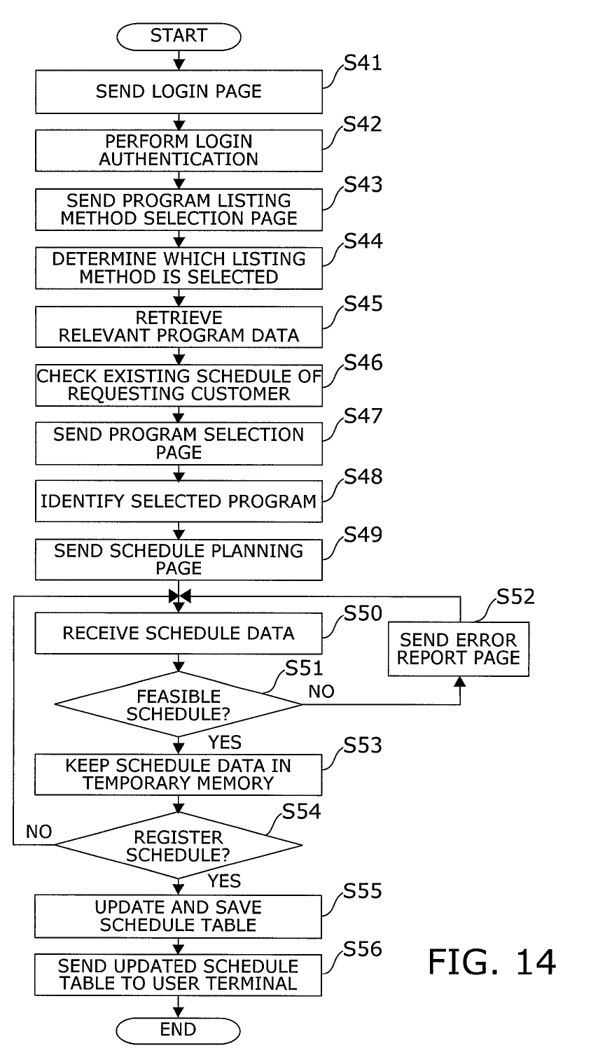

FIG. 14 is a flowchart of a schedule registration process, which is executed by the automatic distribution server 100 when the automaticdistribution server receives a login request from the user terminal 510. More specifically, this process is executed goes as follows:

(S41) The member authentication handler 120 sends login page data to the user terminal 510. This causes a login page to appear on the screen of the user terminal 510, prompting the customer 24 to enter his/her authentication data (i.e., ID and password). When the customer 24 has finished data entry and pressed a LOGIN button on the screen, the user terminal 510 sends a login authentication request to the automatic distribution server 100.

(S42) Upon receipt of the login authentication request, the member authentication handler 120 examines the received login parameters. More specifically, the member authentication handler 120 consults the membership table 111 maintained in the membership manager 110, so as to determine whether the received login parameters (i.e., ID-password pair) exactly match with the previously registered data of the requesting customer 24. If an exact match is found in the membership table 111, the member authentication handler 120 recognizes the customer 24 as a registered member.

The member authentication handler 120 may fail to find a match. If this is the case, the member authentication handler 120 sends error report page data to the user terminal 510 to notify the customer 24 of authentication failure, although FIG. 14 does not show this explicitly. The process would then resume from step S41, allowing the customer 24 to retry.

Once the login parameters are successfully verified, the member authentication handler 120 will forward every subsequent incoming message from the user terminal 510 to the schedule data compiler 140.

(S43) The schedule data compiler 140 sends listing method selection page data to the user terminal 510.

This causes a listing method selection page to appear on the screen of the user terminal 510, prompting the customer 24 to select his/her desired listing method for browsing program schedules. When the customer 24 has made a selection, the user terminal 510 notifies the automatic distribution server 100 of the selected listing method.

(S44) Based on the information sent from the user terminal 510, the schedule data compiler 140 determines how the program selection page should be compiled. The present embodiment provides the customer 24 with the following three options for program extraction: sort by station, sort by date, and sort by genre.

(S45) The schedule data compiler 140 determines criteria for extracting relevant programs, depending on the specified listing method. In conjunction with those criteria, the schedule data compiler 140 examines the availability period of each program, so that it will extract only a deliverable set of programs from the program table 132.

Suppose, for example, that the customer 24 has chosen a “sort by station” option as a program selection method. In this case, the schedule data compiler 140 extracts programs available during the week from a particular station. In the case the customer 24 has chosen a “sort by date” option, the schedule data compiler 140 extracts such programs that start today or are available today from any stations. When a “sort by genre” option is chosen, the schedule data compiler 140 extracts every program that falls under a specified genre.

(S46) Using the ID of the customer 24 as the search key, the schedule data compiler 140 retrieves his/her past schedule table, if any, from the schedule data manager 150 and loads the retrieved table to its own work memory. The schedule data compiler 140 then checks whether the programs extracted at step S45 are registered already in the retrieved schedule table.

(S47) According to the program listing method specified at step S44, the schedule data compiler 140 creates program selection page data and sends it to the user terminal 510. This causes a program selection page to appear on the screen of the user terminal 510, allowing the customer 24 to select a desired program. When a selection is made, the user terminal 510 notifies the automatic distribution server 100 of the identification code of the selected program (i.e., program ID).

(S48) The schedule data compiler 140 identifies particular program data that is relevant to the selected program, among those extracted at step S45.

(S49) The schedule data compiler 140 sends schedule planning page data to the user terminal 510. This causes a schedule planning page to appear on the screen of the user terminal 510, in which the customer 24 enters his/her desired delivery time. The user terminal 510 sends this information (i.e., schedule data for the selected program) to the automatic distribution server 100.

(S50) The schedule data compiler 140 receives the schedule data sent from the user terminal 510.

(S51) Parsing the received schedule data, the schedule data compiler 140 determines whether it is possible to add that schedule to the customer's schedule table. More specifically, the schedule data compiler 140 checks the desired delivery time specified in the schedule data. If the desired delivery time is within the availability period of the program, the schedule table can include that program as a new entry. If this is the case, the process advances to step S53. If not, the process branches to step S52 for error indication.

(S52) The schedule data compiler 140 sends error report page data to the user terminal 510. This makes an error report page appear on the screen of the user terminal 510. The process then goes back to step S50, where the automatic distribution server 100 waits for another instance of program schedule data to come.

(S53) The schedule data compiler 140 keeps the entered schedule data in a temporary memory space. The customer 24, on the other hand, operates his/her user terminal 510 to permit registration of that schedule data after confirming the details. The user terminal 510 then informs the automatic distribution server 100 of the permission for registration.

(S54) The schedule data compiler 140 determines whether the customer 24 has permitted the registration. If such a permission signal is received from the user terminal 510, the process advances to step S55. If the registration is cancelled, the process returns to step S50.

(S55) The schedule data compiler 140 updates the schedule table with the new program data, and passes it to the schedule data manager 150 for storage.

(S56) The schedule data compiler 140 transmits the updated schedule table to the user terminal 510. The user terminal 510 saves the received table in its local storage.

A new schedule table entry is registered in this way. The next section will discuss various pages appearing on a monitor screen of the user terminal 510 during the above-described processes, from membership signup to schedule registration.

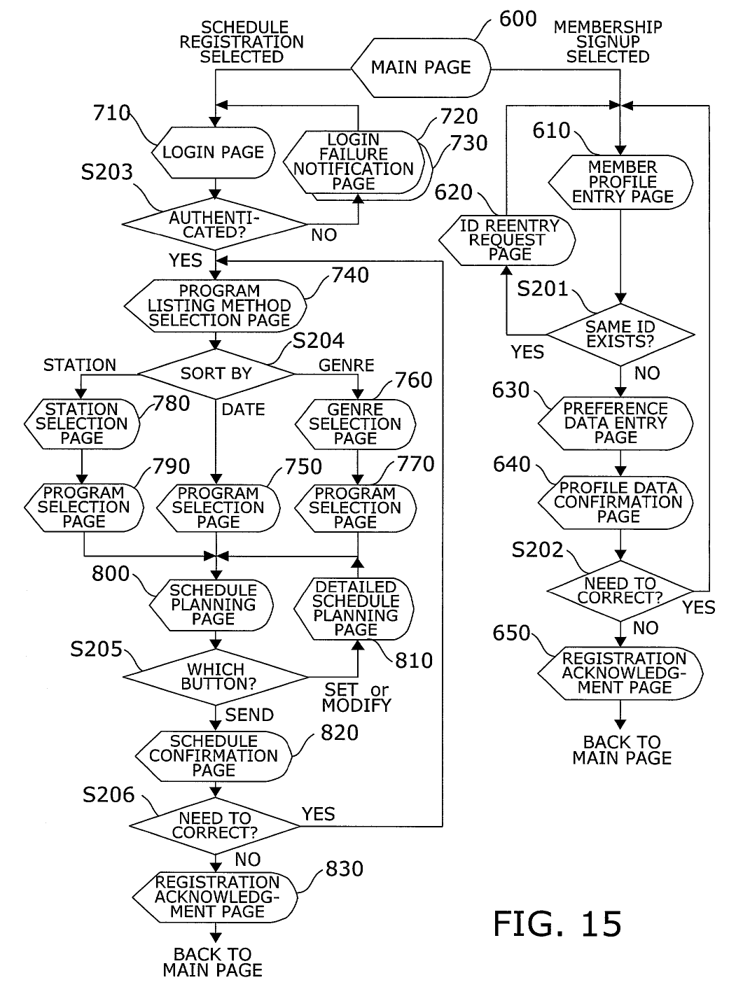

FIG. 15 shows typical transitions of pages displayed on the screen of a user terminal during the processes of membership signup and schedule registration. The customer 24 runs a client program for content delivery service on his/her user terminal 510. This program starts with a main page 600, which prompts the customer to select either membership signup or schedule registration. When membership signup is selected, the terminal screen changes from the main page 600 to a member profile entry page 610, in which the customer 24 enters his/her ID and password. The automatic distribution server 100 examines whether they are already used by an existing member (step S201), and if any duplication error is found, the terminal screen changes to an ID reentry request page 620. This page 620 allows the customer 24 to specify another or password, and the entered new ID-password pair is tested again (step S201). If there is no duplication error, the terminal screen then changes to a preference data entry page 630.

The customer 24 enters information about his/her preferences in the preference data entry page 630, which leads to a transition to a profile data confirmation page 640. Browsing the profile data confirmation page 640, the customer 24 confirms what he/she entered and presses OK button if everything is all right. Instead, he/she may press CANCEL button when any correction is needed. The automatic distribution server 100 receives information about which button was pressed, and it determines whether the customer 24 needs correction (step S202). If any correction is needed (CANCEL button was pressed), the terminal screen goes back to the member profile entry page 610. If no correction is necessary (OK button was pressed), the terminal screen changes to a registration acknowledgment page 650. Pressing RETURN button in the registration acknowledgment page 650 takes the customer 24 back to the main page 600.

Referring back to the top part of FIG. 15, the terminal screen changes to a login page 710 when schedule registration is selected in the main page 600. The customer 24 enters his/her ID and password in the login page 710, which invokes member authentication at the automatic distribution server 100 (step S203). If the entered password turns out to be incorrect, the terminal screen changes to a login failure notification page 720, which allows the customer 24 to return to the login page 710 by pressing RETURN button. Another possible authentication failure is the use of an invalid member ID, which results in a transition to another login failure notification page 730 indicating a wrong ID. By hitting RETURN button in either login failure notification page 720 or 730, the customer 24 can return to the login page 710. Successful authentication, on the other hand, takes the customer 24 to a program listing method selection page 740.

The program listing method selection page 740 provides the customer 24 with three options for listing available programs, and the automatic distribution server 100 determines which option is selected (step S204). If it is “sort by date” option, the terminal screen changes to a program selection page 750. If it is “sort by genre” option, the terminal screen changes to a genre selection page 760. Selecting a particular genre in this genre selection page 760 takes the customer 24 to a program selection page 770 with a program listing in that genre. Referring back to step S204, if the customer 24 chooses “sort by station” option, the terminal screen changes to a station selection page 780. Selecting a particular station in this station selection page 780 takes the customer 24 to a program selection page 780 with a program listing of that station.

The customer 24 picks up desired programs in either of the three program selection pages 750, 770, and 790. They are all linked to a schedule planning page 800, where the customer 24 edits his/her schedule table. The automatic distribution server 100 then determines which button is pressed, SET or MODIFY or SEND (step S205). If it is SET or MODIFY, the terminal screen changes to a detailed schedule planning page 810, which prompts the customer 24 to enter detailed parameters about the selected programs. When this is finished, the schedule planning page 800 comes back. Pressing SEND button in the schedule planning page 800 takes the customer 24 to a schedule confirmation page 820.

In the schedule confirmation page 820, the customer 24 looks through his/her schedule table and determines whether to register or cancel the schedule table that he/she edited. The automatic distribution server 100 watches this decision (step S206), and if OK button is pressed, it causes a transition to a registration acknowledgment page 830, assuming that no correction is necessary. If CANCEL button is pressed in the schedule confirmation page 820, the automatic distribution server 100 interprets it as a request for correction, thus bringing the customer 24 back to the program listing method selection page 740. Finally, the customer 24 checks data on the registration acknowledgment page 830 and makes a predetermined operation to return to the main page 600. The customer 24 signs up for membership, or builds his/her own schedule table, while following such screen changes.

The next section will explain in detail each page appearing on a screen of the user terminal 510. The following explanation includes some new pages that were not explained in the previous section because FIG. 15 only shows a fundamental flow of pages in the present embodiment.

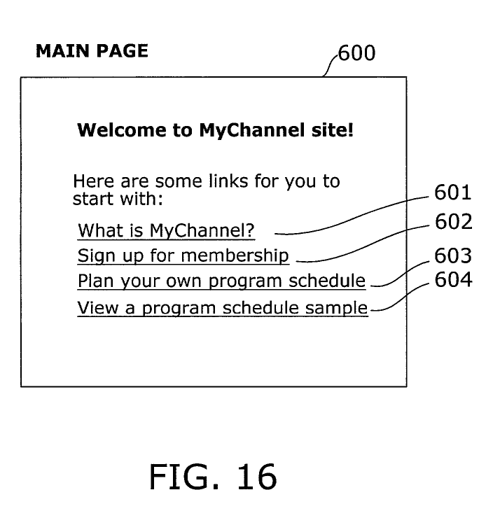

FIG. 16 shows an example of the main page 600 displayed at each user terminal. This main page 600 contains welcome messages and a plurality of links 601 to 604, which form a kind of menu. The first link 601 reads “What is MyChannel?” (the service provider calls their content delivery service “MyChannel” in the present example). When the customer 24 selects this link 601, the screen of his/her user terminal 510 will change to a service description page (not shown in FIG. 15). The second link 602 reads as follows: “Sign up for membership.” This link 602 takes the customer 24 to a member profile entry page 610 when it is selected. The third link 603 reads as follows: “Plan your own program schedule.” This link 603, when selected, calls up a login page 710. The fourth link read as follows: “View a program schedule sample.” When the customer 24 selects this link 604, his/her terminal screen will change to a program table sample page (not shown in FIG. 15).

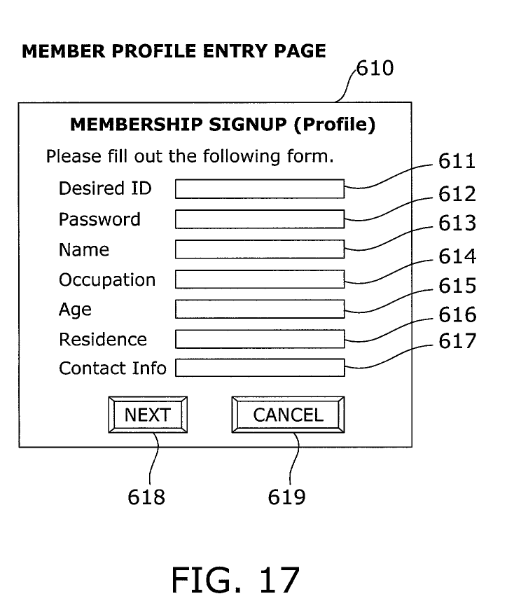

FIG. 17 shows an example of the member profile entry page 610. This page 610 contains a plurality of text boxes 611 to 617, a NEXT button 618, and a CANCEL button 619. The customer 24 is prompted to fill out those text boxes 611 to 617.

The first text box 611 and second text box 612 are used to specify a desired ID and password, respectively. The third text box 613 is used to enter the name of the customer 24. The fourth text box 614 is used to enter the occupation of the customer 24. The fifth text box 615 is used to enter the age of the customer 24. The sixth text box 616 is used to enter the residence of the customer 24. The seventh text box 617 is used to enter the contact information of the customer 24. It is assumed in the present embodiment that the customer 24 is requested to enter his/her e-mail address in this text box 617.

The NEXT button 618 allows the customer 24 to finalize what he/she entered in the member profile entry page 610 and proceeds to the next step. When this NEXT button 618 is pressed, the automatic distribution server 100 performs error checking of each entered data item, including duplicated ID assignment. If any problem is detected, the automatic distribution server 100 takes the customer 24 to the ID reentry request page 620. If there is no problem, the customer proceeds to the preference data entry page 630. The CANCEL button 619 is used to interrupt the membership signup process and return to the main menu 600, discarding the information entered in the member profile entry page 610.

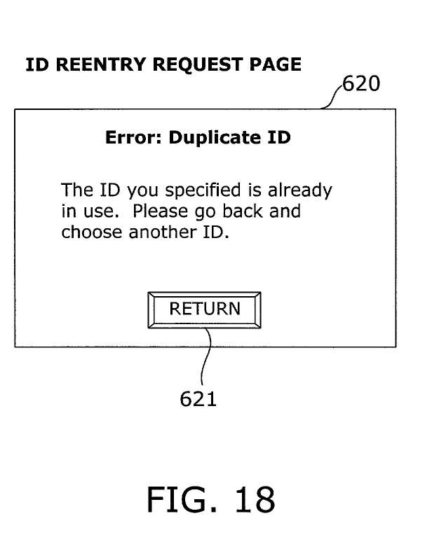

FIG. 18 shows an example of the ID reentry request page 620. This page 620 contains a message indicating that the specified ID is already assigned to another member. Also contained in the ID reentry request page 620 is a RETURN button 621. This RETURN button 621 allows the customer 24 to go back to the member profile entry page 610.

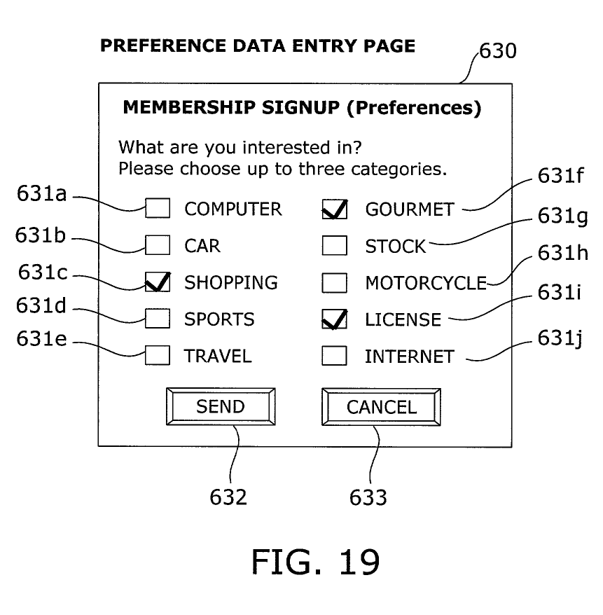

FIG. 19 shows an example of the preference data entry page 630. This preference data entry page 630 contains a plurality of check boxes 631a to 631j, a SEND button 632, and a CANCEL button 633.

The customer 24 selects check boxes 631a to 631j to specify what he/she is interested in. Each check box 631a to 631j has a caption that represents a particular area of interest. More specifically, the first check box 631a is associated with “Computer.” The second check box 631b is associated with “Car.” The third check box 631c is associated with “Shopping.” The fourth check box 631d is associated with “Sports.” The fifth check box 631e is associated with “Travel.” The sixth check box 631f is associated with “Gourmet.” The seventh check box 631g is associated with “Stock.” The eighth check box 631h is associated with “Motorcycle.” The ninth check box 631i is associated with “License.” The tenth check box 631j is associated with “Internet.” A checkmark appears in a check box when it is selected by the customer 24.

The customer 24 presses the SEND button 632 to register the selected areas to the system's database. When this SEND button 632 is pressed, the interest areas associated with the marked check boxes are sent to the automatic distribution server 100 as the customer's preference information. At the same time, the user terminal 510 changes its monitor screen to the profile data confirmation page 640.

The customer 24 may in turn choose to hit the CANCEL button 633 to cancel the selection of preferences. When this CANCEL button 633 is pressed, the user terminal 510 returns to the member profile entry page 610, without submitting the preference information.

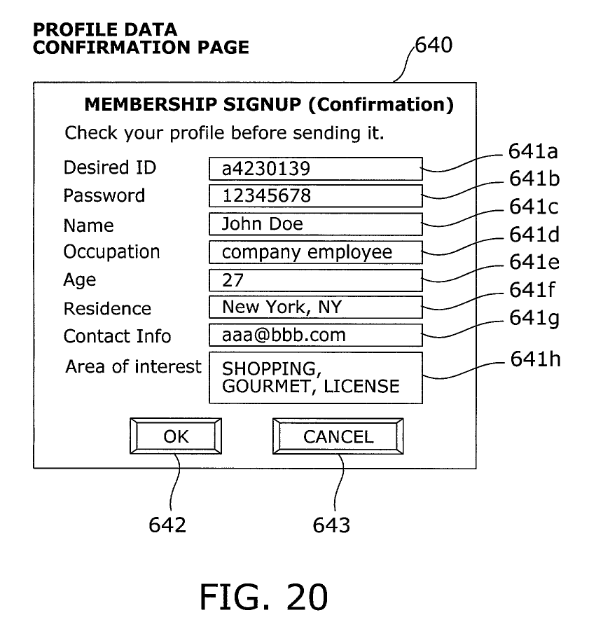

FIG. 20 shows an example of the profile data confirmation page 640. This profile data confirmation page 640 contains a plurality of text fields 641a to 641h, an OK button 642, and a CANCEL button 643.

The text fields 641a to 641h are used to display what the customer 24 has entered in the member profile entry page 610 and preference data entry page 630. The first text field 641a shows the customer's desired ID. The second text field 641b shows his/her specified password. The third text field 641c shows his/her name. The fourth text field 641d shows his/her occupation. The fifth text field 641e shows his/her age. The sixth text field 641f shows his/her place of residence. The seventh text field 641g shows his/her contact address. The eighth text field 641h shows his/her area of interest.

The customer 24 presses the OK button 642 when he/she is sure that all the data items shown in the text fields 641a to 641h are correct. When this OK button 642 is pressed, the information shown in the text fields 641a to 641h is sent to the automatic distribution server 100 as the member profile information of the customer 24. This information is then recorded as a new entry of the membership table 111. The OK button 642 also triggers a transition to the registration acknowledgment page 650. The CANCEL button 643, on the other hand, is used to interrupt the membership signup process, while discarding what the customer 24 has entered. This CANCEL button 643 initiates a transition back to the main page 600, nothing being transmitted to the automatic distribution server 100.

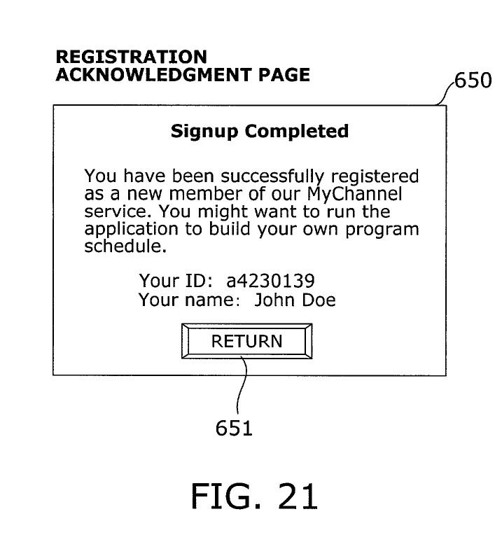

FIG. 21 shows an example of the registration acknowledgment page 650. Besides showing a message indicating the completion of membership registration, this registration acknowledgment page 650 contains a RETURN button 651. The RETURN button 651 allows the customer 24 to exit from the membership signup process. The RETURN button 651 also initiates a transition back to the main page 600.

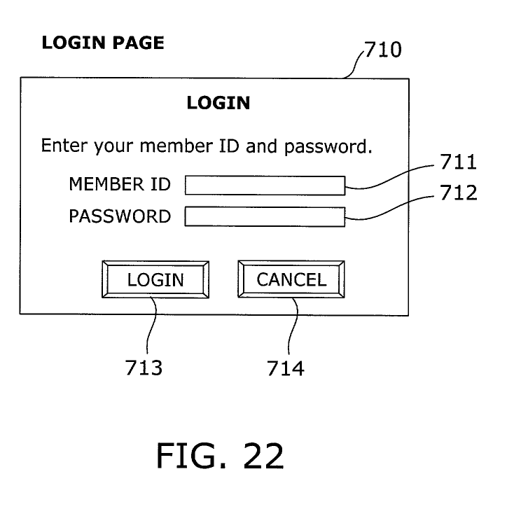

FIG. 22 shows an example of the login page 710. This login page 710 contains the following components: two text boxes 711 and 712, a LOGIN button 713, and a CANCEL button 714.

The first text box 711 and second text box 712 are used by the customer 24 to enter his/her member ID and password, respectively. The LOGIN button 713 is used to login to the automatic distribution server 100, with the authentication parameters in the text boxes 711 and 712. When this LOGIN button 713 is pressed, the member authentication data (i.e., ID-password pair) of the requesting customer 24 is transmitted from the user terminal 510 to the automatic distribution server 100. The automatic distribution server 100 performs authentication processing, and if the password is incorrect, the terminal screen changes to a login failure notification page 720 that warns the customer 24 about his/her use of a wrong password. Entry of an incorrect ID triggers a transition to another login failure notification page 730, which warns the customer 24 about the invalid ID. A valid login attempt, on the other hand, causes a transition to the program listing method selection page 740.

The CANCEL button 714 is used to stop and cancel the login operation. By pressing this CANCEL button 714, the customer 24 can interrupt the current login processing without sending the member authentication parameters that he/she has entered. This also initiates a transition back to the main page 600.

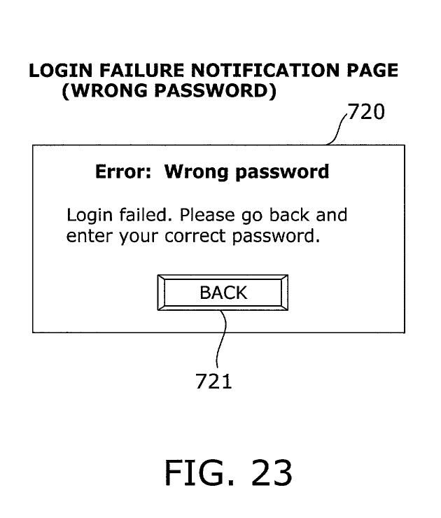

FIG. 23 shows an example of the login failure notification page 720 (wrong password). This login failure notification page 720 contains a warning message that points out the use of a wrong password and indicates login failure as its consequence. The login failure notification page 720 also has a RETURN button 721 to allow the customer 24 to go back to the login page 710.

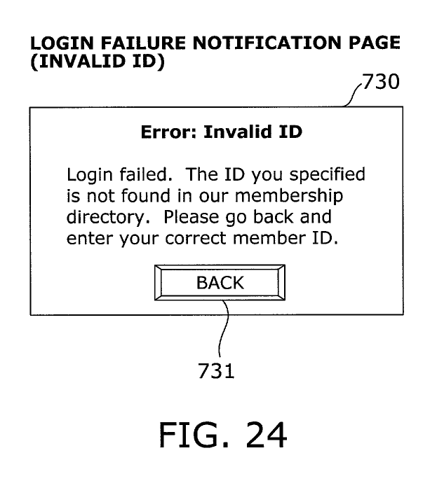

FIG. 24 shows an example of another login failure notification page 730 (invalid ID) displayed on a user terminal. This login failure notification page 730 contains a warning message that points out the use of an undefined ID, as well as indicating login failure as its consequence. The login failure notification page 730 also has a RETURN button 731 to allow the customer 24 to go back to the login page 710.

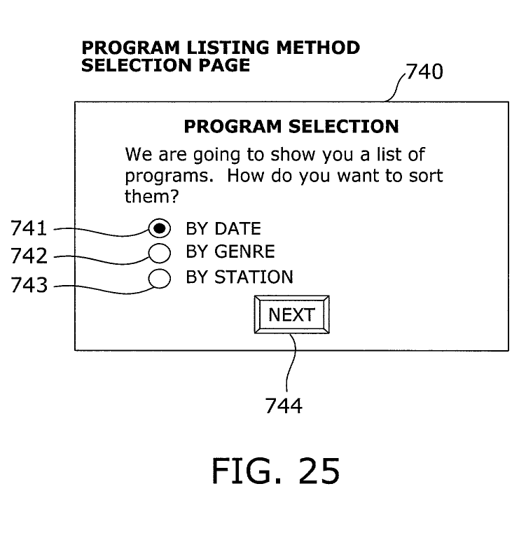

FIG. 25 shows an example of the program listing method selection page 740, which contains a plurality of check boxes 741 to 743 and a NEXT button 744. The customer 24 uses the check boxes 741 to 743 to specify in which method he/she wishes to browse a program schedule. The first check box 741 is selected when he/she wishes to have a program list sorted by date. The second check box 742 is selected when he/she wishes to have a program list sorted by genre. The third check box 743 is selected when he/she wishes to have a program list sorted by station.

The NEXT button 744 allows the customer 24 to finalize what he/she selected and proceeds to the next step. When the NEXT button 744 is pressed, the user terminal 510 notifies the automatic distribution server 100 of the selected method. This causes the automatic distribution server 100 to determine which method to use (step S204). A program selection page 750 appears, if “sort by date” option is selected. A genre selection page 760 appears if “sort by genre” option is selected. A station selection page 780 appears if “sort by station” option is selected.

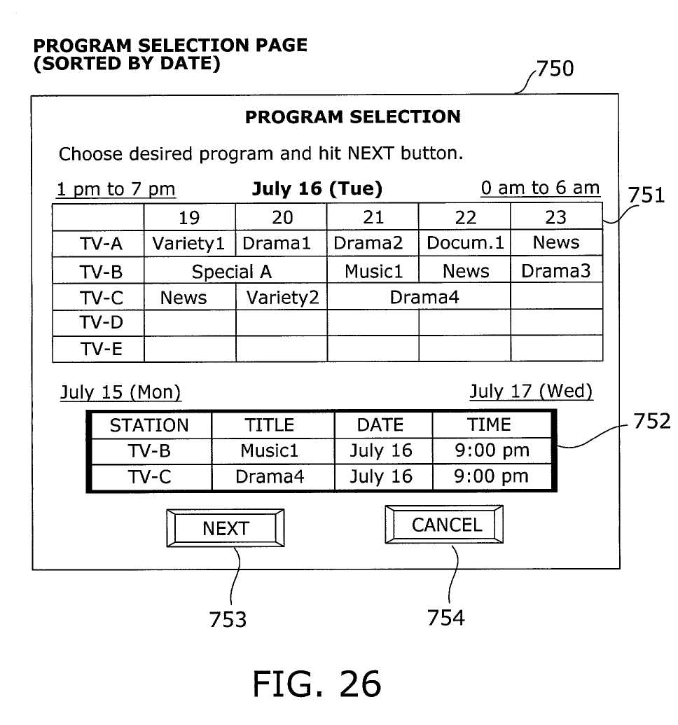

FIG. 26 shows an example of the program selection page 750 including a program list sorted by date. This page 750 contains a program schedule 751, a desired program list 752, a NEXT button 753, and a CANCEL button 754. The program schedule 751 shows all the programs available from every TV station in the form of a time line. The names of TV stations are listed vertically on the leftmost column of the program schedule 751, while the hours are shown on the topmost row, which allows the customer 24 to scroll the view along the time axis in the horizontal direction. Each cell, representing a particular time slot of a particular TV station, accommodates the title of a program if available. The customer 24 specifies a desired program in the program schedule 751 by selecting its title text.

The desired program list 752 shows a collection of program titles selected in the above-described way, along with the names of source stations, dates, and times. Each row of the desired program list 752 forms an associated set of parameters that are related to a particular program of the customer's choice. More specifically, the “Station” field shows the name of a TV station which provides a selected program. The “Title” field shows the title of that selected program. The “Date” and “Time” field show when the source TV station starts delivering the selected program.

The customer 24 presses the NEXT button 753 when he/she wishes to submit the desired program list 752 for registration. By pressing this NEXT button 753, the programs shown in the desired program list 752 are finalized as the candidates for registration, and the terminal screen changes to a schedule planning page 800 accordingly. The CANCEL button 754, on the other hand, allows the customer 24 to return to the previous page without submitting the desired program list 752. Pressing this CANCEL button 754 initiates a transition back to the program listing method selection page 740.

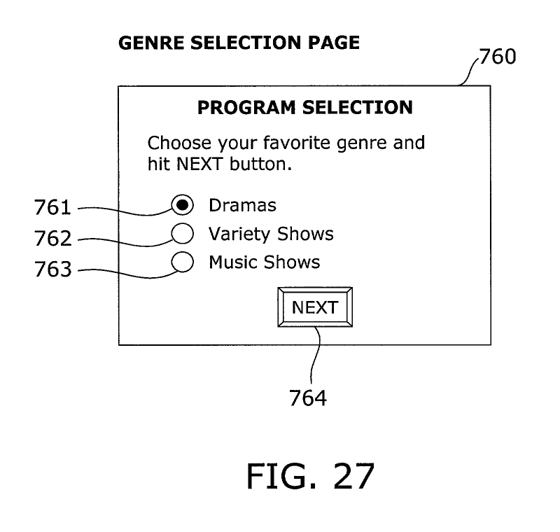

FIG. 27 shows an example of the genre selection page 760. The genre selection page 760 contains a plurality of check boxes 761 to 763 and a NEXT button 764. The check boxes 761 to 763 permit the customer 24 to select a desired program category, so that he/she can view a program listing compiled according to the selected category. More specifically, the first check box 761 is used to create a list of dramas. The second check box 762 is used to create a list of variety shows. The third check box 763 is used to create a list of music shows.

The NEXT button 764 allows the customer 24 to finalize what he/she selected and proceeds to the next step. Pressing this NEXT button 764 causes the user terminal 510 to notify the automatic distribution server 100 of the selected genre, which results in a screen transition to a program selection page 770 containing a program list of that genre.

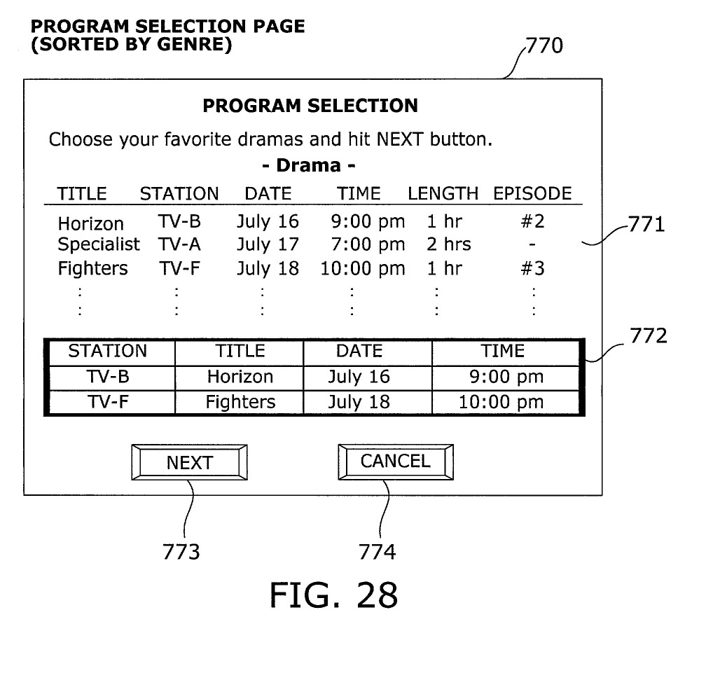

FIG. 28 shows an example of program selection page 770 including a list of programs that fall into a specified genre. The program selection page 770 is composed of a program listing field 771, a desired program list 772, a NEXT button 773, and a CANCEL button 774.

The program listing field 771 presents a list of programs that belongs to the genre that has been selected in the genre selection page 760, which is “Dramas” in the example of FIG. 28. Each row of the program listing field 771 shows the information on a specific drama program, which includes the title, source station, start date and time, program length, and episode number, where the last item indicates the number of the episode when the drama is provided as a series of episodes. The customer 24 specifies a desired program by selecting it in the program listing field 771.

The desired program list 772 shows a collection of program titles selected in the above-described way, along with the names of source stations and program start dates and times. Each row of the desired program list 772 forms an associated set of parameters that are related to a particular program of the customer's choice. More specifically, the “Station” field shows the name of a TV station which provides a selected program. The “Title” field shows the title of that selected program. The “Date” and “Time” fields show when the source TV station starts delivering the selected program, which are also referred to as the “program release date and time.”

The customer 24 presses the NEXT button 773 to submit the desired program list 772 for registration. By pressing this NEXT button 773, the programs shown in the desired program list 772 are finalized as the candidates for registration, and the terminal screen changes to a schedule planning page 800 accordingly. The CANCEL button 774, on the other hand, allows the customer 24 to return to the previous page without submitting the desired program list 772. Pressing this CANCEL button 774 initiates a transition back to the program listing method selection page 740.

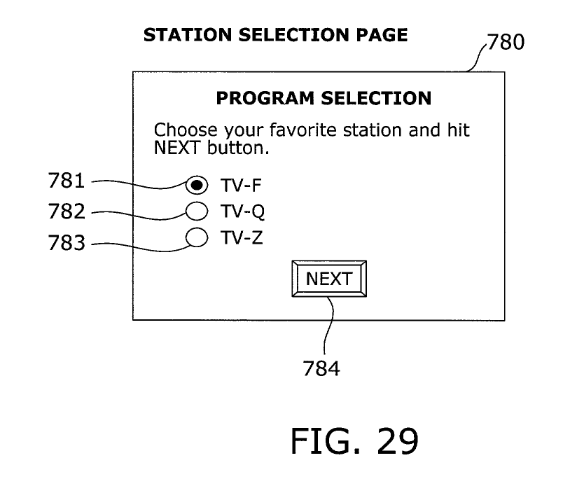

FIG. 29 shows an example of the station selection page 780. The station selection page 780 contains a plurality of check boxes 781 to 783 and a NEXT button 784. The check boxes 781 to 783 permit the customer 24 to select a desired source station, so that he/she can view a program listing compiled according to the selected station. More specifically, the first check box 781 is used to create a list of programs available from TV-F. The second check box 782 is used to create a list of programs available from TV-Q. The third check box 783 is used to create a list of programs available from TV-Z.

The NEXT button 784 allows the customer 24 to finalize what he/she selected and proceeds to the next step. Pressing this NEXT button 784 causes the user terminal 510 to notify the automatic distribution server 100 of the selected station, which results in a screen transition to a program selection page 790 containing a program list of that station.

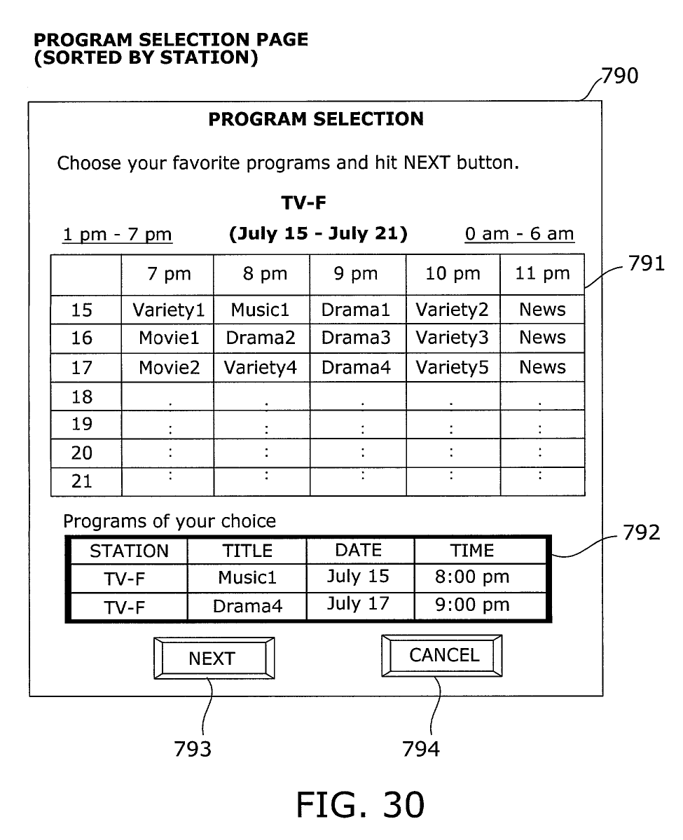

FIG. 30 shows an example of the program selection page 790 including a program list of a specified station. The program selection page 790 has the following components: a program listing field 791, a desired program list 792, a NEXT button 793, and a CANCEL button 794.

The program listing field 791 presents a list of programs that are provided from the source station that has been selected in the station selection page 780, which is “TV-F” in the example of FIG. 30. Each row of the program listing field 791 shows program titles available from TV-F on a specific date. The customer 24 specifies a desired program by selecting it in the program listing field 791.

The desired program list 792 shows a collection of program titles selected in the above-described way, along with the names of source stations and program start dates and times. Each row of the list 792 forms an associated set of parameters that are related to a particular program of the customer's choice. More specifically, the “Station” field shows the name of a TV station which provides a selected program. The “Title” field shows the title of that selected program. The “Date” and “Time” fields show when the source TV station starts delivering the selected program.

The customer 24 presses the NEXT button 793 to submit the desired program list 792 for registration. By pressing this NEXT button 793, the programs shown in the desired program list 792 are finalized as the candidates for registration, and the terminal screen changes to a schedule planning page 800 accordingly.

The CANCEL button 794, on the other hand, allows the customer 24 to return to the previous page without submitting the desired program list 792. Pressing this CANCEL button 794 initiates a screen transition back to the program listing method selection page 740.

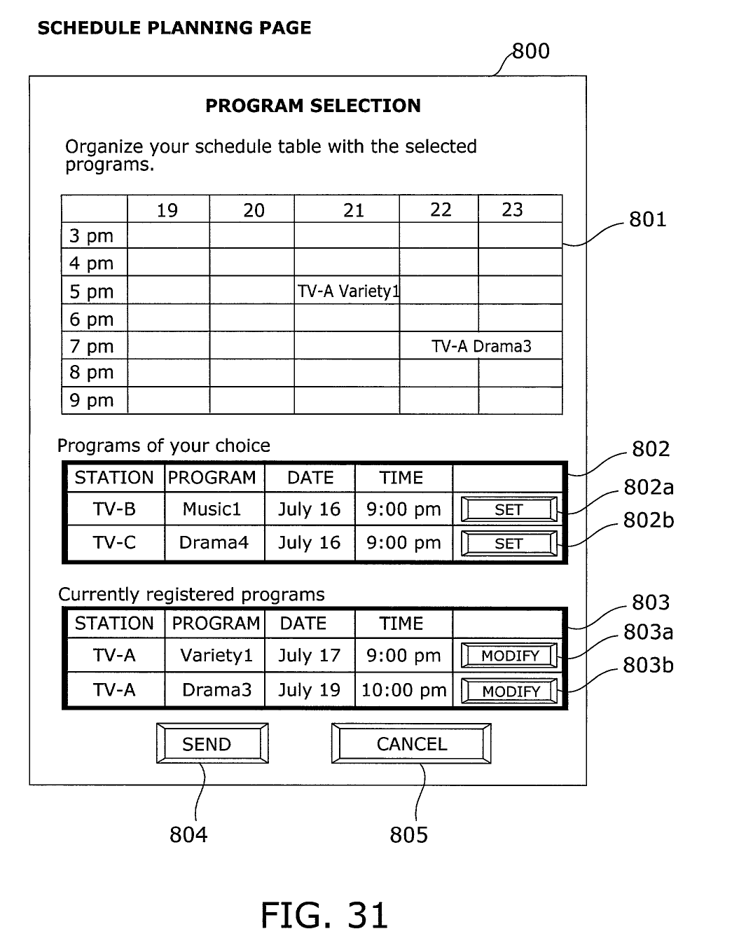

FIG. 31 shows an example of schedule planning page 800 appearing on the user terminal 510. The schedule planning page 800 has the following components: a schedule viewing area 801, a desired program list 802, a registered program list 803, a SEND button 804, and a CANCEL button 805.

The schedule viewing area 801 enables the customer 24 to see the current schedule data stored in his/her own schedule table. The schedule viewing area 801 provides such information in table form, the row and column representing scheduled delivery time and date, respectively. Each cell, representing a particular time slot for program delivery, accommodates the title of a program that is so scheduled.

The desired program list 802 shows a collection of program titles that are selected as the candidates for registration. Shown along with the titles are the names of source stations andn program titles and program start dates and times. Each row forms an associated set of parameters that are related to a particular program of the customer's choice. More specifically, the “Station” field shows the name of a TV station which provides a selected program. The “Program titles” field shows the title of that selected program. The “Date” and “Time” fields show when the source TV station starts delivering the selected program which are also reffered to as the “program release date and time.”

In addition to the program parameters, each row of the desired program list 802 has a SET button 802a and 802b at the right end. These SET buttons 802a and 802b are used to transfer an entry of the desired program list 802 to the customer's personal schedule table. When either of the SET buttons 802a and 802b is pressed, another window (i.e., detailed schedule planning page 810 associated with that button) will pop up.

The registered program list 803 shows the specifics of every program currently registered in the current schedule table, the columns of which give the names of source stations, program titles, and scheduled delivery dates and times. Each row of the registered program list 803 forms an associated set of parameters that are related to a particular program being registered. More specifically, the “Station” field shows the name of a TV station which provides a registered program. The “Program titles” field shows the title of that registered program. The “Date” and “Time” fields show when the program is to be delivered.

In addition to the program parameters, each row of the registered program list 803 has a MODIFY button 803a and 803b at the right end. These MODIFY buttons 803a and 803b are used to change the scheduled delivery of a program registered in the customer's personal schedule table. When either of the MODIFY buttons 803a and 803b is pressed, another window (i.e., detailed schedule planning page 810 associated with that button) will pop up.

The SEND button 804 is used to submit the selected or updated data to the automatic distribution server 100, thus rebuilding the schedule table from the content of the schedule viewing area 801 and registered program list 803. Pressing this SEND button 804 takes the customer 24 to the schedule confirmation page 820. The CANCEL button 805, on the other hand, is used to quit the present process without updating the program viewing schedule. Pressing this CANCEL button 805 takes the customer 24 to the main page 600 without changing his/her schedule.

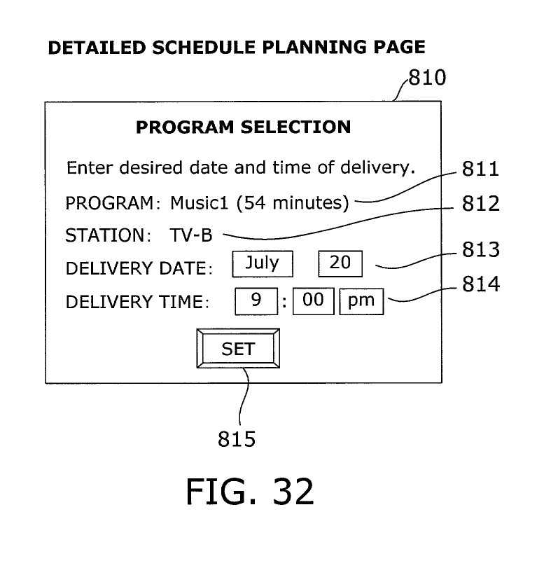

FIG. 32 shows an example of the detailed schedule planning page 810 appearing on the user terminal 510. The detailed schedule planning page 810 has the following components: a program title field 811, a station name field 812, a delivery date setting field 813, a delivery time setting field 814, and a SET button 815.

The program title field 811 indicates the title of the program of interest, together with its length in parentheses. The station name field 812 indicates the name of the source TV station that provides the program of interest. The customer 24 specifies when to view the program by filling out the delivery date setting field 813 and delivery time setting field 814 with his/her desired program delivery date and time. The SET button 815 initiates the registration of the data entered in the delivery date setting field 813 and delivery time setting field 814. By pressing this SET button 815, the delivery date and time specified in these fields 813 and 814 are submitted, and the customer 24 is brought back to the schedule planning page 800.

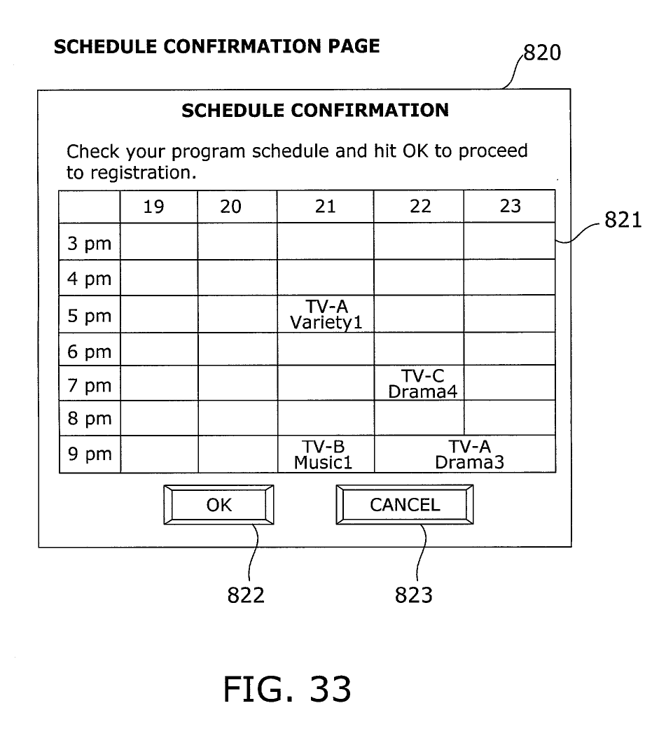

FIG. 33 shows an example of the schedule confirmation page 820 appearing on the user terminal 510. The schedule confirmation page 820 has a schedule viewing area 821, an OK button 822, and a CANCEL button 823.

The schedule viewing area 821 shows the updated schedule table of the customer 24, including new schedule data that was added in the schedule planning page 800. In the example of FIG. 33, the schedule viewing area 821 is presented in table form, the columns and rows representing the time and date, respectively. Each cell, representing a particular time slot for program delivery, accommodates the title of a program that is so scheduled.

The customer 24 presses the OK button 822 when he/she is sure that all the data items shown in the schedule viewing area 821 are correct. When this OK button 822 is pressed, the schedule data shown in the schedule viewing area 821 are sent out to the automatic distribution server 100, as well as being stored in a local storage unit of the user terminal 510. The automatic distribution server 100 updates the schedule table of the customer 24 with the received schedule data. The terminal screen then changes to a registration acknowledgment page 830. The CANCEL button 823, on the other hand, is used to quit the present process without updating the program viewing schedule. Pressing this CANCEL button 823 takes the customer 24 to the main page 600 without changing his/her schedule table.

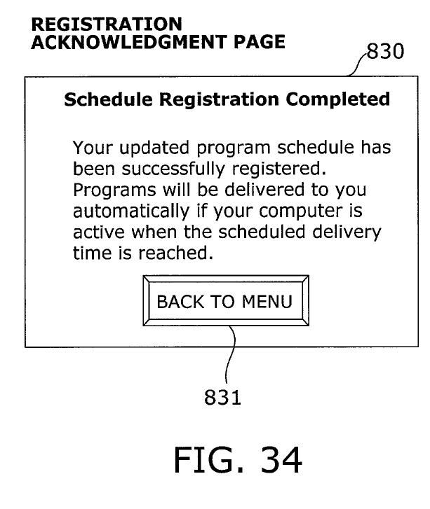

FIG. 34 shows an example of the registration acknowledgment page 830 appearing on the user terminal 510. The registration acknowledgment page 830 contains a message that reports successful completion of data updates, as well as providing a BACK TO MENU button 831. The BACK TO MENU button 831 brings the customer 24 back to the main page 600.

The above section has explained various pages for the customer 24 to select desired programs and set desired delivery times. The scheduled data defined in this way is recorded in both the user terminal 510 and automatic distribution server 100.

Now we move the focus to the processes of executing scheduled program delivery. An actual session of program delivery processing is triggered by a time event in the user terminal 510 which stores schedule data indicative of when to start viewing a program. First, the customer 24 runs a content viewing program on his/her user terminal 510, which monitors the current time of day in comparison with each scheduled delivery start time. When the time for receiving a program is reached, the user terminal 510 displays a pre-delivery notification page, thereby notifying the customer 24 of the start. The customer 24 then responds to the notification by indicating his/her acknowledgment to the user terminal 510. This permits the user terminal 510 to send a program delivery request to the automatic distribution server 100, thus initiating a program delivery session therein. Here, the program delivery request contains the member ID of the customer 24, which is stored in the user terminal 510 previously.

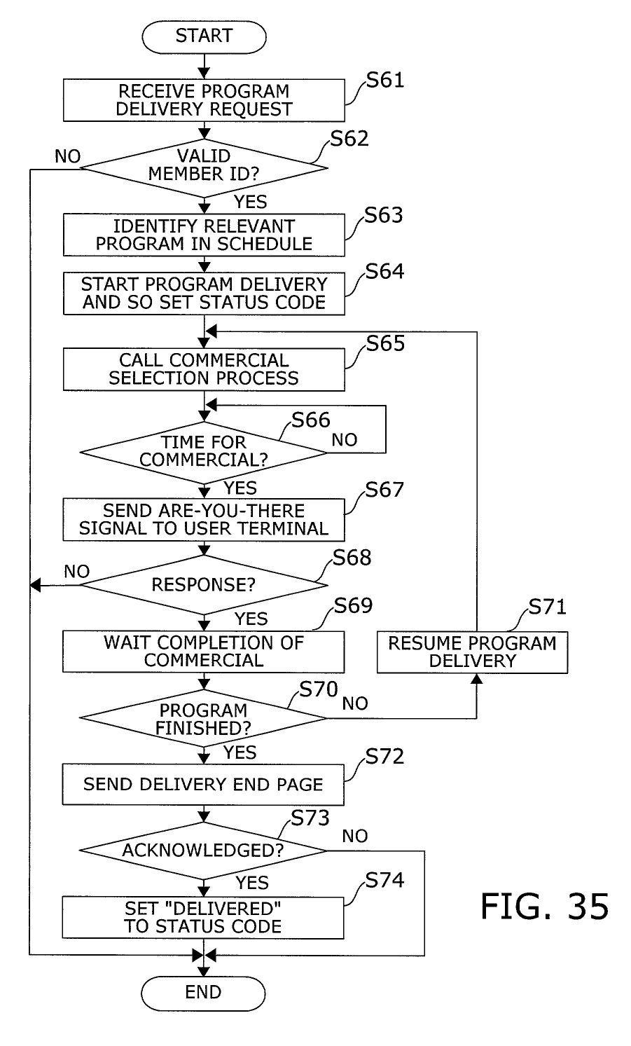

FIG. 35 is a flowchart of a program delivery process executed by the automatic distribution server 100. It is assumed here that each program is previously arranged such that some commercials will be inserted during delivery. According to the present embodiment, every program includes at least one commercial video clip that is played back at the end of its delivery session. The flowchart of FIG. 35 has the following steps:

(S61) The member authentication handler 120 receives a program delivery request from the user terminal 510.

(S62) The member authentication handler 120 extracts a member ID from the received request and determines whether it is registered in the membership table 111. If the received member ID is found in the table 111, the process advances to step S63. If not, the process is terminated here.

(S63) Consulting the schedule table of the customer 24, the schedule dispatcher 160 identifies which program is specified in the program delivery request.

(S64) The schedule dispatcher 160 commands the distribution manager 180 to start delivery of the specified program. At the same time, the schedule dispatcher 160 updates the delivery status field of the schedule table by setting a status code of “1” to indicate “delivery in progress.”

The distribution manager 180 now sends a delivery request to the video distribution server 200, specifying the requested program and its destination (i.e., the user terminal 510). In response to this request, the video distribution server 200 retrieves the specified video file from the program database 210 and transmits it to the user terminal 510 using video streaming techniques.

(S65) The commercial data manager 170 triggers a commercial selection process as will be described in detail later.

(S66) The distribution manager 180 monitors the progress of the present program and determines whether the scheduled advertisement time is reached. If so, the process advances to step S67. If not, the current step S66 is repeated.

(S67) The distribution manager 180 transmits an activation test signal (“are you there” signal) to the user terminal 510. The user terminal 510 is supposed to return a response if it is activated.

(S68) The distribution manager 180 determines whether any response signal has been returned from the user terminal 510 in response to the activation test signal. If there is a response signal, the process advances to step S69. If there is no response, the process is terminated.

(S69) The distribution manager 180 waits until the commercial is finished.

(S70) The distribution manager 180 determines whether the present program is finished. If so, the process advances to step S72. If not, the process proceeds to step S71.

(S71) The distribution manager 180 resumes the delivery of the program. The process then returns the step S65.

(S72) The distribution manager 180 transmits delivery end confirmation page data. This causes a delivery end confirmation page to appear on the screen of the user terminal 510, prompting the customer 24 to make an acknowledgment. The customer's acknowledgment is forwarded from the user terminal 510 to the automatic distribution server 100.

(S73) The distribution manager 180 waits for an acknowledgment signal. If it is received within a predetermined period after the transmission of delivery end confirmation page data, the process advances to step S74. If there is no acknowledgment signal, the process is terminated, without updating the delivery status.

(S74) The distribution manager 180 updates the schedule table by setting a status code “2” (“delivered”) to the delivery status field, thus indicating that the delivery is completed. The distribution manager 180 then exits from the process of FIG. 35.

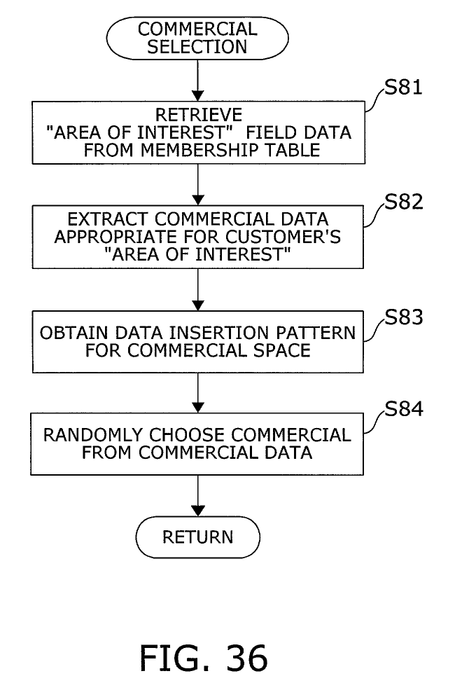

FIG. 36 is a flowchart of the advertisement selection process called at step S65 in the flowchart of f35. This process is executed according to the following steps:

(S81) The membership manager 110 knows the preferences of the customer 24 by retrieving relevant data from the “Area of Interest” field of the membership table 111.

(S82) The commercial data manager 170 picks up appropriate commercial files from the commercial table 172, according to the preference information obtained at step S81.

(S83) The distribution manager 180 obtains a data insertion pattern for use in a commercial area.

(S84) The commercial data manager 170 randomly chooses a commercial from among the commercials extracted at step S82. The control is then passed to step S66 of FIG. 35.

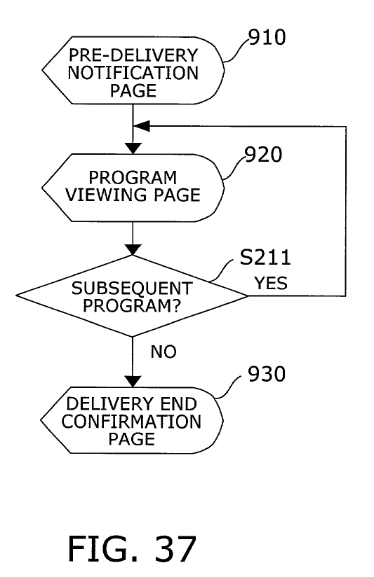

During the session of program delivery, the user terminal 510 presents various pages and dialogs to the customer 24. FIG. 37 shows an example of such screen transitions. Initially, a pre-delivery notification page 910 appears on the monitor screen of the user terminal 510 when a scheduled program delivery time is reached. The customer 24 then responds to the notification by indicating his/her acknowledgment to the user terminal 510. This causes a transition to a program viewing page 920, where the customer 24 can view the program. When the program delivery is finished, the automatic distribution server 100 determines whether any other program deliver is scheduled. If there is such a subsequent program, the user terminal 510 leaves the program viewing page 920 as it is. If there is no more programs to be delivered, the screen changes to a delivery end confirmation page 930. In this way, the customer 24 interacts with the user terminal 510 through the above-described pages during a program delivery session. The next section will provide a more specific example of each page.

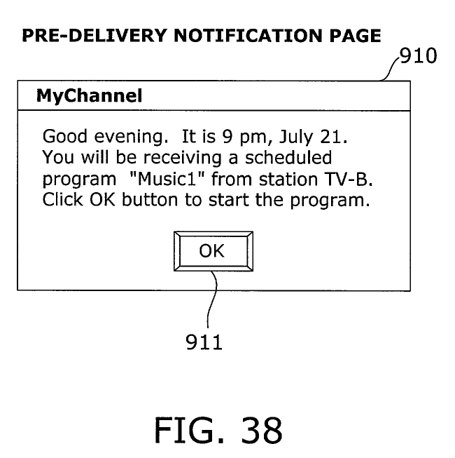

FIG. 38 shows an example of the pre-delivery notification page 910 appearing on the user terminal 510. The pre-delivery notification page 910 shows a message notifying the customer 24 that a scheduled program delivery shall begin. In addition, the pre-delivery notification page 910 has an OK button 911, which the customer 24 presses to make an acknowledgment to the notification message. When this OK button 911 is pressed, a delivery request signal is transmitted from the user terminal 510 to the automatic distribution server 100.

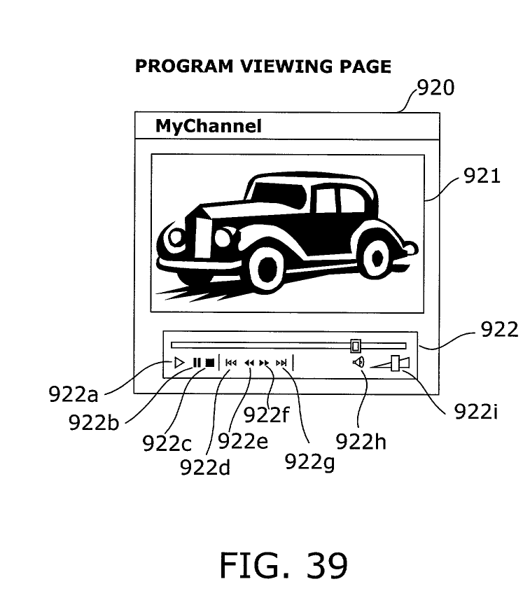

FIG. 39 shows an example of the program viewing page 920 appearing on the user terminal 510. The program viewing page 920 has a video display area 921 and a control bar 922. Streaming video images received from the video distribution server 200 are decoded and displayed in the video display area 921. The control bar 922 provides a playback button 922a, a pause button 922b, a stop button 922c, a program top button 922d, a rewind button 922e, a forward button 922f, a next program button 922g, a mute button 922h, and a volume adjustment bar 922i.

If the playback button 922a is pressed when the video is in pause mode, the video restarts from that position. The pause button 922b causes the ongoing video to pause, while the stop button 922c stops it completely. The program top button 922d allows the customer 24 to replay the program from the beginning. The rewind button 922e makes the video play backward, while the forward button 922f makes the video play forward at an increased frame rate. The next program button 922g allows the customer 24 to skip the current program and go to the next program. The mute button 922h is used to suppress the sound output temporarily. The volume control bar 922i has a slider button that varies the loudness according to its horizontal position.

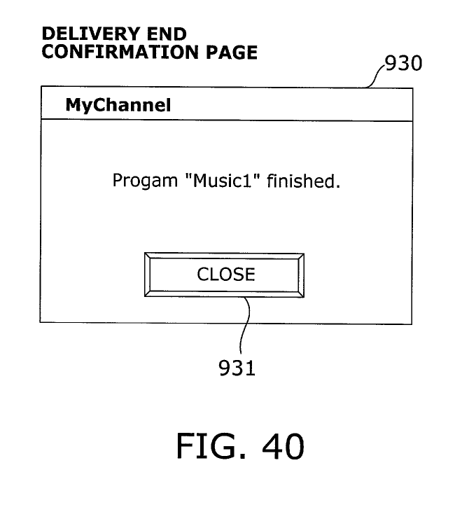

FIG. 40 shows an example of the delivery end confirmation page 930 appearing on the user terminal 510. The delivery end confirmation page 930 shows a message notifying the customer 24 of the completion of a program. It also has a CLOSE button 931, which is used to terminate the program viewing program. Pressing this CLOSE button 931 makes the delivery end confirmation page 930 disappear.

The above section has explained the process of executing scheduled program delivery. Now we move the focus to the provider-side management functions of the automatic distribution server 100, including registration of program content and commercials. The explanation starts with a program registration process, which is executed interactively with the program content provider 22.

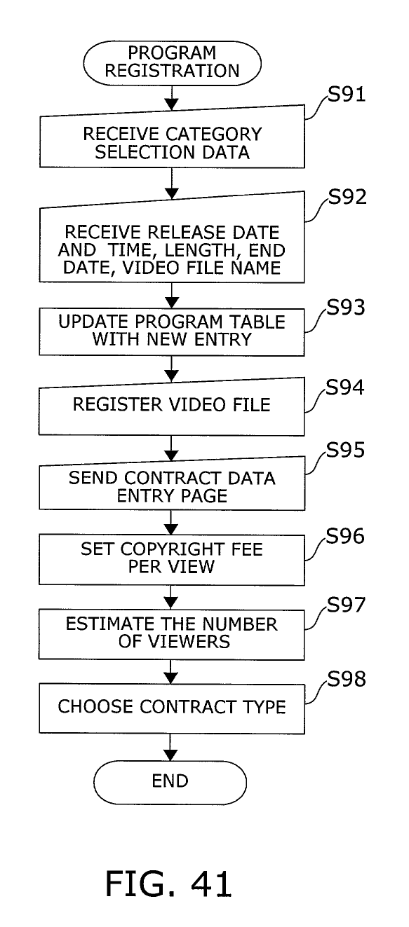

FIG. 41 is a flowchart of a program registration process. This process is invoked within the automatic distribution server 100 when the program content provider 22 makes access to the automatic distribution server 100 through the program editing station 310.

(S91) Through a category selection page (described later), the content manager 130 obtains category selection data from the program editing station 310.

(S92) Through a program information entry page (described later), the content manager 130 receives the program release date and time, length, distribution end date, and video file name from program editing station 310.

(S93) The content manager 130 updates the program table 132 with the information received from the program editing station 310 in steps S91 and S92.

(S94) The video distribution server 200 receives a video file from the program editing station 310 and enters it to the program database 210.

(S95) The content manager 130 sends contract information entry page data to the program editing station 310. This causes a contract information entry page to appear on the screen of the program editing station 310, which prompts the program content provider 22 to enter necessary data items. They include: copyright fee per viewer, estimated number of viewers, and contract type. Those pieces of contract information are transmitted from the program editing station 310 to the automatic distribution server 100.

(S96) The content manager 130 sets the received copyright fee information to the copyright management table 133.

(S97) The content manager 130 sets the estimated number of viewers to the copyright management table 133.

(S98) The content manager 130 sets the selected contract type to the copyright management table 133. More specifically, the system allows the program content provider 22 to choose an option about fee payment policies: (1) based on the estimated number of viewers or (2) based on the actual number of viewers.

The automatic distribution server 100 also accepts an offer of advertisement from a commercial provider 23. The next section describes a commercial registration process.

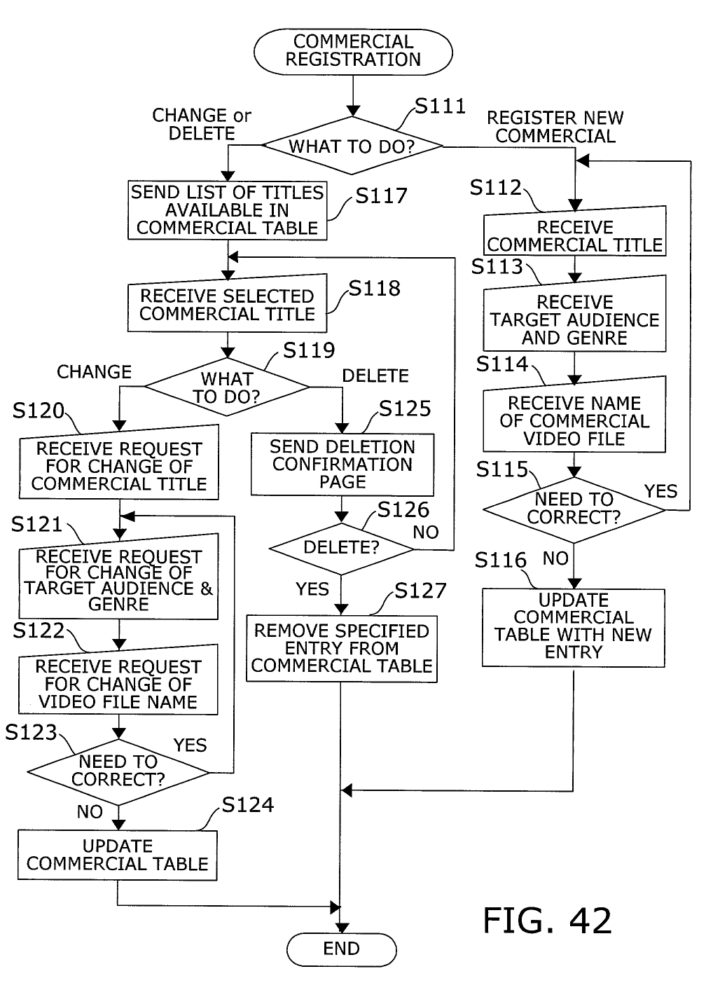

FIG. 42 is a flowchart of a commercial registration process. This process is invoked within the automatic distribution server 100 when a commercial provider 23 sends some request thereto through their commercial editing station 410. This process is executed according to the following steps:

(S111) The commercial data manager 170 determines what the commercial provider 23 is requesting. If it is a registration request for a new commercial, the process advances to step S112. If it is a request for change or deletion of a registered commercial, the process advances to step S117.

(S112) The commercial data manager 170 receives a commercial title from the commercial editing station 410.

(S113) The commercial data manager 170 receives information about target audience and category of advertisement from the commercial editing station 410.

(S114) The commercial data manager 170 receives the name of a commercial video file from the commercial editing station 410.

(S115) The commercial editing station 410 notifies the commercial data manager 170 of a correction, if any. If any correction is needed, the process returns to step S112. If there is no correction, the process advances to step S116.

(S116) The commercial data manager 170 updates the commercial table 172 with the information received at steps S112 to S114, and then it exits from the process of FIG. 42.

(S117) The commercial data manager 170 extracts relevant commercial titles from the commercial table 172 and transmits the resultant listing to the commercial editing station 410. The commercial provider 23 can browse the list on the screen of the commercial editing station 410.

(S118) The commercial data manager 170 is informed of a particular commercial title that is selected at the commercial editing station 410.

(S119) The commercial data manager 170 determines again what the commercial provider 23 is requesting. If it is a change to a registered commercial, the process advances to step S120. If it is a deletion of a registered commercial, the process advances to step S125.

(S120) The commercial data manager 170 accepts a request for changing the title of a specified commercial.

(S121) The commercial data manager 170 accepts a request for changing the target audience and category of a specified commercial.

(S122) The commercial data manager 170 accepts a request for changing the name of a specified commercial video file.

(S123) When it is necessary to correct the data entered at steps S121 and S122, the commercial editing station 410 so notifies the commercial data manager 170. If there is such a correction, the process returns to step S121. If not, the process advances to step S124.

(S124) The commercial data manager 170 updates the commercial table 172 with the data received at steps S120 to S122, and then it exits from the process of FIG. 42.

(S125) The commercial data manager 170 sends deletion confirmation page data to the commercial editing station 410. This causes a deletion confirmation page to appear on the screen of the commercial editing station 410, which prompts the commercial provider 23 to give permission for the deletion. The commercial editing station 410 then notifies the automatic distribution server 100 of the intention of the commercial provider 23.

(S126) From the notification from the commercial editing station 410, the commercial data manager 170 determines whether to carry out the deletion. If the deletion is confirmed, the process advances to step S127. If the deletion is cancelled, the process goes back to step S118.

(S127) The commercial data manager 170 removes the commercial selected at step S118 from the commercial table 172, and then it exits from the process of FIG. 42.

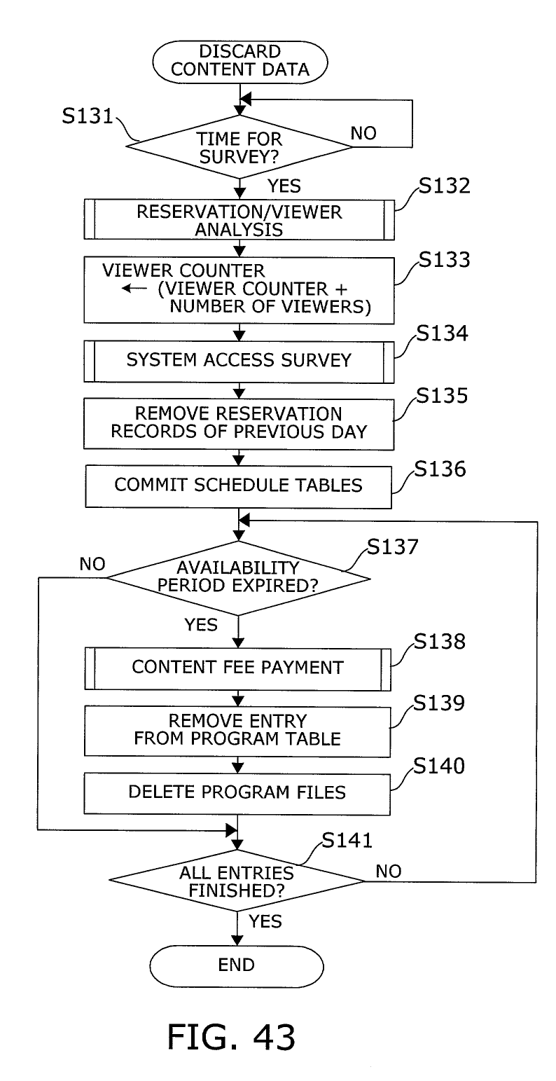

FIG. 43 is a flowchart of a content discarding process. This process is executed according to the following steps:

(S131) The system regularly collects data at predetermined intervals (e.g., everyday at 0 am) for the purpose of statistical survey. The data analyzer 190 determines whether it is the time for such data collection.

(S132) The data analyzer 190 performs statistical analysis about reservations and viewers, the details of which will be described later.

(S133) The data analyzer 190 updates the viewer counter of each program in the copyright management table 133. More specifically, the data analyzer 190 adds the number of actual viewers to the viewer counter field of the copyright management table 133.

(S134) The data analyzer 190 performs a system access survey, the details of which will be described later.

(S135) The data analyzer 190 removes reservation records of the previous day from the schedule tables.

(S136) The data analyzer 190 commits the schedule tables; i.e., it completes all related transactions so that they have definite states.

(S137) The data analyzer 190 determine whether the availability period of each program has expired. If so, the process advances to step S138. If not, the process advances to step S141.

(S138) The data analyzer 190 executes a content fee payment process, the details of which will be described later.

(S139) The data analyzer 190 removes the relevant entry of the program table 132.

(S140) The data analyzer 190 requests the video distribution server 200 to delete video files relevant to the expired program. The video distribution server 200 executes this request.

(S141) The data analyzer 190 determines whether all the program table entries are processed. If so, the process is terminated. If any unprocessed table entries remain, the process returns to step S137.

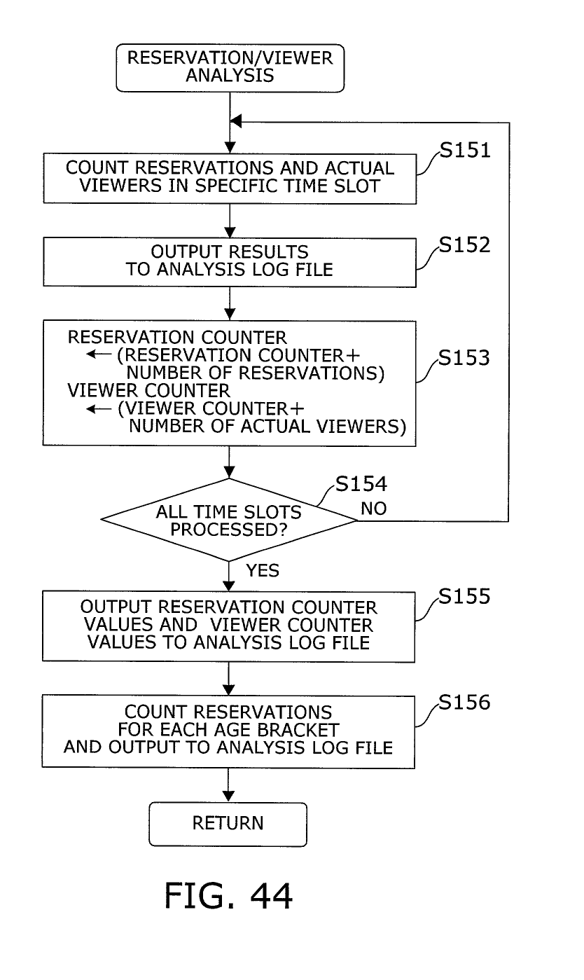

FIG. 44 is a flowchart of the reservation/viewer analysis that is called at step S132 in FIG. 43. This routine is executed according to the following steps:

(S151) Regarding a certain program, the data analyzer 190 counts the number of reservations, as well as the number of actual viewers, in a specific time slot.

(S152) The data analyzer 190 outputs the result of step S151 to an analysis log file.

(S153) The data analyzer 190 updates the reservation counter and viewer counter, which indicate the cumulative number of reservations and actual viewers, respectively. More specifically, the number of reservations obtained at step S151 is added to the reservation counter, and likewise, the number of actual viewers obtained at step S151 is added to the viewer counter.

(S154) The data analyzer 190 determines whether all time slots are processed. If any unprocessed time slots remain, the process returns to step S151. If all the time slots are finished, the process advances to step S155.

(S155) Now that the reservation counter and viewer counter are updated, the data analyzer 190 outputs their values to the analysis log file.

(S156) The data analyzer 190 counts the number of reservations for each individual age bracket and outputs the values to the analysis log file. The control is returned to the calling process, i.e., step S133 of FIG. 43.

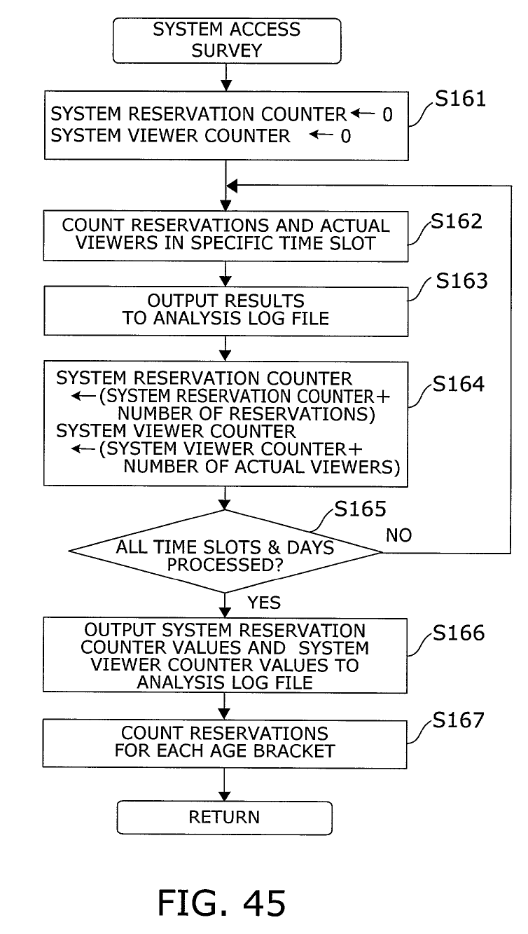

FIG. 45 is a flowchart of the system access survey routine that is called at step S134 in FIG. 43. This routine is executed according to the following steps:

(S161) The data analyzer 190 clears a system reservation counter to zero. It also clears a system viewer counter to zero.

(S162) For a specific time slot, the data analyzer 190 counts the number of reservations, as well as the number of actual viewers, concerning the entire system in a pertinent time slot.

(S163) The data analyzer 190 outputs the result of step S162 to the analysis log file.

(S164) The data analyzer 190 updates the system reservation counter and system viewer counter. More specifically, the number of reservations obtained at step S162 is added to the system reservation counter, and likewise, the number of actual viewers obtained at step S162 is added to the system viewer counter.

(S165) The data analyzer 190 determines whether there is any unprocessed time slot on other unfinished day of the week. If there is any unprocessed time slots or days, the process returns to step S162. If all time slots and days are finished, the process advances to step S166.

(S166) Now that the system reservation counter and viewer counter are updated, the data analyzer 190 outputs their values to the analysis log file.

(S167) The data analyzer 190 counts the number of reservations for each individual age bracket. The control is then returned to the calling process, i.e., step S135 of FIG. 43.

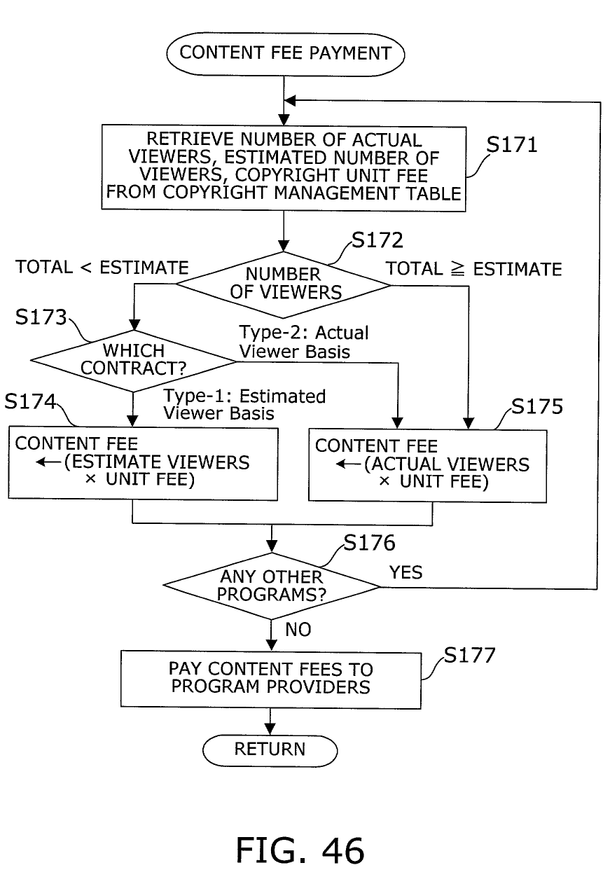

FIG. 46 is a flowchart of the content fee payment routine, which is called at step S138 in FIG. 43. This routine is executed according to the following steps:

(S171) The data analyzer 190 chooses one program from among those listed in the copyright management table 133 and reads the number of actual viewers, the estimated number of viewers, and copyright unit fee of that program.

(S172) The data analyzer 190 compares the total number of viewers with the estimated number of viewers. If the total number of viewers is smaller than the estimated number of viewers, the process advances to step S173. If the total number of viewers is not smaller than the estimated number of viewers, the process advances to step S175.

(S173) The data analyzer 190 refers to the copyright management table 133 to determine which contract type applies, type-1 or type-2. If it is a type-1 contract (estimated viewer basis), the process advances to step S174. If it is a type-2 contract (actual viewer basis), the process advances to step S175.

(S174) The data analyzer 190 calculates the content fee on an estimated viewer basis. More specifically, the content fee is calculated as the product of the estimated number of viewers and the predefined copyright unit fee. The process then advances to step S176.

(S175) The data analyzer 190 calculates the content fee on an actual viewer basis. More specifically, the content fee is calculated as the product of the total number of viewers and the predefined copyright unit fee.

(S176) The data analyzer 190 determines whether any other programs need calculation of content fees. If there is such an unprocessed program, the process returns to step S171 for the next program. If not, the process advances to step S177.

(S177) The data analyzer 190 makes payments of content fees. More specifically, the data analyzer 190 gives notice of content fee payments to the program editing station 310 of each individual content provider. At the same time, the data analyzer 190 requests the computers of relevant financial institutions to transfer money to their accounts. The control is then returned to the calling process, i.e., step S139 of FIG. 43.

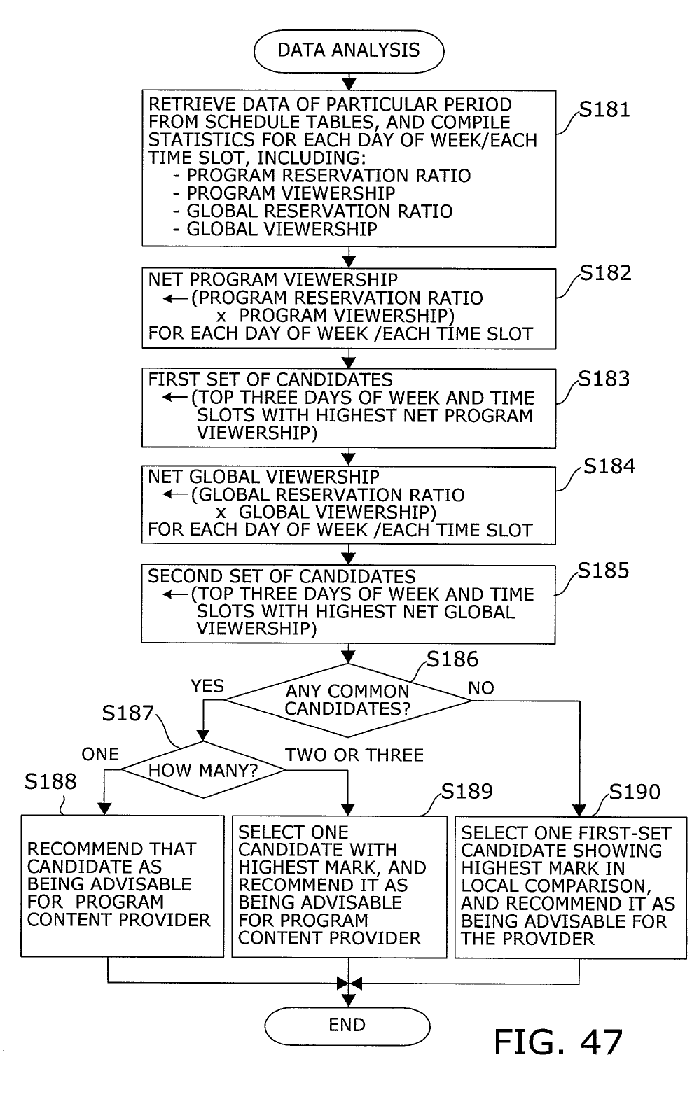

FIG. 47 is a flowchart of a data analyzing process. This process is executed according to the following steps:

(S181) The data analyzer 190 scans the schedule tables to retrieve data for a particular period. It then compiles the statistics in various aspects, for each day of week or for each time slot. The statistics may include: program reservation ratio, program viewership, global reservation ratio, and global viewership.

The program reservation ratio in a particular time slot is calculated by dividing the number of reservations in that time slot by the total number of reservations. The program viewership in a particular time slot is calculated by dividing the number of viewers in that time slot by the total number of viewers. The global reservation ratio of a particular program is calculated by dividing the number of reservations of that program by the service's total number of reservations. The global viewership of a particular program is calculated by dividing the number of viewers of that program by the service's total number of viewers.

(S182) The data analyzer 190 calculates net program viewership, both for each day of week and for each time slot. The net program viewership is calculated by multiplying the program reservation ratio by the program viewership.

(S183) Regarding each particular program, the data analyzer 190 chooses top three days of week, as well as top three time slots, that exhibit high marks in net viewership. These items form a set of candidates for recommended day of week or recommended time slot in local comparison as to that particular program.

In this way, the steps S182 and S183 identify high-performing days of week and time slots that attract many customers who wish to view a particular program, which are regarded as the first set of candidates for recommended service hours.

(S184) The data analyzer 190 calculates net global viewership, both for each day of week and for each time slot. The net global viewership is calculated by multiplying the global reservation ratio by the global viewership.

(S185) Through a global comparison covering all program services, the data analyzer 190 chooses top three days of week, as well as top three time slots, that exhibit high marks in net global viewership. These items form another set of candidates for recommended day of week or recommended time slot in global comparison.

In this way, the steps S184 and S185 identify high-performing days of week and time slots that attract many customers who wish to view either program available, which are regarded as the second set of candidates for recommended service hours.

(S186) The data analyzer 190 compare the first set of candidates with the second set of candidates, which is, in other words, comparison between the programwise tendency of viewership and the system's general tendency of viewership. The data analyzer 190 then identifies such items that are commonly included in the first and second sets of candidates. If there is any such items, the process advances to step S187. If not such items are found, the process branches to step S190.

(S187) The data analyzer 190 determines how many common candidates exist. If there is only one common candidate, the process advances to step S188. If there are two or more such candidates, the process advances to step S189.

(S188) The data analyzer 190 recommends the common candidate (day of week, time slot) as being advisable for the program content provider 22. The data analyzer 190 sends this information to the program editing station 310, so as to offer a “recommended scheduling policy” to the program content provider 22. The recommended scheduling policy encourages them to set the program release date to a particular day of week or time slot. The data analysis process is then terminated here.

(S189) Now that there are a plurality of candidates, the data analyzer 190 has to narrow down them to one. More specifically, it chooses one candidate that shows the highest mark in local comparison (i.e., comparison within the program) and recommends that candidate (day of week, time slot) as being advisable for the program content provider 22. The data analyzer 190 sends this information to the program editing station 310, so as to offer a recommended scheduling policy to the program content provider 22. The data analysis process is then terminated here.

(S190) The data analyzer 190 chooses one of the first set of candidates that shows the highest mark in local comparison (i.e., comparison within the program) and recommends that candidate (day of week, time slot) as being advisable for the program content provider 22. The data analyzer 190 sends this information to the program editing station 310, so as to offer a recommended scheduling policy to the program content provider 22. The data analysis process is then terminated here.

The next section will present specific examples of data tables produced by the data analyzer 190.

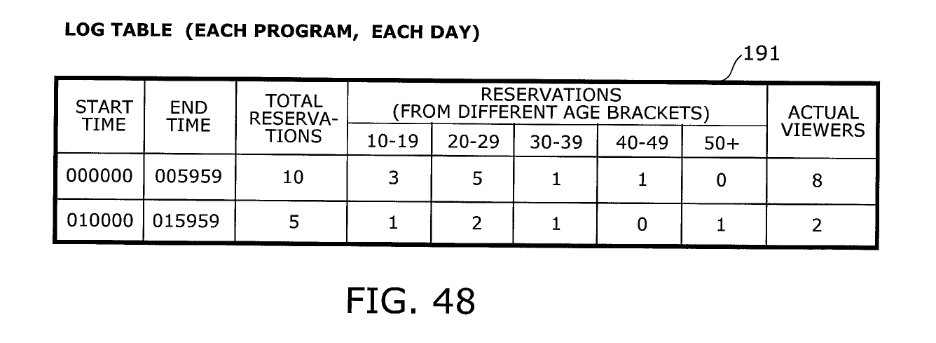

FIG. 48 shows an example of a log table 191 for each program. This log table 191 has the following data fields: “Start Time,” “End Time,” “Total Reservations,” “Reservations 10-19,” “Reservations 20-29,” “Reservations 30-39,” “Reservations 40-49,” “Reservations 50+”, and “Actual Viewers.” Each row of the log table 191 forms an associated set of log records regarding a specific time period.

The “Start Time” field indicates the beginning of each time period during which the data analyzer 190 collects and summarizes statistical data, while the “End Time” filed shows the end of that time period. The “Total Reservations” field shows the number of reservations received during a specific time period. The “Reservations 10-19” field shows the number of reservations received from the age bracket of 10 to 19. The “Reservations 20-29” field shows the number of reservations received from the age bracket of 20 to 29. The “Reservations 30-39” field shows the number of reservations received from the age bracket of 30 to 39. The “Reservations 40-49” field shows the number of reservations received from the age bracket of 40 to 49. The “Reservations 50+” field shows the number of reservations received from the age bracket of 50 and over. The “Actual Viewers” field shows the number of customers who actually viewed the program of interest during a specific time period.

In the example of FIG. 48, the first table entry provides statistics during a time period from “000000” (00:00:00) to “005959” (00:59:59). In this one-hour period, the system received ten reservations, including: three from the 10-19 age bracket, five from the 20-29 age bracket, one from the 30-39 age bracket, and one from the 40-49 age bracket. There were no reservation from the 50+age bracket. Despite the ten reservations, eight customers actually viewed the program.

The second table entry provides statistics during the subsequent time period from “010000” (01:00:00) to “015959” (01:59:59). In this one-hour period, the system received five reservations, including: one from the 10-19 age bracket, two from the 20-29 age bracket, one from the 30-39 age bracket, and one from the 50+ age bracket. There were no reservation from the

40-49 age bracket. Out of the five reservations, only two customers actually viewed the program.

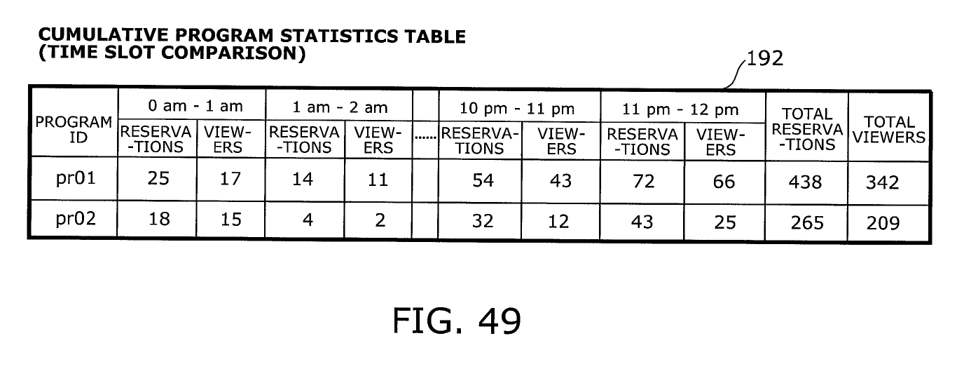

FIG. 49 gives an example of a cumulative program statistics table, which shows the number of reservations and viewers in different time slots. This cumulative program statistics table 192 has the following data fields: “Program ID,” “0 am-1 am Reservations,” “0am-1am Viewers,” “1 am-2 am Reservations,” “1 am-2 am Viewers,”. . . “10 pm-11 pm Reservations,” “10 pm-11 pm Viewers,” “11pm-12pm Reservations,” “11 pm-12 pm Viewers,” “Total Reservations,” and “Total Viewers.” Although FIG. 49 omits a middle part of the table 192 because of space limitation, the cumulative program statistics table 192 contains records of all one-hour-long time slots. Each row of the table 192 forms an associated set of statistical records.

More specifically, the “Program ID” field stores an identification code for distinguishing individual programs from each other. The “0 am-1 am Reservations” field indicates the number of reservations received during the period from 0 am to 1 am. The “0 am-1 am Viewers” field indicates the number of actual viewers who viewed the program during the period from 0 am to 1 am. The “1 am-2 am Reservations” field indicates the number of reservations received during the period from 1 am to 2 am. The “1 am-2 am Viewers” field indicates the number of actual viewers who viewed the program during the period from 0 am to 1 am. Likewise, the table 192 alternately shows the number of reservations and that of actual viewers in the subsequent one-hour-long time slots. The “10 pm-11 pm Reservations” field indicates the number of reservations received during the period from 10 pm to 11 pm. The “10 pm-11 pm Viewers” field indicates the number of actual viewers who viewed the program during the period from 10 pm to 11 pm. The “11 pm-12 pm Reservations” field indicates the number of reservations received during the period from 11 pm to 12 pm. The “11 pm-12 pm Viewers” field indicates the number of actual viewers who viewed the program during the period from 11 pm to 12 pm. The “Total Reservations” field indicates the number of reservations received during that day. The “Total Viewers” field indicates the number of actual viewers who viewed the program during that day.

In the example of FIG. 49, the first table entry shows the performance of a program “pr01” as follows. During the first time slot of 0 am to 1 am, there were 25 reservations and 17 viewers. During the second time slot of 1 am to 2 am, there were 14 reservations and 11 viewers. During the twenty-third time slot of 10 pm to 11 pm, there were 54 reservations and 43 viewers. During the twentyfourth time slot of 11 pm to 12 pm, there were 72 reservations and 66 viewers. The reservations amounted to a total of 438, while the actual viewers amounted to a total of 342.

The second table entry shows the performance of another program “pr02” as follows. During the first time slot of 0 am to 1 am, there were 18 reservations and 15 viewers. During the second time slot of 1 am to 2 am, there were 4 reservations and 2 viewers. During the twenty-third time slot of 10 pm to 11 pm, there were 32 reservations and 12 viewers. During the twenty-fourth time slot of 11 pm to 12 pm, there were 43 reservations and 25 viewers. The reservations amounted to a total of 265, while the actual viewers amounted to a total of 209.

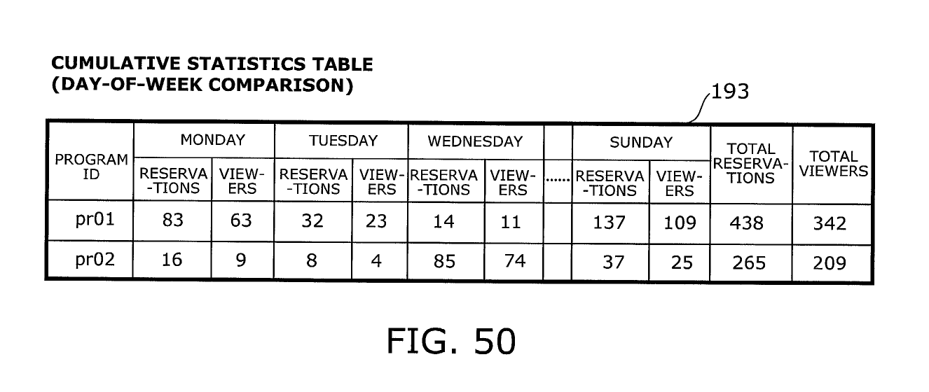

FIG. 50 gives an example of another cumulative program statistics table, which shows the number of reservations and viewers in each day of the week. This table 193 has the following data fields: “Program ID,” “Monday Reservations,” “Monday Viewers,” “Tuesday Reservations,” “Tuesday Viewers,” “Wednesday Reservations,” “Wednesday Viewers,” . . . “Sunday Reservations,” “Sunday Viewers,” “Total Reservations”, “Total Viewers.” Although FIG. 50 omits Thursday, Friday, and Saturday because of space limitation, the cumulative program statistics table 193 contains similar records for them, too. Each row of the table 193 forms an associated set of statistical records.

More specifically, the “Program ID” field stores an identification code for distinguishing individual programs from each other. The “Monday Reservations” field indicates the number of customers who made reservations on Monday. The “Monday Viewers” field indicates the number of customers who viewed the program on Monday. The “Tuesday Reservations” field indicates the number of customers who made reservations on Tuesday. The “Tuesday Viewers” field indicates the number of customers who viewed the program on Tuesday. The “Wednesday Reservations” field indicates the number of customers who made reservations on Wednesday. The “Wednesday Viewers” field indicates the number of customers who viewed the program on Wednesday. Similarly, there are records of Thursday, Friday, and Saturday. The “Sunday Reservations” field indicates the number of customers who made reservations on Sunday. The “Sunday Viewers” field indicates the number of customers who viewed the program on Sunday. The “Total Reservations” field indicates the number of reservations received during that day. The “Total Viewers” field indicates the number of actual viewers who viewed the program during that day.

In the example of FIG. 50, the first table entry shows the performance of a program “pr01” as follows. On Monday, there were 83 reservations and 63 viewers. On Tuesday, there were 32 reservations and 23 viewers. On Wednesday, there were 14 reservations and 11 viewers. On Sunday, there were 137 reservations and 109 viewers. The reservations amounted to a total of 438, while the actual viewers amounted to a total of 342.

The second table entry shows the performance of another program “pr02” as follows. On Monday, there were 16 reservations and 9 viewers. On Tuesday, there were 8 reservations and 4 viewers. On Wednesday, there were 85 reservations and 74 viewers. On Sunday, there were 37 reservations and 25 viewers. The reservations amounted to a total of 265, while the actual viewers amounted to a total of 209.

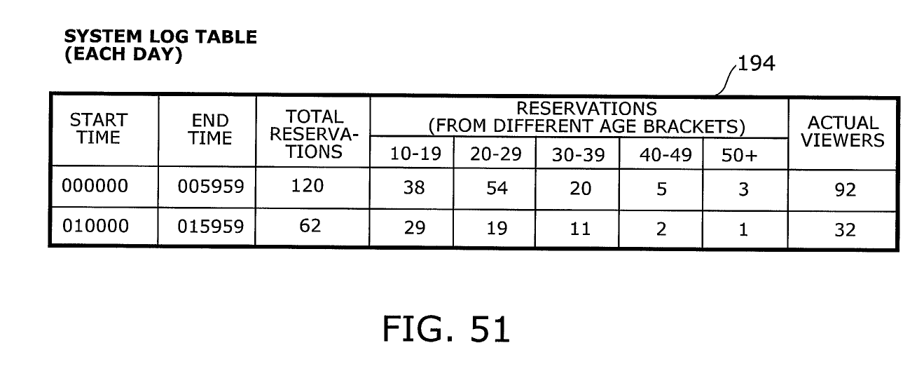

FIG. 51 shows an example of a system log table complied for each day. The system log table 194 has the following data fields: “Start Time,” “End Time,” “Total Reservations,” “Reservations 10-19,” “Reservations 20-29,” “Reservations 30-39,” “Reservations 40-49,” “Reservations 50+”, and “Actual Viewers.” Each row of this table 194 forms an associated set of log records regarding one specific time period.

The “Start Time” field indicates the beginning of each time period during which the data analyzer 190 collects and summarizes statistical data, while the “End Time” filed shows the end of that time period. The “Total Reservations” field shows the number of reservations received during a specific time period. The “Reservations 10-19” field shows the number of reservations received from the age bracket of 10 to 19. The “Reservations 20-29” field shows the number of reservations received from the age bracket of 20 to 29. The “Reservations 30-39” field shows the number of reservations received from the age bracket of 30 to 39. The “Reservations 40-49” field shows the number of reservations received from the age bracket of 40 to 49. The “Reservations 50+” field shows the number of reservations received from the age bracket of 50 and over. The “Actual Viewers” field shows the number of customers who actually received program delivery service during a specific time period.

In the example of FIG. 51, the first table entry provides statistics during a time period from “000000” (00:00:00) to “005959” (00:59:59). In this one-hour period, the system received 120 reservations, including: 38 from the 10-19 age bracket, 54 from the 20-29 age bracket, 20 from the 30-39 age bracket, five from the 40-49 age bracket, and three from the 50+ age bracket. Out of those 120 reservations, 92 customers actually received program delivery service. Likewise, the second table entry provides the statistics during another time period from “010000” (01:00:00) to “015959” (01:59:59). In this onehour period, the system received 62 reservations in total, including: 29 from the 10-19 age bracket, 19 from the 20-29 age bracket, 11 from the 30-39 age bracket, two from the 40-49 age bracket, and one from the 50+ age bracket. Out of those 62 reservations, 32 customers actually received program delivery service.

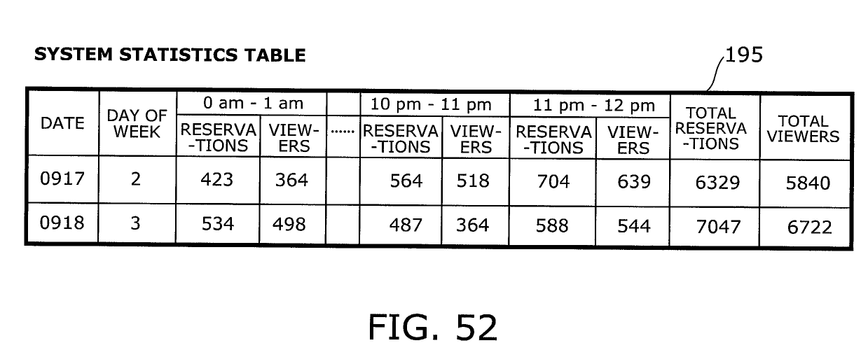

FIG. 52 shows an example of a system statistics table 195. The system statistics table 195 has the following data fields: “Date,” “Day of Week,” “0 am-1 am Reservations,” “0 am-1 am Viewers,” . . . “10 pm-11 pm Reservations,” “10 pm-11 pm Viewers,” “11 pm-12 pm Reservations,” “11 pm-12 pm Viewers,” “Total Reservations,” and “Total Viewers.” Although FIG. 52 omits a middle part of the table 195 due to space limitation, the system statistics table 195 contains records of all one-hour-long time slots. Each row of the table 195 forms a summary of statistical records in a particular day.

The “Date” and “Day of Week” fields indicate what time period the summary represent. Note that, in the present embodiment, the day of week is expressed in a one-digit code that has a value ranging from 1 to 7 to represent Monday to Sunday, respectively. The “0 am-1 am Reservations” field indicates the system's total number of reservations that were received during the period from 0 am to 1 am. The “0 am-1 am Viewers” field indicates the system's total number of viewers who actually received program delivery service during the period from 0 am to 1 am. Likewise, the system statistics table 195 alternately shows the number of reservations and that of actual viewers in the subsequent one-hour-long time slots. The “10 pm-11 pm Reservations” field indicates the system's total number of reservations in the period from 10 pm to 11 pm. The “10 pm-11 pm Viewers” field indicates the system's total number of actual viewers in the period from 10 pm to 11 pm. The “11 pm-12 pm Reservations” field indicates the system's total number of reservations in the period from 11 pm to 12 pm. The “11 pm-12 pm Viewers” field indicates the system's total number of actual viewers in the period from 11 pm to 12 pm. The “Total Reservations” field indicates the system's total number of reservations that are received in a day. The “Total Viewers” field indicates the system's total number of viewers who actually received program delivery service in a day.

In the example of FIG. 52, the first table entry provides the statistics of Tuesday, September 17 as follows. During the first time slot of 0 am to 1 am, there were 423 reservations and 364 viewers. During the twenty-third time slot of 10 pm to 11 pm, there were 564 reservations and 518 viewers. During the twenty-fourth time slot of 11 pm to 12 pm, there were 704 reservations and 639 viewers. In that day, the reservations amounted to a total of 6329, while the actual viewers amounted to a total of 5840.

The second table entry provides the statistics of Wednesday, September 18 as follows. During the first time slot of 0 am to 1 am, there were 534 reservations and 498 viewers. During the twenty-third time slot of 10 pm to 11 pm, there were 487 reservations and 364 viewers. During the twenty-fourth time slot of 11 pm to 12 pm, there were 588 reservations and 544 viewers. In that day, the reservations amounted to a total of 7047, while the actual viewers amounted to a total of 6722.

The next section will now explain various pages and their transitions in order to explain how the program content provider 22 interacts with their program editing station 310, as well as showing how the commercial provider 23 interacts with their commercial editing station 410. Note that the present embodiment is designed to offer a common main page for use by the program content provider 22 and commercial provider 23. By choosing appropriate items from a common menu, the two parties would then proceed to different pages to carry out different tasks, such as program registration, commercial registration, and service statistics analysis.

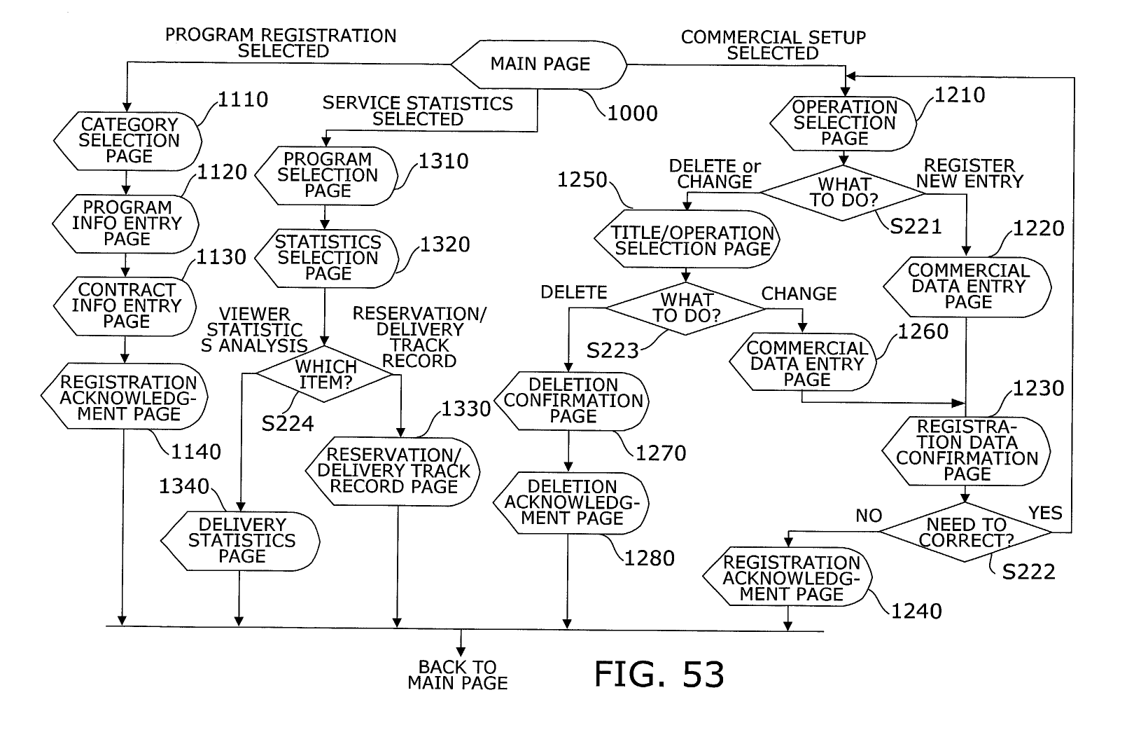

FIG. 53 shows an example of page transitions that happen on the program editing station 310 and commercial editing station 410 according to input device operations made by the program content provider 22 and commercial provider 23, respectively. For simplicity of explanation, the term “operator” will be used, where appropriate, to refer to the program content provider 22 or commercial provider 23.

When an access is made to the automatic distribution server 100, the program editing station 310 and commercial editing station 410 receives a main page 1000 with a menu for partners. The menu in the main page 1000 includes such selection items as “program registration,” “commercial setup,” and “service statistics.” When program registration is selected, the screen changes to a category selection page 1110. When commercial setup is selected, the operator is then brought to an operation selection page 1210. When service statistics is selected, the screen changes to a program selection page 1310.

Suppose here that the category selection page 1110 is present before the operator. Selecting an appropriate program category causes a screen transition to a program information entry page 1120. The operator then fills out program title and text boxes in the program information entry page 1120, which takes him/her to a contract information entry page 1130. The contract information entry page 1130 prompts the operator to enter information about copyright fees and the like. When this is finished, the screen changes to a registration acknowledgment page 1140. The operator then checks the content of the registration acknowledgment page 1140 and goes back to the main page 1000.

Now suppose that the operation selection page 1210 is present in front of the operator. When he/she selects a desired operation, that selection is identified by the automatic distribution server 100 (step S221). If it is “register new entry,” the screen changes to a commercial data entry page 1220. If it is “delete or change,” a title/operation selection page 1250 appears.

After entering various data in the commercial data entry page 1220, the operator proceeds to a registration data confirmation page 1230, which provides a summary of the registration data that he/she entered. The operator's response causes the automatic distribution server 100 to determine whether the data needs correction (step S222). If any correction is needed, the operator can return to the operation selection page 1210. If there is no correction, the screen changes to a registration acknowledgment page 1240. Pressing BACK button in this page 1240 takes the operator back to the main page 1000.

Suppose that the operator is facing the title/operation selection page 1250. When he/she chooses either “delete” or “change” in this page 1250, the selection is examined by the automatic distribution server 100 (step S223). If it is a request for changing a registered commercial, then the screen changes to a commercial data entry page 1260. Modification made in the commercial data entry page 1260 causes a transition to the registration data confirmation page 1230. Referring back to step S223, if it is a request for deleting an existing commercial, then the screen changes to a deletion confirmation page 1270. The operator confirms the deletion request, which brings himself/herself to a deletion acknowledgment page 1280. Pressing OK button in this page 1280 causes a transition back to the main page 1000.

Now suppose that the program selection page 1310 is displayed. The operator's selection of a particular program causes a screen transition to a statistics selection page 1320. The operator specifies an analysis item in the statistics selection page 1320, which is sent to the automatic distribution server 100 (step S224). If it is “reservation/delivery track record,” the screen changes to a reservation/delivery track record page 1330. The operator can return to the main page 1000 by selecting a RETURN link in this page 1330. Referring back to step S224, if it is “viewer statistics analysis,” the screen changes to a viewer statistics page 1340. The operator can return to the main page 1000 by selecting a RETURN link in this page 1340.

The above-described screen transition tree permits the program content provider 22 to register programs and check service statistics. It also permits the commercial provider 23 to incorporate commercials into program content.

The next section will provide a more specific example of each page. The following explanation includes some new pages that were not mentioned in the previous section because FIG. 53 only shows a fundamental flow of pages in the present embodiment.

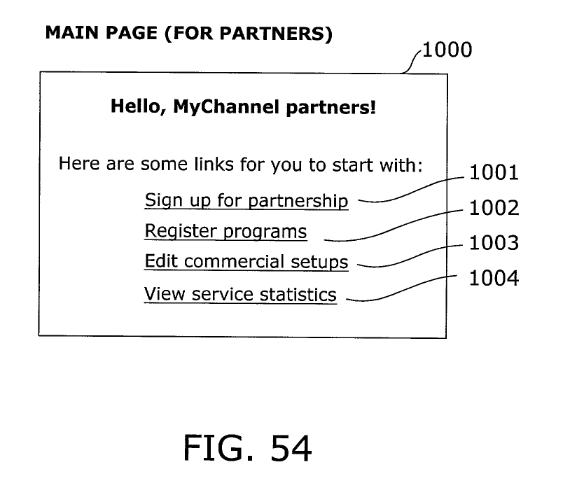

FIG. 54 shows an example of the main page 1000 which appears on the program editing station 310 or commercial editing station 410. The main page 1000 contains a plurality of menu items 1001 to 1004. The first item 1001 allows the program content provider 22 or commercial provider 23 to sign up for partnership of “MyChannel” service. When this menu item 1001 is selected, the screen changes to a partnership registration screen (not shown). The second menu item 1002 allows the program content provider 22 to register programs to the automatic distribution server 100. When this item 1002 is selected, the screen changes to a category selection page 1110. The third menu item 1003 allows the commercial provider 23 to edit their commercial setups in the automatic distribution server 100. When this item 1003 is selected, the screen changes to an operation selection page 1210. The fourth menu item 1004 allows the program content provider 22 to view the service statistics. When this item 1004 is selected, the screen changes to a program selection page 1310.

It is assumed here that the second and fourth menu items 1002 and 1004 are available only to the registered program content providers, while the third menu item 1003 is available only to the registered commercial providers.

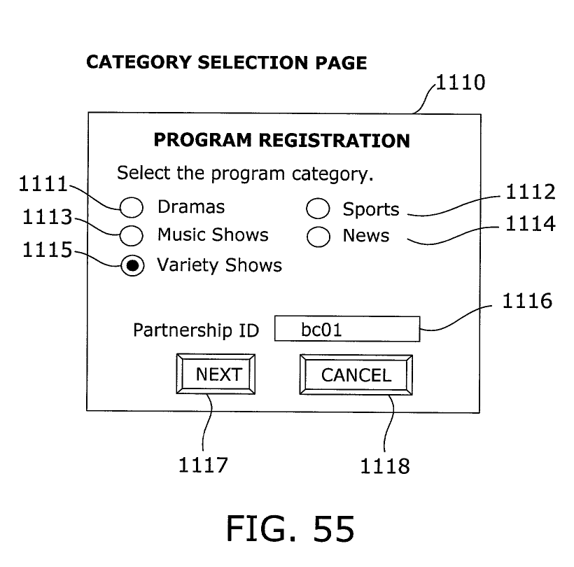

FIG. 55 shows an example of the category selection page 1110 appearing on the program editing station 310. The category selection page 1110 contains a plurality of check boxes 1111 to 1115, one text box 1116, a NEXT button 1117, and a CANCEL button 1118.

The check boxes 1111 to 1115 are used to select a particular category of programs, each being associated with a single predefined category. More specifically, the first check box 1111 is associated with “Dramas.” The second check box 1112 is associated with “Sports.” The third check box 1113 is associated with “Music shows.” The fourth check box 1114 is associated with “News.” The fifth check box 1115 is associated with “Variety shows.”

The text box 1116 is used to enter the identification code of the program content provider 22. The NEXT button 1117 is used to move to the next page to advance the present program registration session. When this NEXT button 1117 is pressed, the program editing station 310 sends the current check box status to the automatic distribution server 100, together with the broadcasting content provider's ID, thus causing a screen transition to the program information entry page 1120. The CANCEL button 1118, on the other hand, allows the program content provider 22 to cancel the current selection. This CANCEL button 1118 initiates a transition back to the main page 1000, without sending any new information to the automatic distribution server 100.

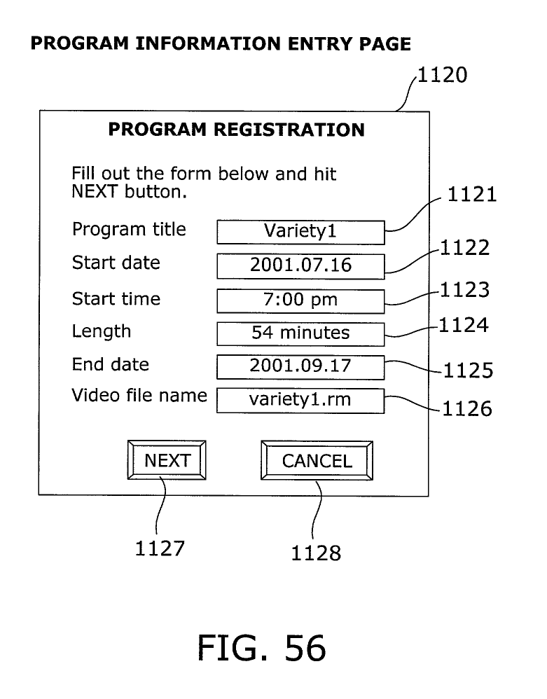

FIG. 56 shows an example of the program information entry page 1120 appearing on the program editing station 310. The program information entry page 1120 contains a plurality of text boxes 1121 to 1126, a NEXT button 1127, and a CANCEL button 1128.

The text boxes 1121 to 1126 accepts various program parameters from the program content provider 22, which are entered to the program table 132 as a new record. The first text box 1121 is for entering the title of a program. The second text box 1122 and third text box 1123 are for entering the start date and start time of the program's availability period. This is also referred to as the program release date and time. The fourth text box 1124 is for entering the length of the program. The fifth text box 1125 is for entering the end date of the availability period. The sixth text box 1126 is for entering the program's video file name.

The program content provider 22 presses the NEXT button 1127 to proceed to the next page. Pressing this NEXT button 1127 causes the information in the text boxes 1121 to 1126 to be submitted to the automatic distribution server 100, thus initiating a transition to the contract information entry page 1130. The CANCEL button 1128, on the other hand, allows the program content provider 22 to cancel the present interaction. This CANCEL button 1128 initiates a screen transition back to the category selection page 1110, without sending any new information to the automatic distribution server 100.

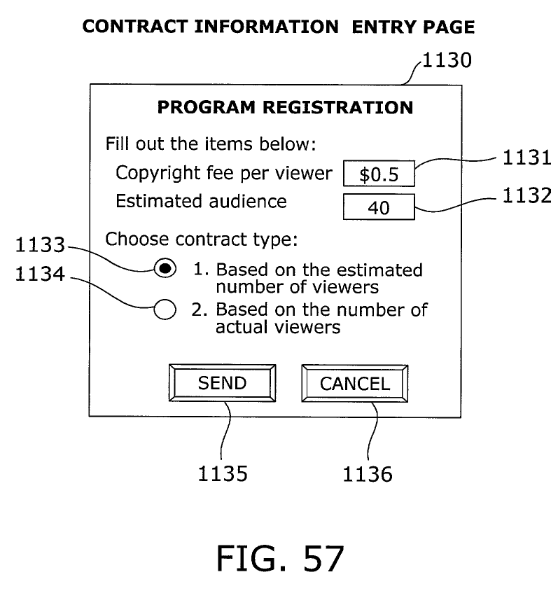

FIG. 57 shows an example of the contract information entry page 1130 displayed on a program editing station. The contract information entry page 1130 has two text boxes 1131 and 1132, two check boxes 1133 and 1134, a SEND button 1135, and a CANCEL button 1136.

The upper text box 1131 is for entering a unit fee of copyright that shall be charged to each customer who viewed the program of interest. The lower text box 1132 is for entering the estimated number of viewers. It is the program content provider 22 who makes this estimation.

The check boxes 1133 and 1134 allow the program content provider 22 to choose a desired contract type concerning the policy of copyright fee calculation in the case the number of actual viewers falls short of the estimation. When the upper check box 1133 is selected, the program content provider 22 can receive copyright fees calculated on an estimation basis even if the number of actual viewers is smaller than the estimated number. On the other hand, when the lower check box 1134 is selected, the copyright fee is always calculated on an actual viewer basis.

The program content provider 22 presses the SEND button 1135 to register the information entered in the program information entry page 1120 and contract information entry page 1130. When this SEND button 1135 is pressed, the entered information is transmitted to the automatic distribution server 100 and registered to the program table 132. The screen is then changed to the registration acknowledgment page 1140. The CANCEL button 1136, on the other hand, allows the program content provider 22 to cancel the registration. A click on this CANCEL button 1136 brings him/her back to the main page 1000, without sending any updates to the automatic distribution server 100.

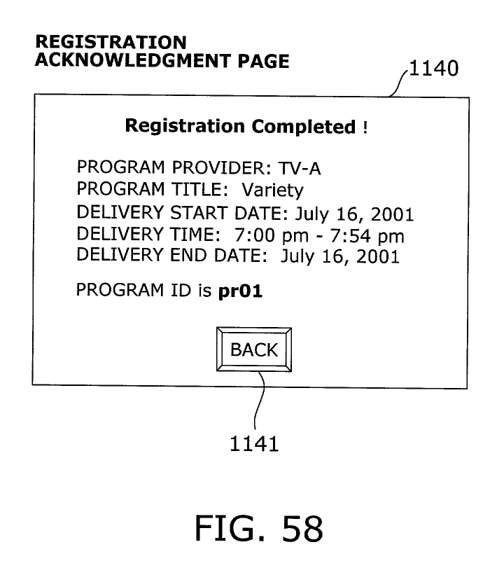

FIG. 58 shows an example of the registration acknowledgment page 1140 appearing on the program editing station 310. The registration acknowledgment page 1140 presents a summary of registration data, together with a BACK button 1141. The automatic distribution server 100 has assigned a program ID to the new program entry, which is shown in the registration acknowledgment page 1140. After looking through the registered data, the operator presses the BACK button 1141, which terminates the present program registration session and thus invokes a screen transition to the main page 1000.

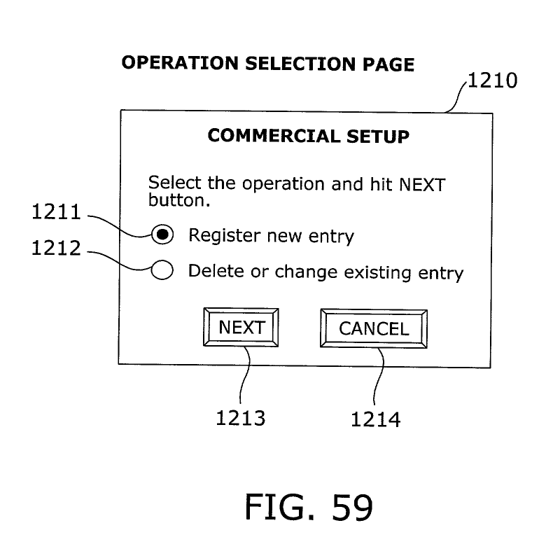

FIG. 59 shows an example of the operation selection page 1210 appearing on the commercial editing station 410. The operation selection page 1210 contains two check boxes 1211 and 1212, a NEXT button 1213, and a CANCEL button 1214.

The check boxes 1211 and 1212 are used to select a desired operation about commercials. More specifically, the upper check box 1211 requests registration of a new commercial entry. The lower check box 1212 requests deletion or change of an existing entry of the commercial table 172.

The NEXT button 1213 initiates a screen transition to another page that is relevant to the selected operation. More specifically, pressing the NEXT button 1213 causes the screen to change to the commercial data entry page 1220 if the upper check box 1211 is selected at that time. Pressing the NEXT button 1213 causes the screen to change to the title/operation selection page 1250 if the lower check box 1212 is selected at that time. The CANCEL button 1214, on the other hand, allows the operator to cancel the current session of commercial setup. Pressing the CANCEL button 1214 causes a transition back to the main page 1000.

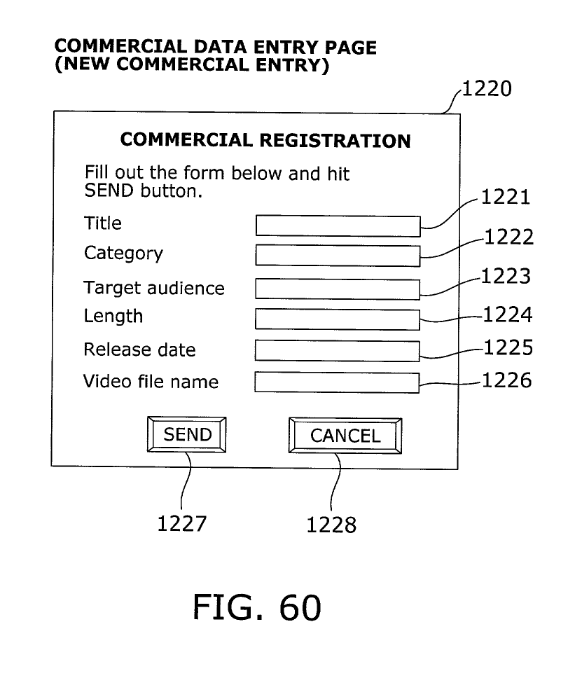

FIG. 60 shows an example of the commercial data entry page 1220 appearing on the commercial editing station 410, which allows the operator to register a new commercial title. The commercial data entry page 1220 contains a plurality of text boxes 1221 to 1226, a SEND button 1227, and a CANCEL button 1228.

The text boxes 1221 to 1226 accepts various parameters from the commercial provider 23. The first text box 1221 is for entering the title of a commercial to be registered. The second text box 1222 is for entering the category of products or services to be advertised. The third text box 1223 is for specifying the target audience of the commercial. The fourth text box 1224 is for entering the length of the commercial. The fifth text box 1225 is for specifying when to release the commercial. The sixth text box 1226 is for entering the video file name.

By pressing the SEND button 1227, the operator sends the information in each text box 1221 to 1226 to the automatic distribution server 100. This action also causes a transition to the registration data confirmation page 1230. The CANCEL button 1228, on the other hand, allows the operator to cancel the registration. Pressing this CANCEL button 1228 causes a transition back to the operation selection page 1210, without sending any new information to the automatic distribution server 100.

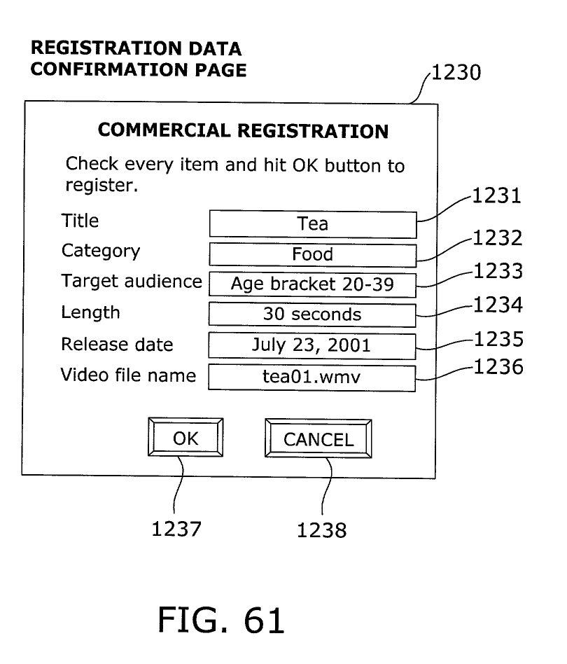

FIG. 61 shows an example of the registration data confirmation page 1230 appearing on the commercial editing station 410. The registration data confirmation page 1230 contains a plurality of text boxes 1231 to 1236, an OK button 1237, and a CANCEL button 1238.

The text boxes 1231 to 1236 shows what have been entered in the commercial data entry page 1220. More specifically, the first text box 1231 shows the title of the commercial. The second text box 1232 shows the category of products or services to be advertised. The third text box 1233 shows the target audience of the commercial. The fourth text box 1234 shows the length of the commercial. The fifth text box 1235 shows the release date of the commercial. The sixth text box 1236 shows the video file name of the commercial.

The OK button 1237 is used to register the entered or modified information in the above-described text boxes 1231 to 1236. When this OK button 1237 is pressed, the information will be transferred to a relevant part of the commercial table 172 in the automatic distribution server 100. This action also causes a transition to the registration acknowledgment page 1240. The CANCEL button 1238 gives the operator a chance to correct the information shown in the text boxes 1231 to 1236. By pressing the CANCEL button 1238, the operator can go back to the operation selection page 1210.

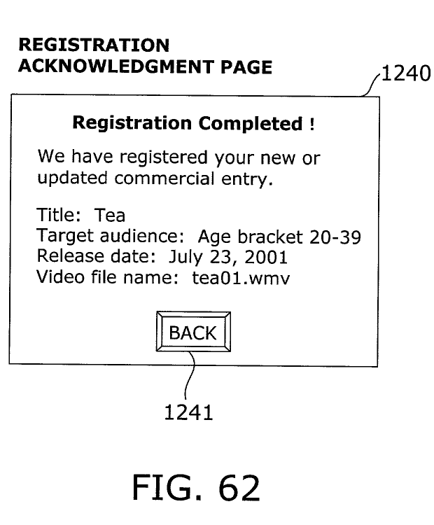

FIG. 62 shows an example of the registration acknowledgment page 1240 appearing on the commercial editing station 410. The registration acknowledgment page 1240 shows a message that reports successful completion of commercial registration, as well as providing a BACK button 1241. The operator reads the completion message on this page 1240 and the presses the BACK button 1241. This action brings him/her back to the main page 1000.

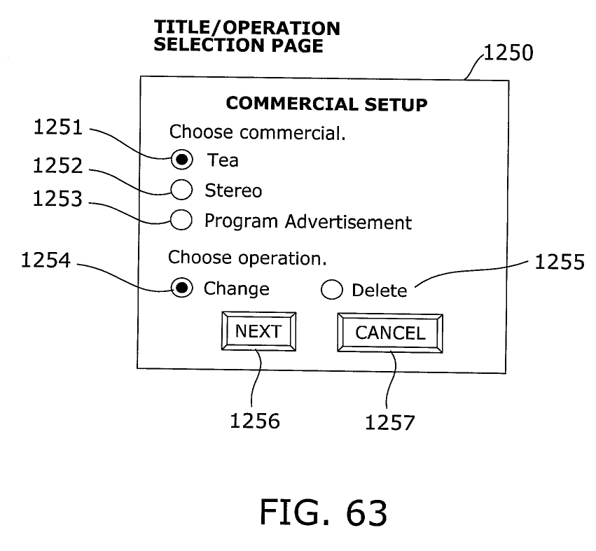

FIG. 63 shows an example of the title/operation selection page 1250 appearing on the commercial editing station 410. The title/operation selection page 1250 contains a plurality of check boxes 1251 to 1255, a NEXT button 1256, and a CANCEL button 1257.

The three check boxes 1251 to 1253 allows the operator to find and specify an existing commercial being registered in the commercial table 172 for the purpose of manipulation. All the commercial titles registered by the commercial provider 23 are listed in this page 1250, in association with the check boxes 1251 to 1253. More specifically, the first check box 1251 is associated with a commercial titled “Tea.” The second check box 1252 is associated with a commercial titled “Stereo.” The third check box 1253 is associated with a commercial titled “Program Advertisement.” By selecting one of those check boxes 1251 to 1253, the operator specifies which commercial he/she wishes to manipulate.

The bottommost two check boxes 1254 and 1255 are used to select a desired operation about commercials. The left check box 1254 is for changing an existing commercial. The right check box 1255 is for deleting an existing commercial. The operator executes either operation by selecting a desired check box.

The NEXT button 1256 initiates a screen transition to another page where the operation selected with the check boxes 1254 and 1255 will be applied to the commercial selected with the check boxes 1251 to 1253. More specifically, pressing the NEXT button 1256 causes a screen transition to the commercial data entry page 1260 if the check box 1254 is selected at that time. The same action causes a screen transition to the deletion confirmation page 1270 if the check box 1255 is selected at that time. The CANCEL button 1257, on the other hand, allows the operator to cancel the current session. Pressing this CANCEL button 1257 brings him/her back to the main page 1000 without affecting the existing commercial titles.

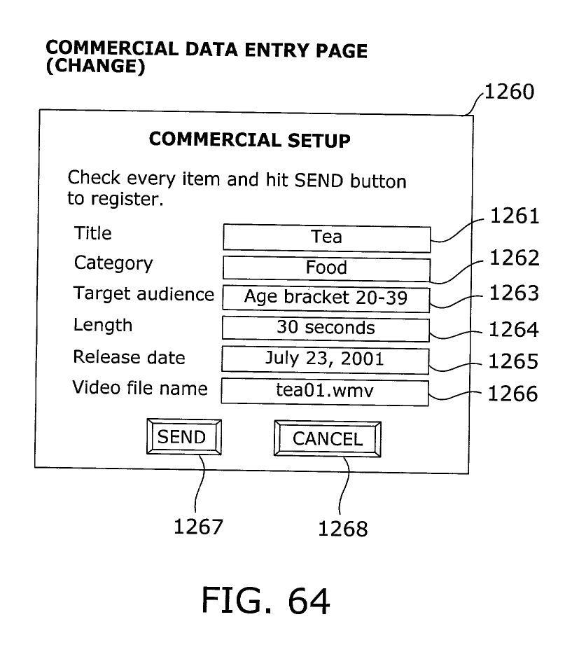

FIG. 64 shows an example of the commercial data entry page 1260 appearing on the commercial editing station 410, which allows the operator to change the setup of a specified commercial. The commercial data entry page 1260 has a plurality of text boxes 1261 to 1266, a SEND button 1267, and a CANCEL button 1268.

The text boxes 1261 to 1266 shows the current parameters of a particular commercial entry that the operator has specified in the title/operation selection page 1250. The operator can check and modify these parameters as necessary. More specifically, the first text box 1261 shows the title of a commercial to be registered. The second text box 1262 shows the category of products or services to be advertised. The third text box 1263 shows the target audience of the commercial. The fourth text box 1264 shows the length of the commercial. The fifth text box 1265 shows the release date of the commercial. The sixth text box 1266 shows the video file name.

The operator changes the above parameters and presses the SEND button 1267. This action causes the commercial editing station 410 to transmit the modified parameters to the automatic distribution server 100, subsequently invoking a transition to the registration data confirmation page 1230 described earlier. The CANCEL button 1268, on the other hand, allows the operator to cancel the current session. Pressing this CANCEL button 1268 causes a transition back to the operation selection page 1210, without sending any updates to the automatic distribution server 100.

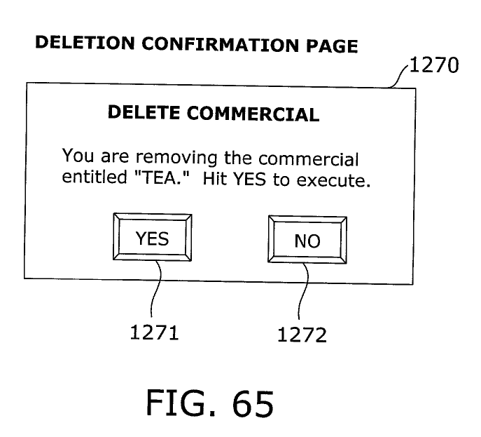

FIG. 65 shows an example of the deletion confirmation page 1270 appearing on the commercial editing station 410. The deletion confirmation page 1270 shows a confirmation message about deletion of the specified commercial entry, prompting the operator to respond by pressing either YES button 1271 or NO button 1272.

The YES button 1271 is for granting permission to execute the deletion. Pressing this YES button 1271 causes transmission of a deletion request to the automatic distribution server 100. The specified commercial entry is thus removed from the commercial table 172. At the same time, the screen changes to the deletion acknowledgment page 1280. On the other hand, the NO button 1272 allows the operator to cancel the deletion. Pressing this NO button 1272 causes a transition back to the operation selection page 1210.

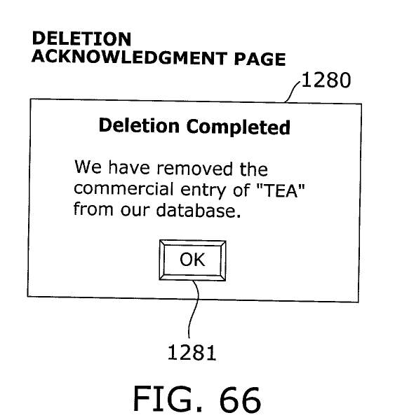

FIG. 66 shows an example of the deletion acknowledgment page 1280 appearing on the commercial editing station 410. The deletion acknowledgment page 1280 shows a message that reports successful completion of commercial deletion. It also provides an OK button 1281. The operator reads the completion message and presses this OK button 1281, which results in a transmission back to the main page 1000.

In the next section, we will describe how the proposed system displays the result of service statistics analysis, as well as presenting a specific example of page transition.

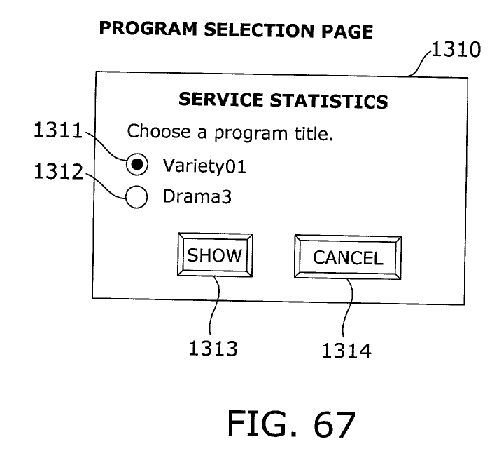

FIG. 67 shows an example of the program selection page 1310 appearing on the program editing station 310. The program selection page 1310 contains two check boxes 1311 and 1312, a SHOW button 1313, and a CANCEL button 1314.

The check boxes 1311 and 1312 allows the operator to choose a specific program title for statistical analysis. The check boxes 1311 and 1312 are each associated with the registered program entries of the program table 132. By selecting one of these check boxes, the operator directs a particular program to data analysis.

The SHOW button 1313 is used to trigger a session of data analysis. When this SHOW button 1313 is pressed, the program editing station 310 supplies the automatic distribution server 100 with the information for identifying the target program. This action also causes a transition to a statistics selection page 1320. The CANCEL button 1314, on the other hand, allows the operator to cancel the request. Pressing the CANCEL button 1314 causes a transition back to the main page 1000, without doing anything about analysis.

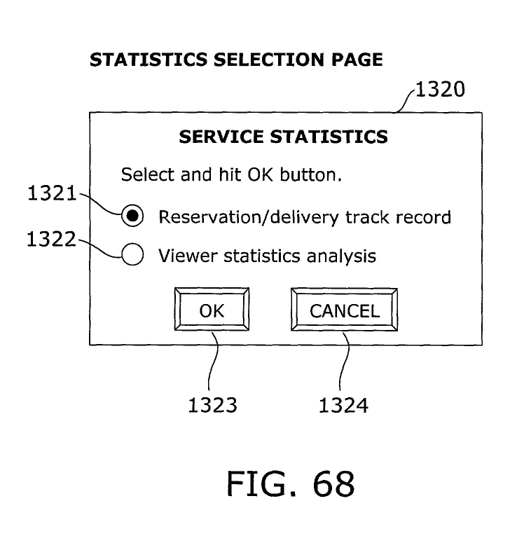

FIG. 68 shows an example of the statistics selection page 1320 appearing on the program editing station 310. This statistics selection page 1320 has two check boxes 1321 and 1322, an OK button 1323, and a CANCEL button 1324.

The check boxes 1321 and 1322 are used to select a desired analysis. More specifically, the upper check box 1321 is for selecting “Reservation/delivery track record,” while the lower check box 1322 is for selecting “Viewer statistics analysis.” The OK button 1323 is used to make the selection effective. When this OK button 1323 is pressed, the program editing station 310 sends an analysis request to the automatic distribution server 100, which includes the information about which analysis has been selected. If the upper check box 1321 is selected at that time, the screen will change to a reservation/delivery track record page 1330. If the lower check box 1322 is selected, a viewer statistics page 1340 will appear.

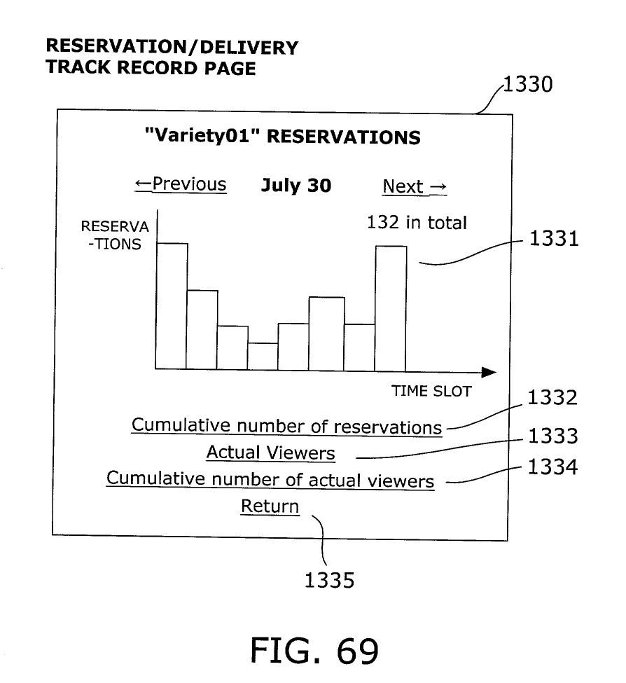

FIG. 69 shows an example of the reservation/delivery track record page 1330 appearing on the program editing station 310. This reservation/delivery track record page 1330 contains a bar graph 1331 and a plurality of links 1332 to 1335, which form a menu.

The bar graph 1331 shows the number of reservations in consecutive time slots, with respect to the program titled “Variety01.” The menu items 1332 to 1334 are presented to switch the screen to other pages showing different statistical aspects. More specifically, the first menu item 1332 takes the operator to a page showing statistics about the cumulative number of reservations. The second menu item 1333 causes a transition to another page which presents statistics of actual viewers. The third menu item 1334 is for viewing statistics about the cumulative number of actual viewers. The fourth menu item 1335 is used to terminate the current page and move back to the main page 1000.

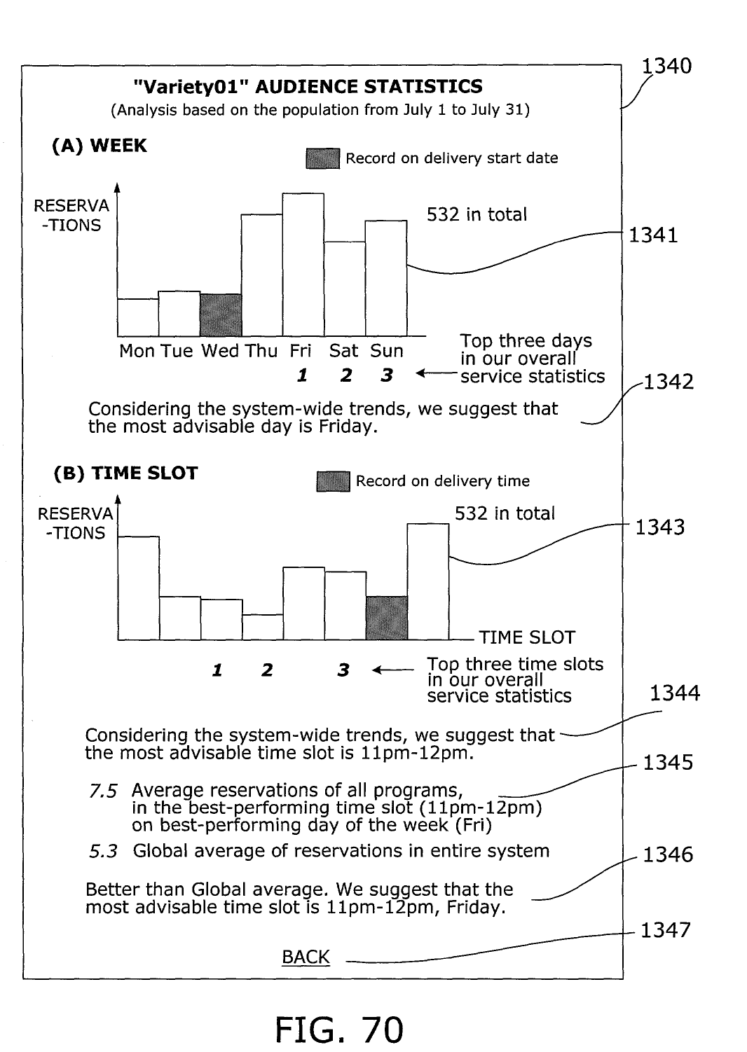

FIG. 70 shows an example of the viewer statistics page 1340 appearing on the program editing station 310. The viewer statistics page 1340 shows two graphs 1341 and 1343, comments 1342 and 1344 to 1346, and a link 1347.

The first bar graph 1341 shows the trend of reservations for the specified program on each day of the week. In this graph 1341, the bar representing the program release date is hatched for emphasis. Placed under the graph 1341 are the numerals representing the top three days of the week that achieved the highest marks. Note that this ranking is determined by evaluating all the programs available in the system, as opposed to the illustrated bar graph 1341. In the example of FIG. 70, Friday is the busiest day in receiving reservations, which is followed by Saturday, and then by Sunday.

The first comment 1342 is generated as a result of statistical evaluation of the graph 1341. In the example of FIG. 70, it reads as follows: “Considering the system-wide trends, we suggest that the most advisable day is Friday.”

The second bar graph 1343 depicts the trend of reservations for the specified program on an individual time slot basis. In this graph 1343, the hatched bar represents reservations in the time slot during which the program is delivered. Placed under the graph 1343 are the numerals representing the top three time slots that achieved the highest marks. Note again that this ranking is determined by evaluating all the programs available in the system.

The second comment 1344 is generated to indicate the most suitable time slot for program delivery. In the example of FIG. 70, it reads as follows: “Considering the system-wide trends, we suggest that the most advisable time slot is 11 pm-12 pm.”

The third comment 1345 shows the average reservations of all programs, in the best-performing time slot, on the best-performing day of the week. It also shows the global average of reservations in the entire system (i.e., all days, all time slots, all programs).

The fourth comment 1346 is generated to indicate the most suitable time slot and day of the week for program delivery. In the example of FIG. 70, it reads as follows: “Better than Global average. We suggest that the most advisable time slot is 11 pm-12 pm, Friday.”

The link 1347 is used to close the viewer statistics page 1340 and go back to the main page 1000. A click on this link 1347 causes a transition to the main page 1000.

As described above, the present embodiment allows the customers to create their own schedule tables 151, 152, and so on. Based on these personal schedule tables, the automatic distribution server 100 delivers video data streams to user terminals 510, 520, and so on. With this feature of the present invention, the customers can enjoy their favorite programs at convenient times, without missing the chance.

In addition, the customers need not to bother making Internet connections because the selected content is delivered to the dedicated software program running on each user terminal, as scheduled by themselves. The customer have only to open the window of that dedicated viewer software, instead of making access to their Internet broadcast providers. That is, the present invention provides a unified way of viewing programs available from different stations, being free from burdensome TV channel selections.

Also, the customers are allowed to set up their own delivery schedules, so that they can watch a program at a convenient time. There is no need for them to prepare blank video tapes, hard disk space, or whatever necessary for recording programs. Because of the reduced necessity of recording, it will be less likely for other computer applications to suffer a shortage of storage space.

Even if a customer needs to record programs for some reason, he/she can determine the sequence of programs, considering a suitable playback order when planning a delivery schedule. This feature eliminates the need for resetting or searching for the beginning of each program.

The present invention can also set an available period (i.e., from program release date to distribution end date) for each piece of content, limiting the access to the content. This feature effectively protects the copyright of content.

The proposed system requires a user terminal to indicate its activity when starting program delivery. If the user terminal is not ready to receive a program, the server does not start data transmission. Since customers may not always be able to execute the scheduled program reception, the above confirmation function avoids needless content delivery.

The proposed system sets beforehand a copyright fee for a single occurrence of content delivery, and calculates copyright charges according to the number of occurrences of content delivery. This feature reduces the burden in calculation and payment of copyright fees.

According to the present invention, the server collects statistical data about reservations for each piece of content and actual delivery of same. When requested, it sends the collected statistical data to terminal stations at the content providers. This feature helps the program content provider 22 to find a particular day of the week or time slot that is suitable for program delivery.

While the above explanation has assumed program delivery over the Internet, it is also possible to use other type of network infrastructures. One alternative may be to use a mobile communications network.

Further, the present invention should not be limited to any particular type of content. Although the proposed embodiment has assumed the delivery of video data streams, including TV programs and commercial video clips, other kind of content, such as still images and sound data, can also be distributed to customers as convenient times.

Moreover, since the proposed system involves a plurality of user terminals, there is a chance that they send the same delivery schedule information (schedule data) to the server. Considering this nature, it is possible to configure the server to use simulcast techniques to deliver a program to multiple user terminals when they have the same schedule data. This arrangement will reduce the total data traffic in delivering programs, thus relaxing the requirements for communication channel capacity.

The above-described processing functions of the present invention are realized as a client and server system. More specifically, the functions of the automatic distribution server 100 and video distribution server 200 are implemented as server programs, while those of the program editing stations 310 and 320, commercial editing stations 410 and 420, and user terminals 510 to 530 are provided as client programs. Various services of the proposed automatic distribution server 100 and video distribution server 200 are realized by executing such server programs on one or more appropriate server computer platforms. Also, the features of the program editing stations 310 and 320, commercial editing stations 410 and 420, and user terminals 510 to 530 are realized by executing such client programs on each client computer platform.

The above server and client programs may be stored in a computer-readable medium for the purpose of storage and distribution. Suitable computer-readable storage media include magnetic storage media, optical discs, magneto-optical storage media, and solid state memory devices. Magnetic storage media include hard disk drives (HDD) floppy disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the circulation of the server and client programs. Network-based distribution of software programs is also possible, in which case the client program files stored in a server computer are downloaded to client computers over a network.

Each server computer has server programs in its local storage unit, which have been previously installed from a portable storage media. The server computer executes the server programs read out of the local storage unit, thereby providing its intended functions. Alternatively, the server computer may execute those programs directly from a portable storage media.

The client computers, on the other hand, store client programs in their local storage units, which have been previously installed from a portable storage media or downloaded from a server computer. The client computer provides its intended functions by executing the client programs read out of the local storage unit. As an alternative way of program execution, the client computer may execute the client programs directly from the portable storage media. Another alternative method is that the server computer supplies the client computer with client programs dynamically, allowing the client computer to execute them upon delivery.

As seen from the above discussion, the proposed system is configured to store delivery schedule information sent from each user terminal. Content is delivered to requesting user terminals each time their desired delivery time is reached. This feature enables a server to distribute content to a plurality of customers according to their respective delivery schedules.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method of delivering content from a server to a user terminal, comprising the steps of:
(a) upon receipt of delivery schedule information from the user terminal which specifies a desired delivery time, storing the received delivery schedule information into a storage device;
(b) determining whether the desired delivery time is reached, by comparing the present time with the desired delivery time specified in the delivery schedule information that is stored in the storage device; and
(c) delivering the content to the user terminal when the desired delivery time is reached.

2. The method according to claim 1, wherein:
the content is only available during a predefined availability period; and
said storing step (a) stores the received delivery schedule information in the storage device only when the desired delivery time falls within the predefined availability period.

3. The method according to claim 1, wherein said delivering step (c) starts delivering of the content, upon receiving a message indicating that the user terminal is ready.

4. The method according to claim 1, wherein:
the content is a video data stream; and
said delivering step (c) uses streaming techniques to deliver the video data stream.

5. The method according to claim 1, wherein said delivering step (c) delivers the content to the user terminal while inserting advertising content thereinto.

6. The method according to claim 1, further comprising the steps of:
setting a copyright fee for a single occurrence of content delivery; and
calculating copyright charges according to the number of occurrences of content delivery.

7. The method according to claim 1, further comprising the steps of:
collecting statistical data about reservations for the content and actual delivery of the content; and
sending the collected statistical data to a terminal station that is used by a provider of the content.

8. The method according to claim 1, wherein:
there are a plurality of user terminals, each of which sends delivery schedule information;
said storing step (a) stores the delivery schedule information sent from the plurality of user terminals;
said determining step (b) handles a plurality of desired delivery times specified by the plurality of user terminals; and
said delivering step (c) simulcasts the content to the plurality of user terminals, if the plurality of desired delivery times agree with each other.

9. A method of receiving content at a user terminal which is delivered from a server over a network, comprising the steps of:
(a) transmitting delivery schedule information to the server in response to an external input, wherein the delivery schedule information specifies a desired delivery time;
(b) storing the transmitted delivery schedule information into a storage device;
(c) determining whether the desired delivery time is reached, by comparing the present time with the desired delivery time specified in the delivery schedule information that is stored in the storage device;
(e) issuing a message that requests permission for receiving the content, when the desired delivery time is reached;
(f) upon receipt of the permission, notifying the server that the user terminal is ready for receiving the content; and
(g) displaying the content being delivered from the server.

10. A server connected to a user terminal via a network, comprising:
a storage device;
delivery schedule receiving means for receiving delivery schedule information from the user terminal which specifies a desired delivery time, and saving the received delivery schedule information in said storage device;
delivery time determination means for determining whether the desired delivery time is reached, by comparing the present time with the desired delivery time specified in the delivery schedule information that is stored in the storage device; and
delivering means for delivering the content to the user terminal when notified by said delivery time determination means that the desired delivery time has been reached.

11. A user terminal connected to a server that distributes content over a network, comprising:
a storage device;
delivery schedule transmission means for transmitting delivery schedule information to the server in response to an external input, wherein the delivery schedule information specifies a desired delivery time;
delivery schedule recording means for recording the transmitted delivery schedule information into a storage device;
delivery time determination means for determining whether the desired delivery time is reached, by comparing the present time with the desired delivery time specified in the delivery schedule information that is stored in the storage device;
message issuing means for issuing a message that requests permission for receiving the content, when the desired delivery time is reached;
notifying means for notifying, upon receipt of the permission, the server that the user terminal is ready for receiving the content; and
content displaying means for displaying the content being delivered from the server.

12. A program product for delivering content to a user terminal over a network, the program product causing a computer system to perform the steps of:
(a) upon receipt of delivery schedule information from the user terminal which specifies a desired delivery time, storing the received delivery schedule information into a storage device;
(b) determining whether the desired delivery time is reached, by comparing the present time with the desired delivery time specified in the delivery schedule information that is stored in the storage device; and
(c) delivering the content to the user terminal when the desired delivery time is reached.

13. A program product for receiving content from a server, the program product causing a computer system to perform the steps of:
(a) transmitting delivery schedule information to the server in response to an external input, wherein the delivery schedule information specifies a desired delivery time;
(b) storing the transmitted delivery schedule information into a storage device;
(c) determining whether the desired delivery time is reached, by comparing the present time with the desired delivery time specified in the delivery schedule information that is stored in the storage device;
(e) issuing a message that requests permission for receiving the content, when the desired delivery time is reached;
(f) upon receipt of the permission, notifying the server that the user terminal is ready for receiving the content; and
(g) displaying the content being delivered from the server.

14. A computer-readable storage medium which stores a computer program for delivering content to a user terminal over a network, the computer program causing a computer system to perform the steps of:
(a) upon receipt of delivery schedule information from the user terminal which specifies a desired delivery time, storing the received delivery schedule information into a storage device;
(b) determining whether the desired delivery time is reached, by comparing the present time with the desired delivery time specified in the delivery schedule information that is stored in the storage device; and
(c) delivering the content to the user terminal when the desired delivery time is reached.

15. A computer-readable storage medium which stores a computer program for receiving content from a server, the computer program causing a computer system to perform the steps of:
(a) transmitting delivery schedule information to the server in response to an external input, wherein the delivery schedule information specifies a desired delivery time;
(b) storing the transmitted delivery schedule information into a storage device;
(c) determining whether the desired delivery time is reached, by comparing the present time with the desired delivery time specified in the delivery schedule information that is stored in the storage device;
(e) issuing a message that requests permission for receiving the content, when the desired delivery time is reached;
(f) upon receipt of the permission, notifying the server that the user terminal is ready for receiving the content; and
(g) displaying the content being delivered from the server.
